(19) United States
(12) Patent Application Publication
(10) Pub. No.: US 2025/0091039 A1
(43) Pub. Date: Mar. 20, 2025

(54) NEW STEREORETENTIVE RUTHENIUM COMPLEXES, METHOD OF THEIR PREPARATION, INTERMEDIATES USED IN THIS METHOD AND USE OF NEW STEREORETENTIVE RUTHENIUM COMPLEXES IN OLEFIN METATHESIS REACTIONS

(71) Applicant: UNIWERSYTET WARSZAWSKI, Warszawa (PL)

(72) Inventors: Karol GRELA, Warszawa (PL); Anna KAJETANOWICZ, Warszawa (PL); Lukasz GRZESINSKI, Nowe Osiny (PL); Mariusz MILEWSKI, Pruszkow (PL)

(21) Appl. No.: 18/728,965

(22) PCT Filed: Jan. 16, 2023
(86) PCT No.: PCT/IB2023/050374

§ 371 Date: Jul. 15, 2024

(30) Foreign Application Priority Data
Jan. 17, 2022 (PL) PL440147

(51) Int. Cl. B01J 31/16

(52) U.S. Cl. CPC B01J 31/1616; B01J 2231/54; B01J 2531/0238; B01J 2531/821

(57) ABSTRACT

The subject matter of the invention is a stereoretentive ruthenium complex of the general formula 1a-Ru and/or 1b-Ru, in which all variables have the meanings defined in the description. The subject matter of the invention is also a method of preparing the ruthenium complex, an intermediate used in preparing the ruthenium complex, and the use of this ruthenium complex as a (pre) catalyst in olefin metathesis reactions such as ring-closing metathesis (RCM), homometathesis (self-CM), cross-metathesis (CM), and stereoretentive processes in olefin metathesis.

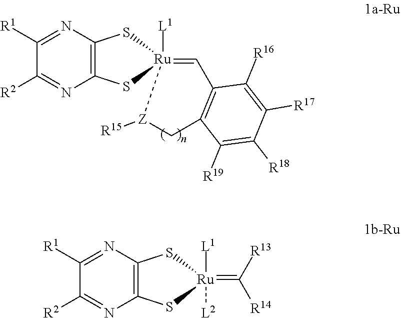

The subject matter of the invention is new stereoretentive ruthenium complexes useful as catalysts and/or (pre) catalysts for olefin metathesis reaction and their use in olefin metathesis reactions. The subject matter of the invention is also intermediates used to produce new stereoretentive ruthenium complexes, as well as a method of producing new stereoretentive ruthenium complexes. The invention finds its application as a desirable and universal tool in organic synthesis when selective synthesis Z- or E-configured olefins, depends on the C═C bond configuration in the substrate.

In recent years, great progress has been made in the application of olefin metathesis in organic synthesis [R H. Grubbs (Ed.), A. G. Wenzel (Ed.), D. J. O'Leary (Ed.), E. Khosravi (Ed.), Handbook of Olefin Metathesis, 2nd. edition, 3 volumes 2015, Wiley-VCH Verlag GmbH & Co. KGaA, 1608 pages]. A number of homogeneous ruthenium-based olefin metathesis catalysts are known in the state of the art, which have both high activity in different types of metathesis reactions and high tolerance to functional groups found in the substrate/product. Due to the combination of these features, metathesis catalysts are of significant importance in modern organic synthesis and industry. The most extensively described (pre) catalysts in the literature are Grubbs-type, Hoveyda-type and indenylidene complexes, containing a carbene N-heterocyclic carbene ligand (NHC) in their structure, and more recently Bertrand-type catalysts, having a cyclic alkylaminocarbene ligand (CAAC) [Grubbs et al. Chem. Rev., 2010, 110, 1746-1787; WO2017055945A1]. In other cases, most of the structures of olefin metathesis catalysts are derived from these above-mentioned ruthenium complexes.

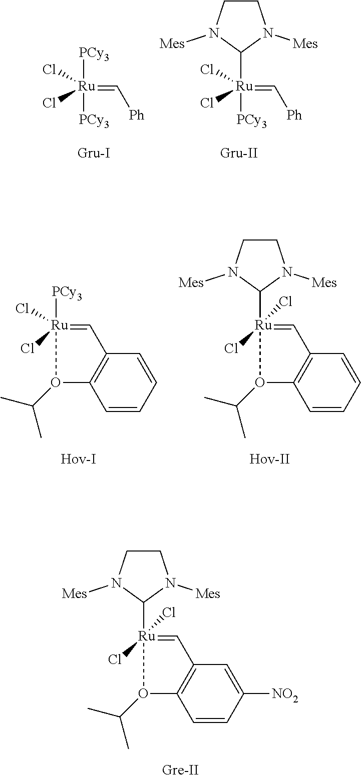

In the application of olefin metathesis in modern organic synthesis, the control of the C═C double bond configuration is very important. The first literature report on Z-selective ruthenium catalysts for olefin metathesis is from 2011 [Grubbs et al. J. Am. Chem. Soc., 2011, 133, 8525-8527]. In this scientific publication, Grubbs et al. described ruthenium complexes containing symmetric (Gru-Mes) and asymmetric (Gru-Ada-1) NHC ligands containing a mesyl and adamantyl substituent at the nitrogen atom, as well as the anionic ligand of pivalic acid (^{t}BuCOO⁻). Then, Prof. Grubbs' team obtained analogous structures (Gru-Ada-2, Gru-Ada-3) in which the anionic ligand is a nitro acid residue [Grubbs et al. Angew. Chem. Int. Ed., 2013, 52, 9001-9004]. These catalysts showed high chemoselectivity towards terminal C═C double bonds, which selectively form Z-configured products in the olefin metathesis reaction. In the substrate structure there was an internal (non-terminal) C═C bond with E-configuration, which, despite the high loading of the ruthenium catalyst and the long duration of the reaction (1 mol %, 5 hours, RT, THF), did not undergo the olefin metathesis reaction.

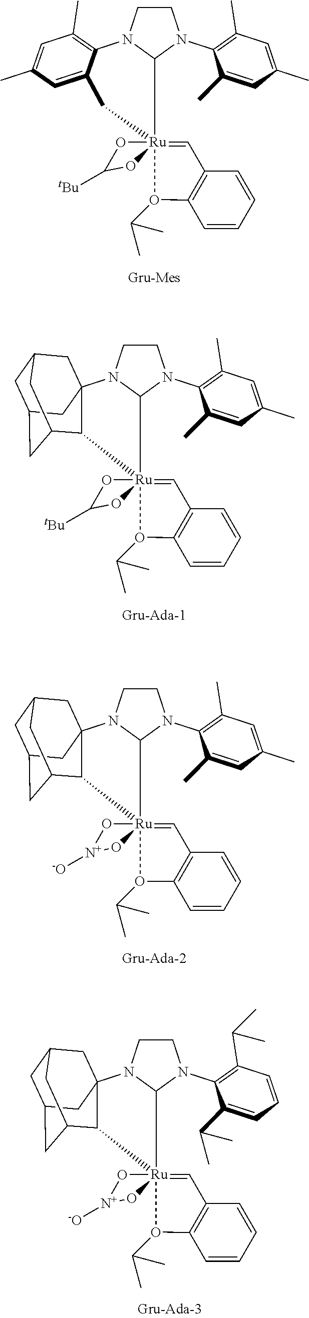

Subsequent modifications of ruthenium catalysts involved Hoveyda-Grubbs-type complexes, in the structure of which the two anionic ligands were replaced by a dithiocatechol bidentate ligand [WO2014201300A1, and A. Hoveyda et al., J. Am. Chem. Soc, 2013, 135, 10258-10261].

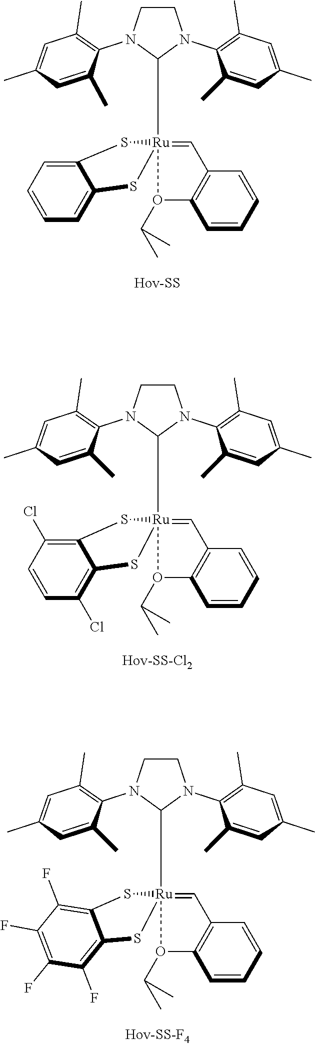

The principle of action of the above complexes is based on the retention (preservation) of the double bond configuration in the reaction product. Grubbs et al. [Org. Lett. 2016, 18, 772-775, DOI: 10.1021/acs.orglett.6b00031] showed that the use of the Hov-SS-Cl₂ complex in the Z-5-tetradecene metathesis reaction leads to two products having only a Z-configured double bond, while when E-5-tetradecene is used as a substrate for the same reaction, the products of the transformation are exclusively olefins with an E-configuration. In other words, catalysts containing various modifications of the dithiocatechol ligand (Hov-SS, Hov-SS-Cl₂, Hov-SS-F₄) are characterized by high stereoretentivity, i.e. the ability to transfer the original configuration of the C═C double bond from the substrates to the products of the olefin metathesis reaction.

Chelating catalysts containing various modifications of the dithiocatechol ligand show high chemoselectivity and higher yields of the desired products compared to previous complexes reported by Grubbs. It is noteworthy that the reactions were carried out at room temperature with high catalyst loading, and with long catalyst exposure to substrates/products (up to 12 hours, THF, room temperature, 1 mol %). As the first reports in the literature described the activity of ruthenium dithiocatechol catalysts in ROMP and rare ROM/CM reactions, so it was difficult to compare the activities of the new catalysts with those previously reported.

In patent document from 2017 [WO2017100585A1], Californian researchers claimed a list of 53 ruthenium complexes containing the dianionic dithiocatechol ligand or derivatives thereof. All of the ruthenium compounds in this document contain a chelating benzylidene and an NHC ligand, substituted either symmetrically or nonsymmetrically at the NHC ligand nitrogen atoms. In contrast, not all claimed ruthenium compounds have been obtained and well characterized by comparative olefin metathesis reactions.

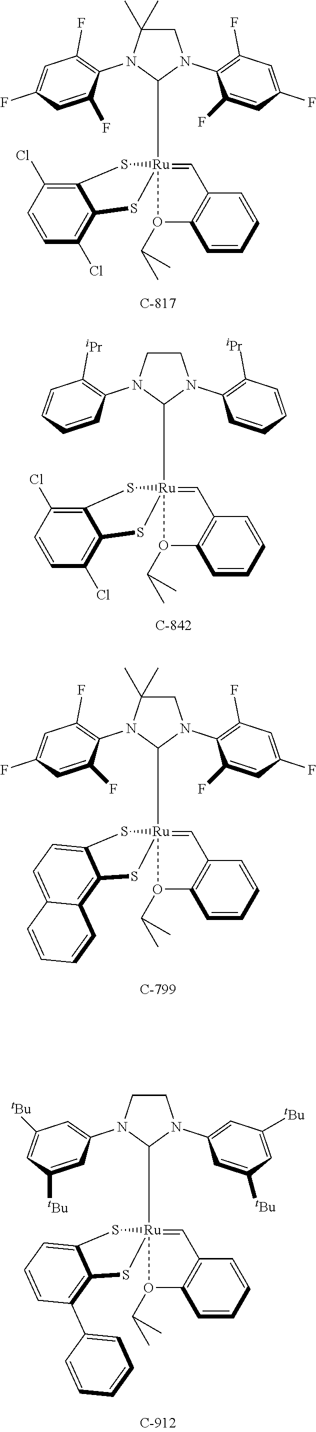

In another patent document from 2018 [WO2018087230A1], its authors obtained and characterized ruthenium complexes containing chelating benzylidene ligand activated by electron withdrawing group. The ruthenium catalysts contained a bidentate dithiocatechol derivative and NHC or CAAC ligands. The new E5 and E8 complexes in the model reaction proved to be slightly more active, with identical Z-selectivity, compared to previously known stereoretentive ruthenium complexes.

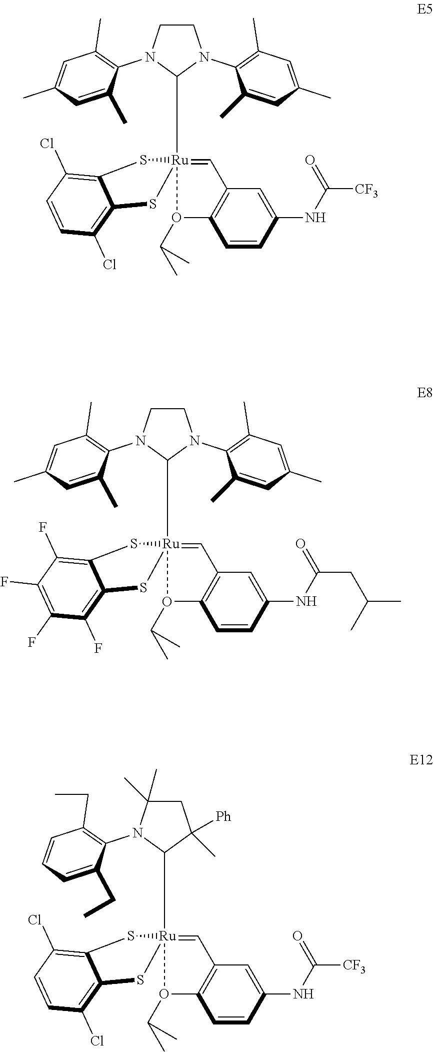

In another patent document [WO2018038928A1], its authors, from Californian company Materia, have obtained alkylidene ruthenium complexes containing a dithiocatechol ligand and a dimethylsulfoxide (C785_{SS} and C885_{SS}). One of the complexes, C785_{SS}, was tested in a model olefin metathesis reaction (cis-5-tetradecene homometathesis), wherein there is no comparison to other known stereoretentive ruthenium complexes.

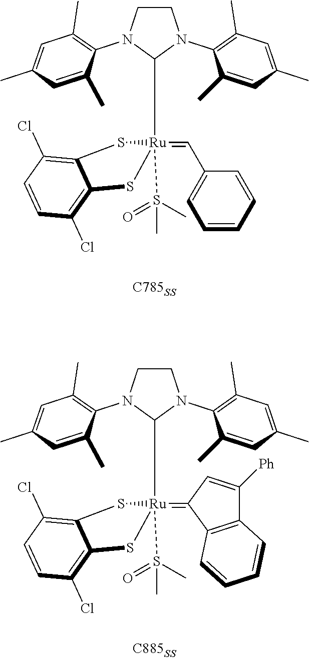

It is noteworthy that the authors of this invention predict stereoretentive properties of the ruthenium complexes (C885_{SS}), which are non-benzylidene derivatives of ruthenium catalysts (they are not Hoveyda-Grubbs-type complexes). However, these complexes have not been studied, and their catalytic activities in model olefin metathesis reactions with particular emphasis on Z-selective and stereoretentive reactions are unknown.

A significant problem in the state of the art is the high price of dithiocatechol derivatives, especially those substituted with halogens, as well as long synthesis pathways for other derivatives in which the expected products are obtained in low yields. These features are a barrier to further development of stereoselective and/or stereoretentive catalysts. Obtaining, by chemical synthesis, new ruthenium catalysts for olefin metathesis with dithiocatechol-based ligands of planned properties, is becoming difficult, and economically unjustifiable for industrial scale-up.

In the search for new ruthenium complexes with high catalytic activity and enhanced selectivity to obtain the expected Z- or E-isomer, it is important that convenient synthesis pathways based on readily available and inexpensive substrates lead to these compounds. It is also important to increase the library of ligands, the use of which will constitute an alternative and/or improved source of structures for ruthenium complexes used as catalysts in stereoretentive olefin metathesis.

Another problem is the low thermal stability of E- and especially Z-selective metathesis catalysts known in the state of the art. As a result, currently used ruthenium E-/Z-selective complexes require the use of very high catalyst loading to obtain the desired product in high yield. As an example, one can mention the paper by Grubbs et al. from 2013, where researchers describe the possibility of synthesizing macrocyclic compounds with a Z-configuration double bond via ring-closing metathesis using Z-selective complexes [V. M. Marx, M. B. Herbert, B. K. Keitz, R. H. Grubbs, J. Am. Chem. Soc. 2013, 135, 94-97, DOI: 10.1021/ja311241q]. In the presented study, the authors use 7.5 mol % of catalyst dissolved in 1,2-dichloroethane at 60° C. to obtain macrocycles in yields ranging from 30 to 75% and Z-isomer content in the product varying from 64 to 94%. In a study on macrocyclization and entropy-driven polymerization by ring-opening metathesis by Meyer and co-authors, as much as 10 mol % of catalyst is required to obtain a highly functionalized macrocyclic compound with an 88% yield and a Z-isomer content of 88% [A. L. Short, C. Fang, J. A. Nowalk, R. M. Weiss, P. Liu, T. Y. Meyer, ACS Macro Lett. 2018, 7, 858-862, DOI: 10.1021/acsmacrolett.8b00460]. Z-selective complexes of other transition metals, such as molybdenum, are characterized by low stability already at room temperature, which is again solved by using high (up to 10 mol %) loading of these complexes [M. Yu, C. Wang, A. F. Kyle, P. Jakubec, D. J. Dixon, R. R. Schrock, A. H. Hoveyda, Nature 2011, 479, 88-93, DOI: 10.1038/nature10563; H. Zhang, E. C. Yu, S. Torker, R. R. Schrock, A. H. Hoveyda, J. Am. Chem. Soc. 2014, 136, 16493-16496 DOI: 10.1021/ja510768c]. Obviously, this increases the cost of the synthesis process and contaminates the final product with a harmful transition metal.

Unexpectedly, it turned out that 1,2-dithio derivatives of pyrazine, quinoxalines, derivatives thereof and other similar organic compounds can act as ligands for new stereoretentive ruthenium catalysts and/or (pre) catalysts for olefin metathesis.

In addition, it was unexpectedly found that the new olefin metathesis (pre) catalysts in the model reactions exhibit stereoretentive properties, even under significantly elevated temperature conditions. Known in the state of the art stereoselective and stereoretentive ruthenium and molybdenum olefin metathesis catalysts retain their properties only under low temperature conditions (usually room temperature), which is a major difficulty and inconvenience for large organic compounds possessing many functional groups in their structure.

In addition, it was unexpectedly found that the addition of the zinc complex has a positive effect on the activity and selectivity of the new stereoretentive ruthenium complexes in metathesis reactions allowing to obtain higher yields and/or selectivity of the reactions compared to the reactions carried out without the addition of the zinc complex.

### SUMMARY OF THE INVENTION

The present invention relates to a ruthenium complex of the formula 1-Ru

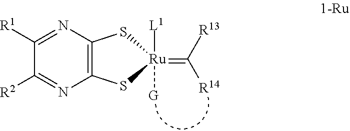

in which:
L¹ is a neutral ligand selected from N-heterocyclic carbenes (NHCs), cyclic alkylaminocarbenes (CAACs), or phosphines;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl or C₅-C₂₄ heteroaryloxy, which are optionally substituted by at least one C₁-C₁₂ alkyl, C₁-C₁₂ perfluoroalkyl, or R¹ and R² are independently an alkoxy group (—OR″), a sulfide group (—SR″), a sulfoxide group (—S(O)R″), a sulfonium group (—S⁺R″₂), a sulfonyl group (—SO₂R″), a sulfonamide group (—SO₂NR″₂), an amine group (—NR″₂), an ammonium group (—N⁺R″₃), a nitro group (—NO₂), a cyano group (—CN), a phosphonate group (—P(O)(OR″)₂), a phosphinate group (—P(O)R″(OR″)), a phosphonite group (—P(OR″)₂), a phosphine group (—PR″₂), a phosphine oxide group (—P(O)R″₂), a phosphonium group (—P⁺R″₃), a carboxyl group (—COOH), an ester group (—COOR″), an amide group (—CONR″₂), an amide group (—NR″C(O)R″), a formyl group (—CHO), a ketone group (—COR″), a thioamide group (—CSNR″₂), a thioketone group (—CSR″), a thionoester group (—CSOR″), a thioester group (—COSR″), a dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups to form a quaternary ammonium group, a tertiary sulfonium group, or a quaternary phosphonium group;
or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus;
R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ aralkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein the R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium or phosphorus, optionally substituted with one and/or more substituents independently selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₃-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle;
wherein the R¹³ and R¹⁴ substituents are independently preferably hydrogen and/or C₅-C₂₅ aryl independently substituted with hydrogen, halogen, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group independently is hydrogen, C₁-C₅ alkyl, C₁-C₅ perfluoroalkyl, C₆-C₂₄ aryl, C₇-C₂₄ aralkyl, C₅-C₂₄ perfluoroaryl, the two R″ groups, taken together, may form either C₃-C₁₂ cycloalkyl ring or C₃-C₂₅ heterocycloalkyl ring containing nitrogen, oxygen or sulfur, optionally additionally substituted with C₁-C₁₂ alkyl group, alternatively R″ is a ketone group (—COR^{c}) in which R^{c} is C₁-C₁₂ perfluoroalkyl or alkoxy group (—OR^{d}) in which R^{d} is C₁-C₁₂ alkyl or C₃-C₁₂ heterocycloalkyl containing nitrogen, oxygen or sulfur optionally additionally substituted with C₁-C₁₂ alkyl group;
G is chosen from such as
   L² ligand

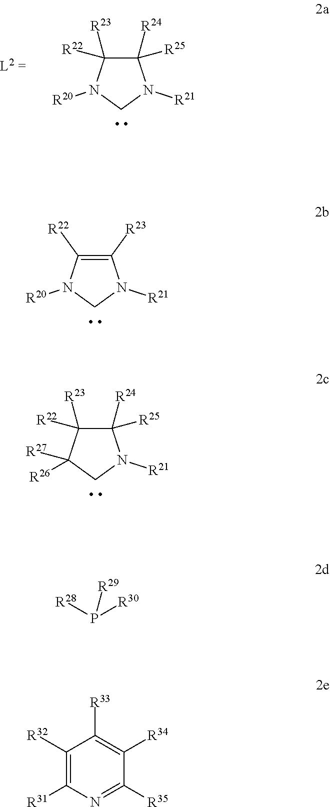

in which the R²⁰ and R²¹ substituents are independently C₁-C₁₂ alkyl group, C₃-C₁₂ cycloalkyl group, C₅-C₂₀ aryl group, or C₅-C₂₀ heteroaryl group, C₅-C₂₅ aralkyl group, which may be substituted independently by one and/or more substituents selected from a group comprising hydrogen, halogen, C₁-C₁₂ alkyl group, C₁-C₁₂ perfluoroalkyl group, C₅-C₂₀ aryl group, C₅-C₂₀ perfluoroaryl, C₅-C₂₀ heteroaryl, C₁-C₁₂ alkoxy, C₅-C₂₄ aryloxy, C₅-C₂₀ heteroaryloxy, alkoxy group (—OR″), sulfide group (—SR″), amine group (—NR″₂), in which the R″ group independently is hydrogen, C₁-C₅ alkyl, C₆-C₂₄ aryl, C₇-C₂₄ aralkyl, alternatively R²⁰ and R², taken together, form C₅-C₂₅ ring;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—CORd) group, methylester group (—CH₂OCOR^{b}), in which R^{b} is either C₅-C₂₀ aryl group or C₅-C₂₀ perfluoroaryl group; amine group (—NR^{c} [symbol] ), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted by C₁-C₁₂ alkyl group, (—COOR^{d}) ester group or (—COR^{d}) group, in which R^{d} is C₅-C₂₀ aryl group or C₅-C₂₀ perfluoroaryl group, or amine group (—NR^{e}₂) in which each R^{e} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or quaternary ammonium group, tertiary sulfonium group or quaternary phosphonium group, and R²⁰, R²¹, R²², R²³, R²⁴, R²⁵, R²⁶, and R²⁷ substituents may optionally be interconnected to form C₄-C₁₀ cyclic system or C₄-C₁₂ polycyclic system;
each R²⁸, R²⁹, and R³⁰ substituent is independently C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹, R³⁰, taken together, form a substituted or unsubstituted cyclic C₄-C₁₀, polycyclic C₄-C₁₂, aromatic C₄-C₁₀, heteroaromatic C₄-C₁₀ system that may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen;
each R³¹, R³², R³³, R³⁴ and R³⁵ substituent is independently C₁-C₁₂ alkyl group, C₃-C₁₂ cycloalkyl group, C₅-C₂₀ aryl group or C₅-C₂₀ heteroaryl group, which may be substituted independently by one and/or more substituents selected from a group comprising hydrogen, C₁-C₁₂ alkyl group, C₁-C₁₂ perfluoroalkyl group, C₁-C₁₂ alkoxy group, C₅-C₂₄ aryloxy group, C₅-C₂₀ heteroaryloxy group, or halogen;
or
heteroatom 1
   selected from a group comprising oxygen, sulfur, selenium, substituted by a group selected from such as hydrogen, halogen, oxygen, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′₂), Weinreb-type amide (—CON(R′)(OR′)), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′) or dithioester (—CS₂R′) group, in which R′ group is independently C₁-C₂₅ alkyl, C₁-C₂₅ perfluoroalkyl, C₃-C₂₅ cycloalkyl, C₃-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl, C₅-C₂₄ heteroaryloxy and then the dashed line represents a direct binding of the heteroatom to the R¹⁴ substituent or represents the connection of the R¹⁴ substituent to the heteroatom via a —CH₂—, —CHR′—, or —CR′₂-methylene bridge, wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl; or
heteroatom 2
   selected from a group comprising either nitrogen or phosphorus, substituted by a group selected from such as hydrogen, methylidene optionally substituted by substituent R′, C₁-C₂₅ alkyl, perfluoroaryl C₁-C₂₅, C₃-C₂₅ cycloalkyl, C₅-C₂₀ alkoxy, C₃-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, acyl group (—COR′), ester group (—COOR′), tert-butyloxycarbonyl group (t-Boc) or 9-fluorenylmethoxycarbonyl group (Fmoc), carbamate group (—CONR [symbol] ₂), sulfonic group (—SO₂R′), formyl group (—COH), in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′₂), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy and then the dashed line represents a direct binding of the heteroatom to the R¹⁴ substituent or the connection of the R¹⁴ substituent to the heteroatom via a (CH₂)—, —(CHR′)—, or (CR′₂)— methylene bridge; wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, or
heteroatom 3
   selected from a group comprising halogen, and then the dashed line represents a direct binding of the heteroatom to the R¹⁴ substituent, wherein the R¹⁴ substituent is C₅-C₁₅ aryl, or C₅-C₂₅ polyaryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which R″ group is C₁-C₅ alkyl, C₁-C₅ perfluoroalkyl, C₆-C₂₄ aryl, C₇-C₂₄ aralkyl, C₅-C₂₄ perfluoroaryl.

Preferably, the neutral L¹ ligand has a structure represented by a general formula selected from either 2a, 2b, 2c or 2d

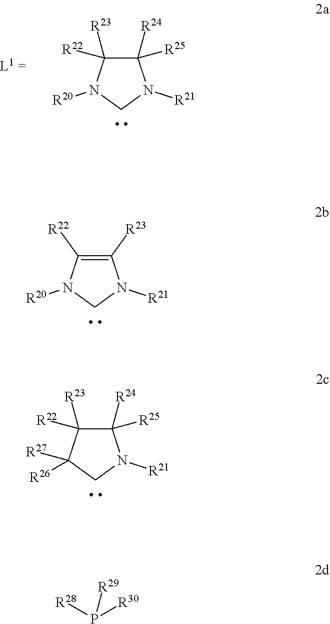

in which:
each R²⁰ and R²¹ substituent is independently C₁-C₁₂ alkyl group, C₃-C₁₂ cycloalkyl group, C₅-C₂₀ aryl group, or C₅-C₂₀ heteroaryl group which may be substituted independently by one and/or more substituents selected from a group comprising hydrogen, C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy, C₅-C₂₄ aryloxy, C₅-C₂₀ heteroaryloxy, or halogen, alkoxy group (—OR″), sulfide group (—SR″), halogen, amino group (—NR″₂), in which the R″ group independently is hydrogen, C₁-C₅ alkyl, C₆-C₂₄ aryl, C₇-C₂₄ aralkyl, alternatively R²⁰ and R²¹, taken together, form ring C₅-C₂₅ group; each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or amine group (—NR^{e}₂) in which each R^{d} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form cyclic C₄-C₁₀ system or polycyclic C₄-C₁₂ system;
R²⁸, R²⁹, and R³⁰ are independently C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy which are optionally substituted by at least one C₁-C₁₂ alkyl or C₁-C₁₂ perfluoroalkyl, or R¹ and R², taken together, form a substituted or unsubstituted cyclic C₄-C₁₀, polycyclic C₄-C₁₂, aromatic C₄-C₁₀, heteroaromatic C₄-C₁₀ system which can be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen.

Preferably, the subject matter of the invention is the ruthenium complex represented by the formula 1a-Ru

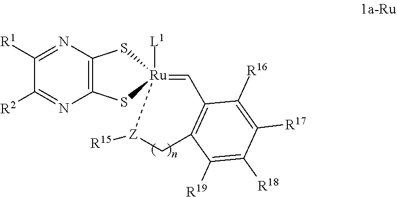

in which:
L¹ is a neutral ligand selected from N-heterocyclic carbenes (NHCs), cyclic alkylaminocarbene (CAAC) or phosphines;
‘n’ is 1 or 0
Z is selected from a group comprising halogens, O, S, Se, or an NR″ group, in which R″ is methylidene, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, acyl group (—COR′), ester group (—COOR′), tert-butyloxycarbonyl group (t-Boc) or 9-fluorenylmethoxycarbonyl group (Fmoc), carbamate group (—CONR [symbol] ₂), sulfonic group (—SO₂R′), formyl group (—COH), in which R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy,
or a halogen, wherein when Z is a halogen, R¹⁵ does not exist;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₁₂ alkyl, C₁-C₁₂ perfluoroalkyl, C₁-C₁₂ alkoxy, C₅-C₂₄ aryloxy, C₅-C₂₀ heteroaryloxy, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P+R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which R″ group is C₁-C₅ alkyl, C₁-C₅ perfluoroalkyl, C₆-C₂₄ aryl, C₇-C₂₄ aralkyl, C₅-C₂₄ perfluoroaryl;
R¹⁵ is independently hydrogen, C₁-C₂₅ alkyl, C₁-C₂₅ cycloalkyl, C₅-C₂₀ alkoxy, C₅-C₂₀ aryl, C₅-C₂₄ aryloxy, —COOR′″ group, —CH₂COOR′″ group, —CONR′″₂ group, —CH₂CONR′″₂ group, —COR′″ group, —CH₂COR′″ group, —CH₂CON(OR′″)(R′″) group, —CH₂CON(OR′″)(R′″) group, or a halogen, wherein R′″ is C₁-C₁₂ alkyl, C₃-C₁₂ cycloalkyl, C₂-C₁₂ alkenyl, C₆-C₂₀ aryl, which are optionally substituted by at least one C₁-C₁₂ alkyl, C₁-C₁₂ perfluoroalkyl, C₁-C₁₂ alkoxy, C₆-C₂₄ aryloxy, or halogen;
R¹⁶, R¹⁷, R¹⁸, and R¹⁹ are independently hydrogen, halogen, C₁-C₂₅ alkyl group, C₂-C₂₅ alkenyl group, C₅-C₂₅ aryl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N′R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, wherein R¹⁶, R¹⁷, R¹⁸, and R¹⁹ substituents, taken together, may form a substituted or unsubstituted cyclic C₄-C₁₀ or polycyclic C₄-C₁₂ system.

Preferably, the subject matter of the invention is the ruthenium complex represented by the formula 1b-Ru

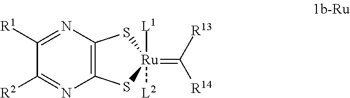

in which:
L¹ is a neutral ligand selected from N-heterocyclic carbenes (NHCs), cyclic alkylaminocarbene (CAAC) or PR₃ phosphines;
L² is a neutral ligand selected from N-heterocyclic carbenes (NHCs), cyclic alkylaminocarbene (CAAC), PR₃ phosphine derivatives or pyridine derivatives;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S+R″₂), sulfonyl group (—SO₂R″), sulfonamide group (—SO₂NR″₂), amine group (—NR″₂), ammonium group (—N′R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus; R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₃-C₂₅ aryloxy, optionally substituted C₆-C₂₅ arylalkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium, or phosphorus which may be substituted independently with one and/or more substituents selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle.

Preferably, the subject matter of the invention is the ruthenium complex represented by the formula 1b-Ru

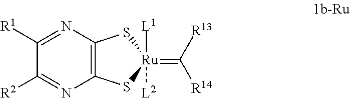

in which L¹ ligand is

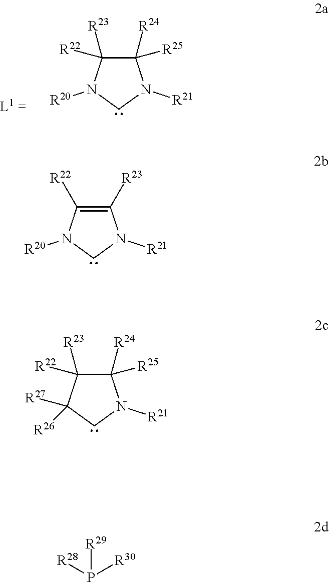

in which:
each R²⁰ and R²¹ substituent is independently C₁-C₁₂ alkyl group, C₃-C₁₂ cycloalkyl group, C₅-C₂₀ aryl group, or C₅-C₂₀ heteroaryl group which may be substituted independently by one and/or more substituents selected from a group comprising hydrogen, C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy group, C₅-C₂₄ aryloxy group, C₅-C₂₀ heteroaryloxy group, or halogen, alkoxy group (—OR″), sulfide group (—SR″), halogen, amino group (—NR″₂), in which the R″ group independently is hydrogen, C₁-C₅ alkyl, C₆-C₂₄ aryl, C₇-C₂₄ aralkyl, alternatively R²⁰ and R²¹, taken together, form ring C₅-C₂₅ group;

each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{c} groups, taken together, may form either C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or amine group (—NR^{e}₂) in which each R^{d} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form cyclic C₄-C₁₀ system or polycyclic C₄-C₁₂ system;
R²⁸, R²⁹, and R³⁰ are independently C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹ and R³⁰, taken together, form a substituted or unsubstituted cyclic C₄-C₁₀, polycyclic C₄-C₁₂, aromatic C₄-C₁₀, heteroaromatic C₄-C₁₀ system which can be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen;
   in which L² ligand is:

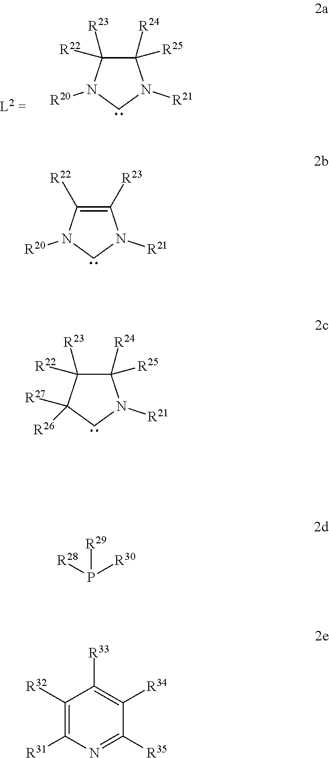

in which
each R²⁰ and R²¹ substituent is independently C₁-C₁₂ alkyl group, C₃-C₁₂ cycloalkyl group, C₅-C₂₀ aryl group, or C₅-C₂₀ heteroaryl group, which may be substituted independently by one and/or more substituents selected from a group comprising hydrogen, C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy, C₅-C₂₄ aryloxy, C₅-C₂₀ heteroaryloxy, or halogen, alkoxy group (—OR″), sulfide group (—SR″), halogen, amino group (—NR″₂), in which the R″ group independently is hydrogen, C₁-C₅ alkyl, C₆-C₂₄ aryl, C₇-C₂₄ aralkyl, alternatively R²⁰ and R²¹, taken together, form ring C₅-C₂₅ group;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or amine group (—NR^{e}₂) in which each R^{d} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form cyclic C₄-C₁₀ system or polycyclic C₄-C₁₂ system;
each R²⁸, R²⁹ and R³⁰ substituent is independently hydrogen, halogen, C₁-C₂₅ alkyl, C₃-C₁₂ cycloalkyl, C₅-C₂₀ alkoxy. C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹ and R³⁰, taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy, and halogen;
each R³¹, R³², R³³, R³⁴ and R³⁵ substituent is independently hydrogen, halogen, C₁-C₁₂ alkyl group, C₃-C₁₂ cycloalkyl group, C₅-C₂₀ aryl group or C₅-C₂₀ heteroaryl group, which may be substituted independently by one and/or more substituents selected from a group comprising hydrogen, C₁-C₁₂ alkyl group, C₁-C₁₂ perfluoroalkyl group, C₁-C₁₂ alkoxy group, C₅-C₂₄ aryloxy group, C₅-C₂₀ heteroaryloxy group, or halogen;
R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ arylalkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein the R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium or phosphorus, optionally substituted with one and/or more substituents independently selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₆-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle.

Preferably, the subject matter of the invention is a ruthenium complex represented by a formula selected from such as

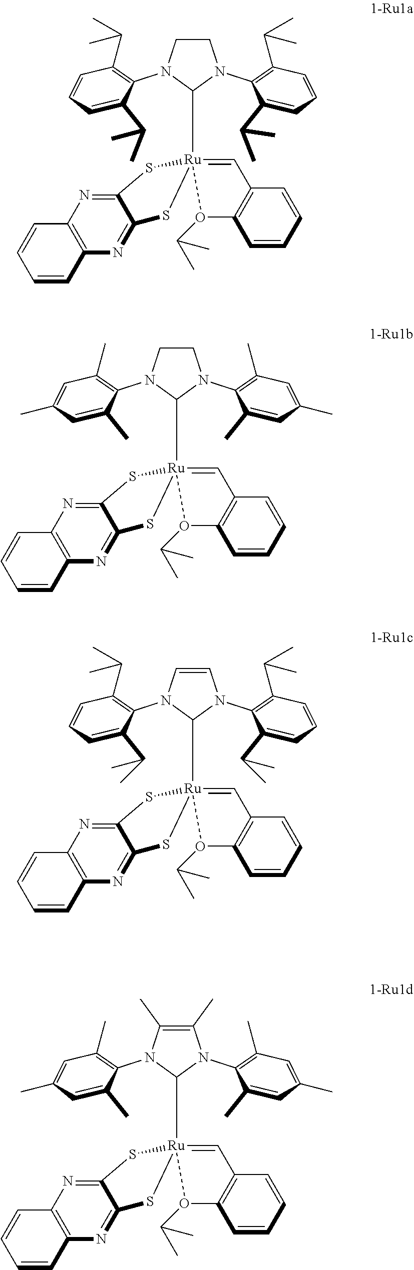

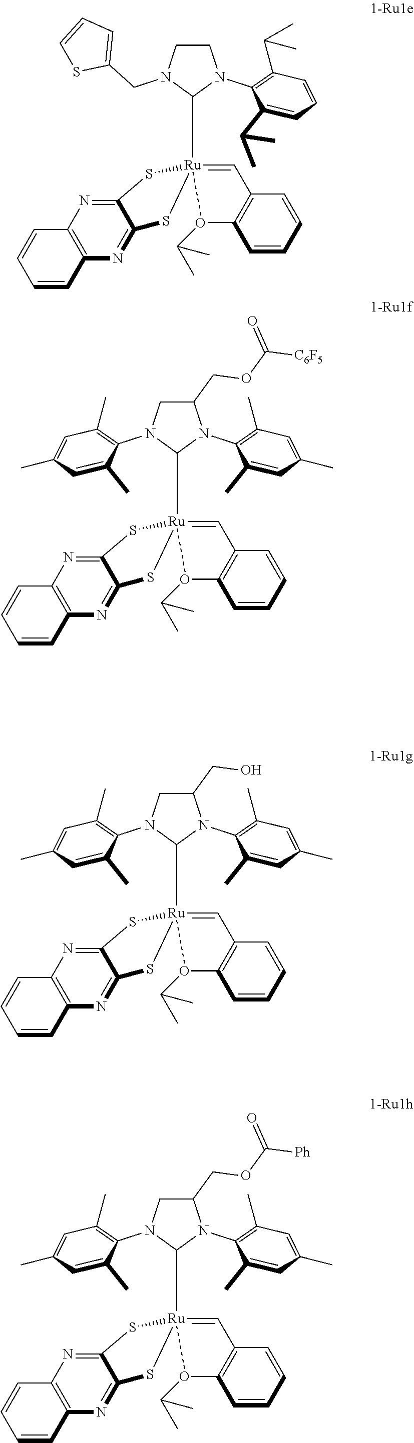

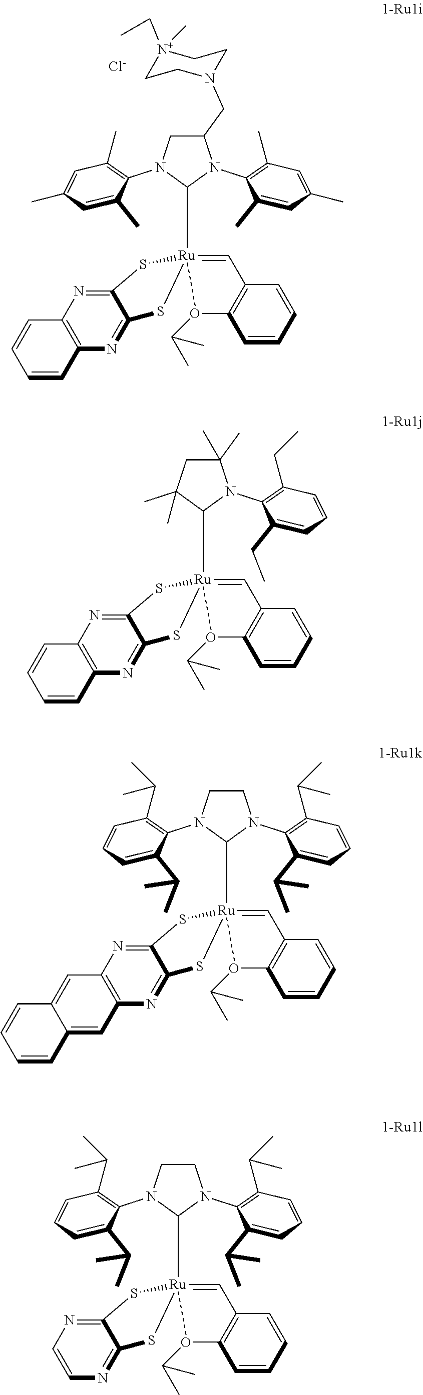

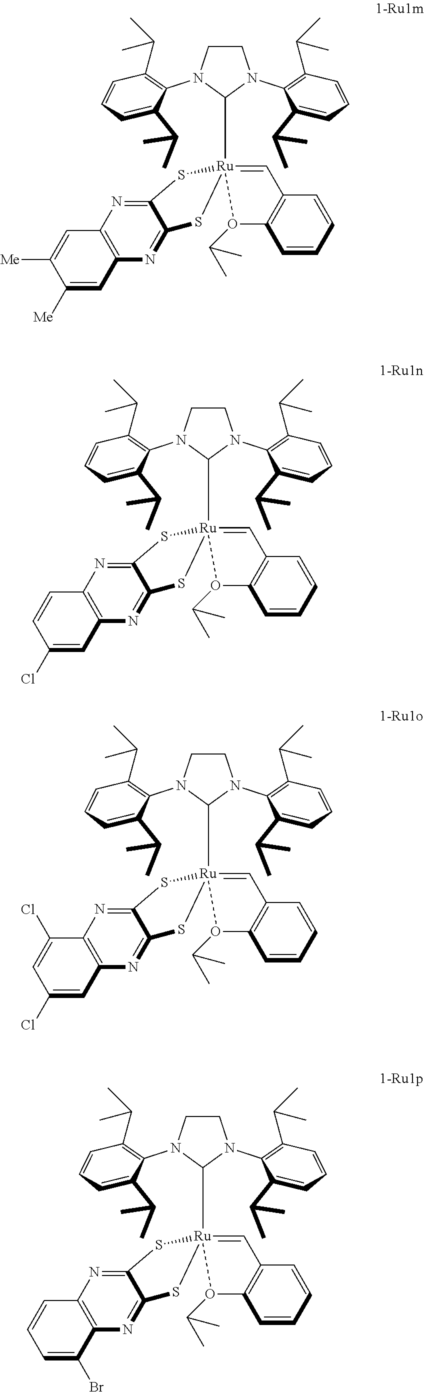

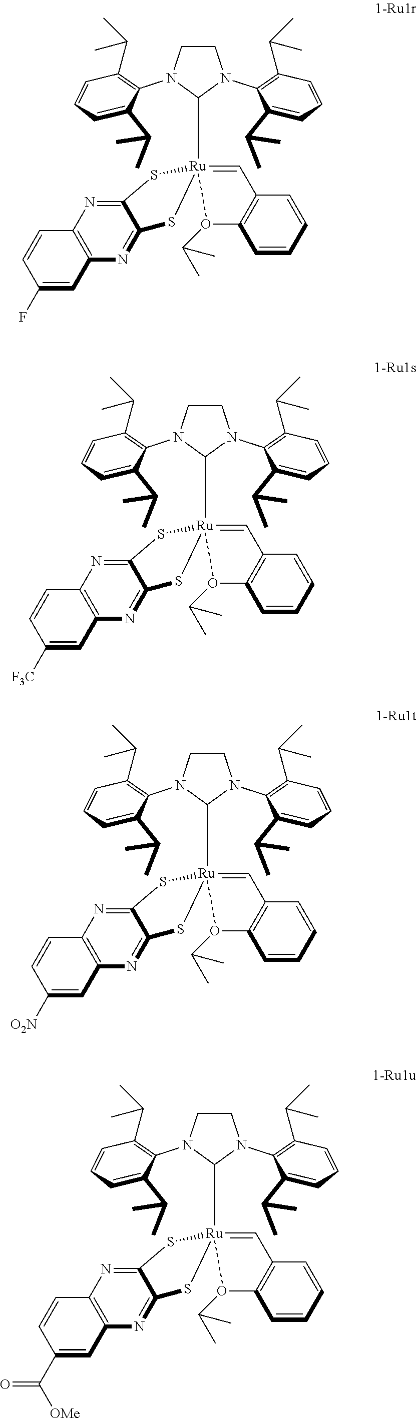

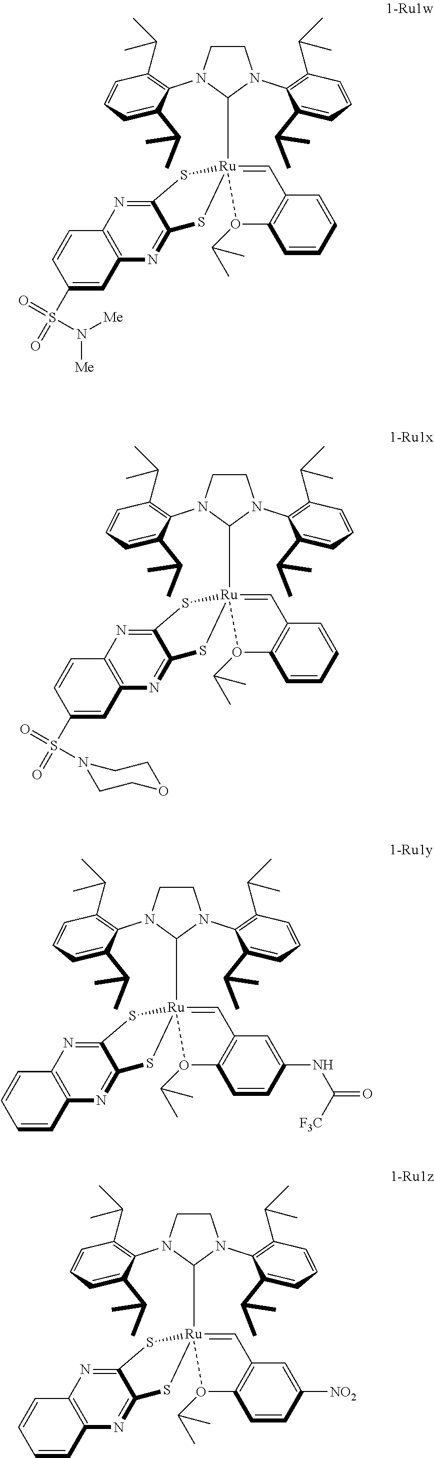

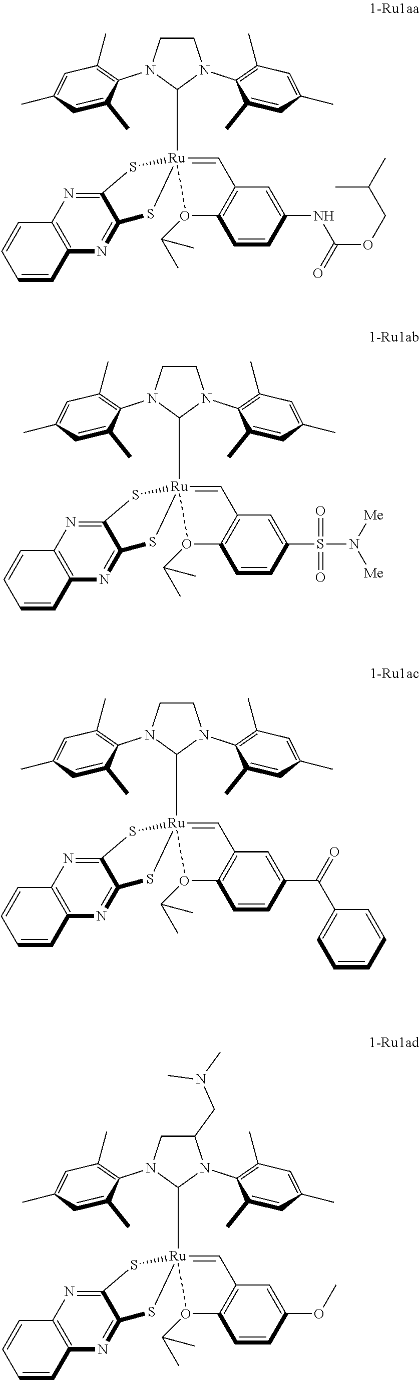

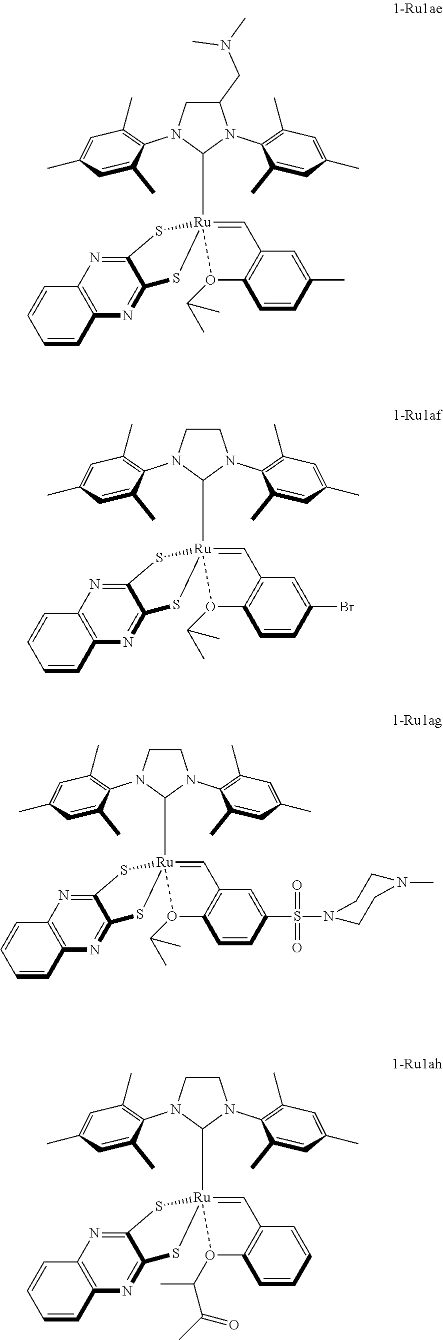

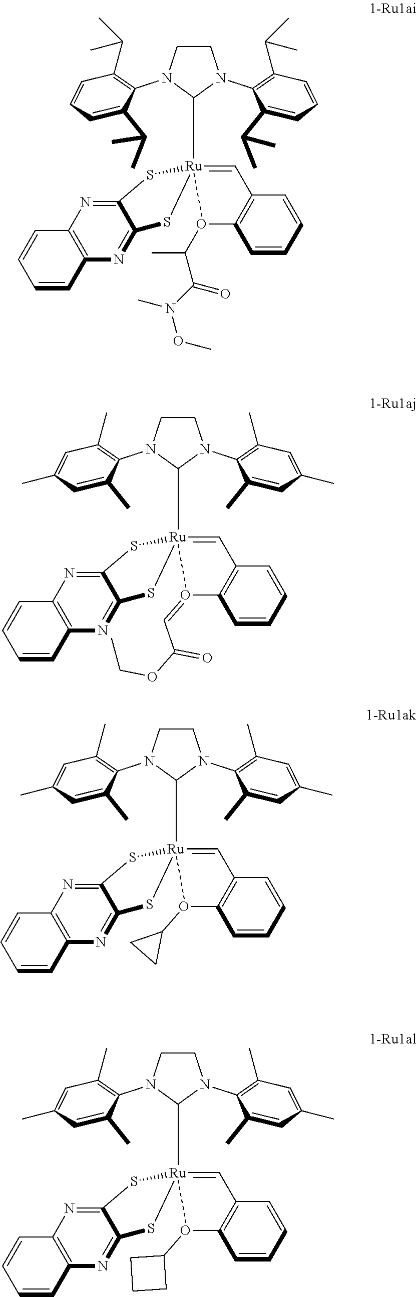

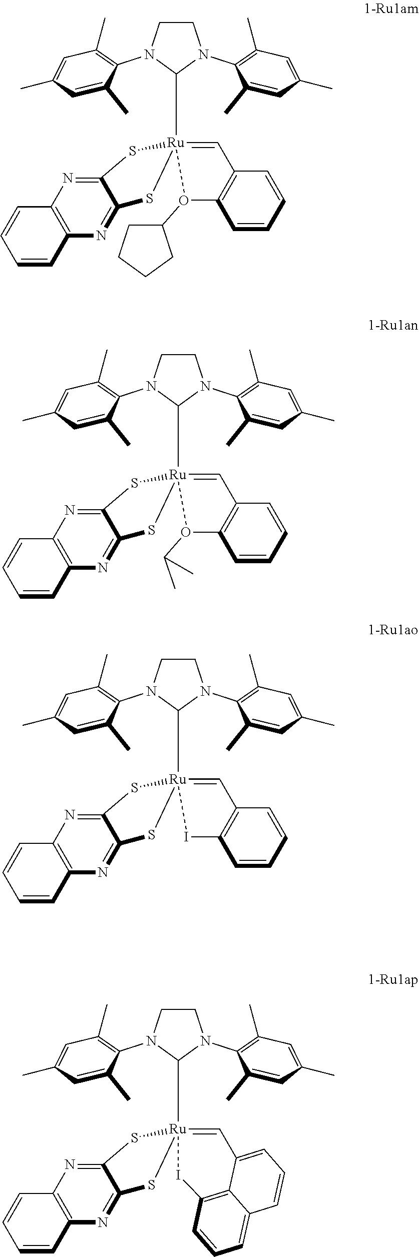

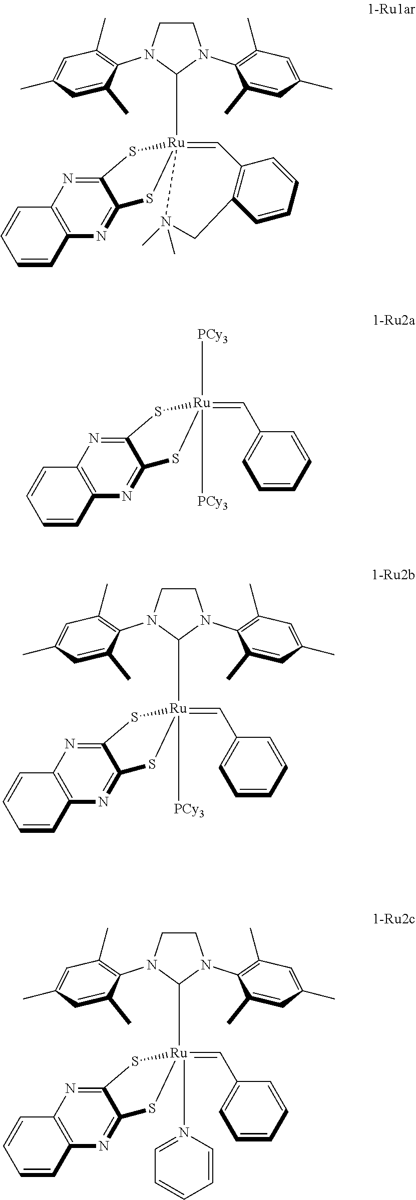

The subject matter of the invention is also a compound of the structure defined by the formula 3a or 3b

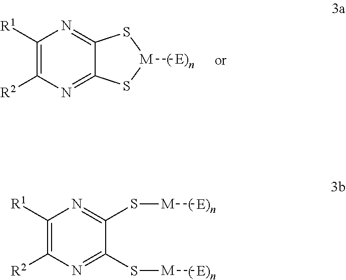

in which
M is monovalent or divalent metal cation;
n is 0, 1, 2 or 3;
E is at least one heteroatom selected from a group comprising oxygen, sulfur, selenium, nitrogen, phosphorus, which are substituted by a group, or if the heteroatom is nitrogen or phosphorus, by groups: C₁-C₂₅ alkyl group, C₁-C₂₅ cycloalkyl group, C₅-C₂₀ alkoxy group, C₅-C₂₀ aryl group, C₇-C₂₀ aralkyl group, C₅-C₂₄ aryloxy group, C₂-C₁₂ alkenyl group, C₆-C₂₀ heteroaryl group, C₅-C₂₄ heteroaryloxy group, or hydrogen, which are optionally substituted by at least one C₁-C₁₂ alkyl or C₁-C₁₂ perfluoroalkyl, or if two identical or different heteroatoms constitute a chelating system then, taken together, they form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently an alkoxy group (—OR″), a sulfide group (—SR″), a sulfoxide group (—S(O)R″), a sulfonium group (—S⁺R″₂), a sulfonyl group (—SO₂R″), a sulfonamide group (—SO₂NR″₂), an amine group (—NR″₂), an ammonium group (—N⁺R″₃), a nitro group (—NO₂), a cyano group (—CN), a phosphonate group (—P(O)(OR″)₂), a phosphinate group (—P(O)R″(OR″)), a phosphonite group (—P(OR″)₂), a phosphine group (—PR″₂), a phosphine oxide group (—P(O)R″₂), a phosphonium group (—P⁺R″₃), a carboxyl group (—COOH), an ester group (—COOR″), an amide group (—CONR″₂), an amide group (—NR″C(O)R″), a formyl group (—CHO), a ketone group (—COR″), a thioamide group (—CSNR″₂), a thioketone group (—CSR″), a thionoester group (—CSOR″), a thioester group (—COSR″), a dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
or R¹ and R², taken together, form a substituted or unsubstituted C₄-C₁₀ cyclic, C₄-C₁₂ polycyclic, C₄-C₁₀ aromatic, C₄-C₁₀ heteroaromatic, C₄-C₁₀ polyaromatic, and C₄-C₁₀ polyheteroaromatic system, which can be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form a C₅-C₂₅ ring, which alternatively may contain at least one heteroatom selected from oxygen, sulfur, selenium, nitrogen, phosphorus.

Preferably, the subject matter of the invention is a compound represented by a formula 3c or 3d or 3e

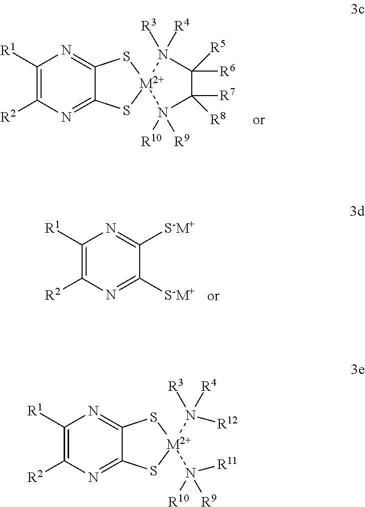

in which
M²⁺ is Zn, Cu, Mg, Ca cation,
M⁺ is Li, Na, K, Cs, Cu or Cu^{x}(E)ₙ cation
n is 1 or 2;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently an alkoxy group (—OR″), a sulfide group (—SR″), a sulfoxide group (—S(O)R″), a sulfonium group (—S⁺R″₂), a sulfonyl group (—SO₂R′), a sulfonamide group (—SO₂NR″₂), an amine group (—NR″₂), an ammonium group (—N⁺R″₃), a nitro group (—NO₂), a cyano group (—CN), a phosphonate group (—P(O)(OR″)₂), a phosphinate group (—P(O)R″(OR″)), a phosphonite group (—P(OR″)₂), a phosphine group (—PR″₂), a phosphine oxide group (—P(O)R″₂), a phosphonium group (—P⁺R″₃), a carboxyl group (—COOH), an ester group (—COOR″), an amide group (—CONR″₂), an amide group (—NR″C(O)R″), a formyl group (—CHO), a ketone group (—COR″), a thioamide group (—CSNR″₂), a thioketone group (—CSR″), a thionoester group (—CSOR″), a thioester group (—COSR″), a dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group;
or R¹ and R², taken together, form a substituted or unsubstituted cyclic C₄-C₁₀, polycyclic C₄-C₁₂, aromatic C₄-C₁₀, heteroaromatic C₄-C₁₀, polyaromatic C₄-C₁₀, and polyheteroaromatic C₄-C₁₀ system, which can be substituted by one and/or more substituents selected from hydrogen, halogen, C₁-C₂₃ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus;
R³, R⁴, R⁵, R⁶, R⁷, R⁸, R⁹, R¹⁰, R¹¹ and R¹² independently are hydrogen, C₁-C₂₅ alkyl, C₁-C₂₅ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or two selected R³, R⁴, R⁵, R⁶, R⁷, R⁸, R⁹, R¹⁰, R¹¹ and R¹² substituents, taken together, form a substituted or unsubstituted cyclic C₄-C₁₀, polycyclic C₄-C₁₂, heterocyclic C₄-C₁₂, aromatic C₄-C₁₀, heteroaromatic C₄-C₁₀, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy, and halogen.

Preferably, the subject matter of the invention is a compound 3f

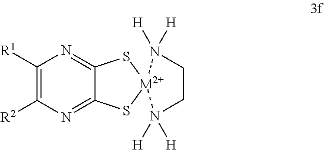

in which
M²⁺ is Zn cation,
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently an alkoxy group (—OR″), a sulfide group (—SR″), a sulfoxide group (—S(O)R″), a sulfonium group (—S⁺R″₂), a sulfonyl group (—SO₂R″), a sulfonamide group (—SO₂NR″₂), an amine group (—NR″₂), an ammonium group (—N′R″₃), a nitro group (—NO₂), a cyano group (—CN), a phosphonate group (—P(O)(OR″)₂), a phosphinate group (—P(O)R″(OR″)), a phosphonite group (—P(OR″)₂), a phosphine group (—PR″₂), a phosphine oxide group (—P(O)R″₂), a phosphonium group (—P⁺R″₃), a carboxyl group (—COOH), an ester group (—COOR″), an amide group (—CONR″₂), an amide group (—NR″C(O)R″), a formyl group (—CHO), a ketone group (—COR″), a thioamide group (—CSNR″₂), a thioketone group (—CSR″), a thionoester group (—CSOR″), a thioester group (—COSR″), a dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group;
or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₁₂ perfluoroalkyl group, C₁-C₁₂ alkoxy group, C₅-C₂₄ aryloxy group, C₅-C₂₀ heteroaryloxy group, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus.

Preferably, the subject matter of the invention is a compound whose structure is represented by a formula selected from such as 3-Zn1, 3-Zn2, 3-Zn3, 3-Zn4, 3-Zn5, 3-Zn6, 3-Zn7, 3-Zn8, 3-Zn9, 3-Zn10, 3-Zn11, 3-Zn12, 3-Zn13, and 3-K1:

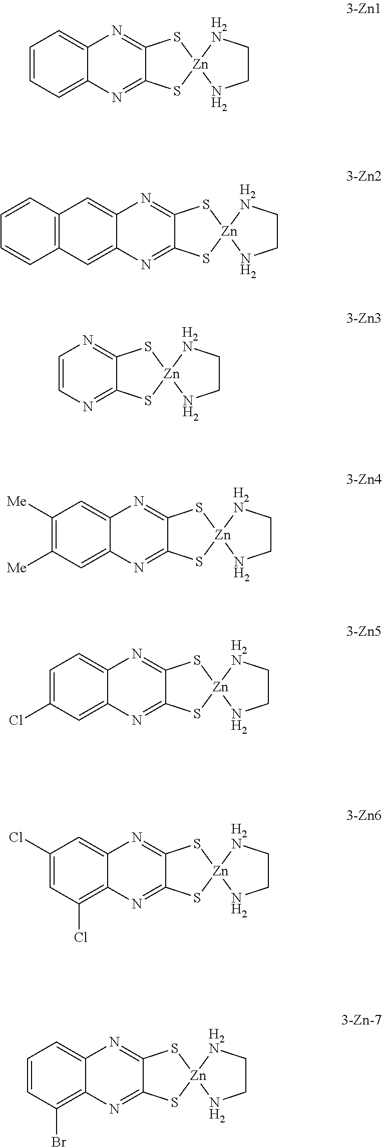

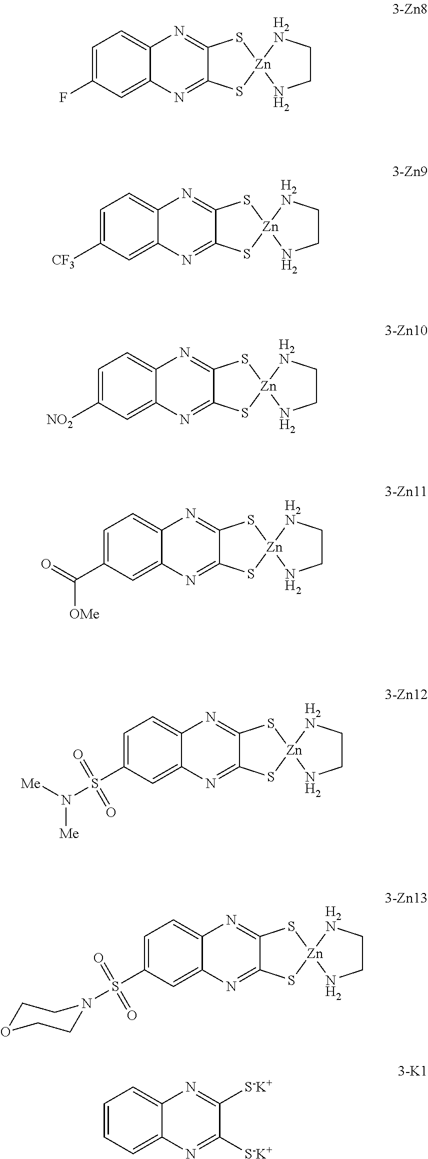

The subject matter of the invention is also a method of producing a ruthenium complex of formula 1-Ru, as defined above

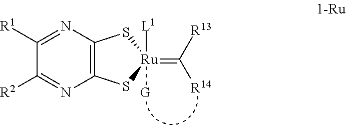

in which:
L¹ is a neutral ligand, selected from N-heterocyclic carbenes (NHCs), cyclic alkylaminocarbene (CAAC) or phosphines;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl or C₅-C₂₄ heteroaryloxy, which are optionally substituted by at least one C₁-C₁₂ alkyl or C₁-C₁₂ perfluoroalkyl, or R¹ and R² are independently an alkoxy group (—OR″), a sulfide group (—SR″), a sulfoxide group (—S(O)R″), a sulfonium group (—S⁺R″₂), a sulfonyl group (—SO₂R′), a sulfonamide group (—SO₂NR″₂), an amine group (—NR″₂), an ammonium group (—N′R″₃), a nitro group (—NO₂), a cyano group (—CN), a phosphonate group (—P(O)(OR″)₂), a phosphinate group (—P(O)R″(OR″)), a phosphonite group (—P(OR″)₂), a phosphine group (—PR″₂), a phosphine oxide group (—P(O)R″₂), a phosphonium group (—P⁺R″₃), a carboxyl group (—COOH), an ester group (—COOR″), an amide group (—CONR″₂), an amide group (—NR″C(O)R″), a formyl group (—CHO), a ketone group (—COR″), a thioamide group (—CSNR″₂), a thioketone group (—CSR″), a thionoester group (—CSOR″), a thioester group (—COSR″), a dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group;
or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus.
R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ arylalkyl, optionally substituted C₅-C₂₅ heteroaryl, optionally substituted C₅-C₂₅ heteroaryloxy, optionally substituted C₃-C₂₅ perfluoroaryl, 3-12-membered heterocycle containing sulfur, oxygen, nitrogen, selenium or phosphorus, optionally substituted;
wherein R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium or phosphorus, optionally substituted with one and/or more substituents independently selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle;
wherein R¹³ and R¹⁴ substituents are independently preferably hydrogen and/or C₅-C₂₅ aryl independently substituted with hydrogen, halogen, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group independently is hydrogen, C₁-C₅ alkyl, C₁-C₅ perfluoroalkyl, C₆-C₂₄ aryl, C₇-C₂₄ aralkyl, C₅-C₂₄ perfluoroaryl, the two R″ groups, taken together, may form either C₃-C₁₂ cycloalkyl ring or C₃-C₂₅ heterocycloalkyl ring containing nitrogen, oxygen or sulfur, optionally additionally substituted with C₁-C₁₂ alkyl group, alternatively R″ is a ketone group (—COR^{c}) in which R^{c} is C₁-C₁₂ perfluoroalkyl or an alkoxy group (—OR^{d}) in which R^{d} is C₁-C₁₂ alkyl or C₃-C₁₂ heterocycloalkyl containing nitrogen, oxygen or sulfur optionally additionally substituted with C₁-C₁₂ alkyl group;
G is selected from such as
   L² ligand

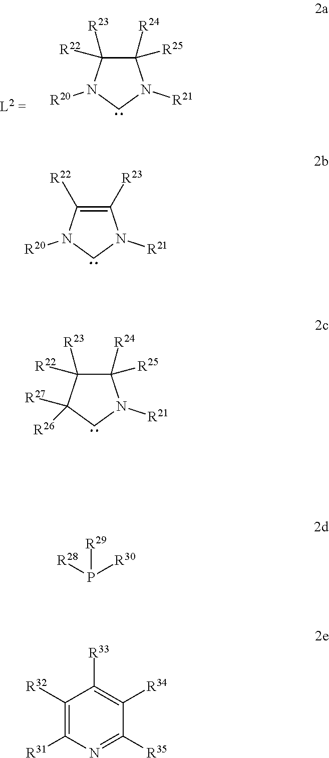

in which R²⁰ and R²¹ substituents are independently C₁-C₁₂ alkyl group, C₃-C₁₂ cycloalkyl group, C₅-C₂₀ aryl group or C₅-C₂₀ heteroaryl group, C₅-C₂₅ aralkyl group, which may be substituted independently by one and/or more substituents selected from a group comprising hydrogen,
C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy group, C₅-C₂₄ aryloxy group, C₅-C₂₀ heteroaryloxy group, or halogen, alkoxy group (—OR″), sulfide group (—SR″), halogen, amine group (—NR″₂), in which the R″ group independently is hydrogen, C₁-C₅ alkyl, C₆-C₂₄ aryl, C₇-C₂₄ aralkyl, alternatively R²⁰ and R²¹, taken together, form C₅-C₂₅ ring;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group: C₅-C₂₀ aryl group, C₅-C₂₀ heteroaryl group, ester group (—OCOR^{b}), (—COR^{d}) group, methylester group (—CH₂OCOR^{b}), in which the R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or amine group (—NR^{e}₂) in which each R^{d} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²², R²¹, R²², R²³, R²⁴, R²⁵, R²⁶, and R²⁷ substituents may optionally be interconnected to form C₄-C₁₀ cyclic system or C₄-C₁₂ polycyclic system;
each R²⁸, R²⁹, and R³⁰ substituent is independently C₁-C₂₅ alkyl, C₁-C₂₅ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹, R³⁰, taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen;
each R³¹, R³², R³³, R³⁴ and R³⁵ substituent is independently C₁-C₁₂ alkyl group, C₃-C₁₂ cycloalkyl group, C₅-C₂₀ aryl group or C₅-C₂₀ heteroaryl group, which may be substituted independently by one and/or more substituents selected from a group comprising hydrogen, C₁-C₁₂ alkyl group, C₁-C₁₂ perfluoroalkyl group, C₁-C₁₂ alkoxy group, C₅-C₂₄ aryloxy group, C₅-C₂₀ heteroaryloxy group, or halogen; or
heteroatom 1
   selected from a group comprising oxygen, sulfur, selenium, substituted by a group selected from such as hydrogen, halogen, oxygen, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′2), Weinreb-type amide (—CON(R′)(OR′)), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl, or C₅-C₂₄ heteroaryloxy and then the dashed line represents a direct binding of the heteroatom to the R¹⁴ substituent or represents the connection of the R¹⁴ substituent to the heteroatom via a (CH₂)—, —(CHR′)—, or (CR′₂)— methylene bridge, wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₂), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), wherein the R″ group is C₁-C₅ alkyl, C₁-C₅ perfluoroalkyl, C₆-C₂₄ aryl, C₇-C₂₄ aralkyl, C₅-C₂₄ perfluoroaryl; or
heteroatom 2
   selected from a group comprising nitrogen, or phosphorus, substituted by a group selected from such as hydrogen, methylidene optionally substituted by an R′ substituent, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, acyl group (—COR′), tert-butyloxycarbonyl group (t-Boc) or 9-fluorenylmethoxycarbonyl group (Fmoc), carbamate group (—CONR [symbol] ₂), sulfonic group (—SO₂R′), formyl group (—COH), in which R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′₂), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy and then the dashed line represents a direct binding of the heteroatom to the R¹⁴ substituent or represents the connection of the R¹⁴ substituent to the heteroatom via a (CH₂)—, —(CHR′)—, or (CR′₂)— methylene bridge; wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₃-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, or
heteroatom 3
   selected from a group comprising a halogen, and then the dashed line represents a direct binding of the heteroatom to the R¹⁴ substituent, wherein the R¹⁴ substituent is C₅-C₁₅ aryl, or C₅-C₂₅ polyaryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which R″ group is C₁-C₅ alkyl, C₁-C₅ perfluoroalkyl, C₆-C₂₄ aryl, C₇-C₂₄ aralkyl, C₅-C₂₄ perfluoroaryl;
characterized in that the alkylidene ruthenium complex of formula 4-Ru:

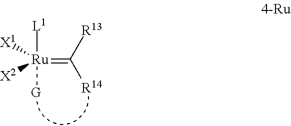

in which:
X¹ and X², independently, are anionic ligand selected from a group comprising halogen anion, —CN, —SCN, —OR^{a}, —SR^{a}, —O(C═O)R^{a}, —O(SO₂)R^{a}, and —OSi(R^{a})₃, in which R^{a} is C₁-C₁₂ alkyl, C₃-C₁₂ cycloalkyl, C₂-C₁₂ alkenyl or C₅-C₂₀ aryl, which is optionally substituted by at least one C₁-C₁₂ alkyl, C₁-C₁₂ perfluoroalkyl, C₁-C₁₂ alkoxy, C₅-C₂₄ aryloxy, C₅-C₂₀ heteroaryloxy or a halogen;
L¹ is a neutral ligand selected from N-heterocyclic carbenes (NHCs), cyclic alkylaminocarbene (CAAC) or phosphines;
R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ arylalkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium, or phosphorus which may be substituted independently with one and/or more substituents selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle;
wherein the R¹³ and R¹⁴ substituents independently preferably are hydrogen and/or C₅-C₂₅ aryl independently substituted with hydrogen, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N′R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl;
G is selected from such as
   L² ligand

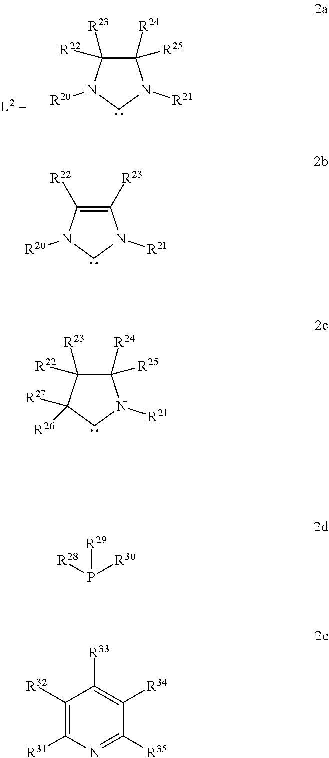

in which the R²⁰ and R²¹ substituents are independently C₁-C₁₂ alkyl group, C₃-C₁₂ cycloalkyl group, C₅-C₂₀ aryl group or C₅-C₂₀ heteroaryl group, C₅-C₂₅ aralkyl group, which can be substituted independently by one and/or more substituents selected from a group comprising hydrogen, C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy group, C₅-C₂₄ aryloxy group, C₅-C₂₀ heteroaryloxy group, or halogen, alkoxy group (—OR″), sulfide group (—SR″), halogen, amine group (—NR″₂), in which the R″ group independently is hydrogen, C₁-C₅ alkyl, C₆-C₂₄ aryl, C₇-C₂₄ aralkyl, alternatively R²⁰ and R²¹, taken together form C₅-C₂₅ ring;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or an amino group (—NR^{e}₂) in which each R^{d} is independently hydrogen or C₁-C₁₂ alkyl, the two R^{e} groups may, taken together, form a C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form cyclic C₄-C₁₀ system or polycyclic C₄-C₁₂ system;
each R²⁸, R²⁹, and R³⁰ substituent is independently C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹, R³⁰, taken together, form a substituted or unsubstituted cyclic C₄-C₁₀, polycyclic C₄-C₁₂, aromatic C₄-C₁₀, heteroaromatic C₄-C₁₀ system which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen;
each R³¹, R³², R³³, R³⁴ and R³⁵ substituent is independently C₁-C₁₂ alkyl group, C₃-C₁₂ cycloalkyl group, C₅-C₂₀ aryl group or C₅-C₂₀ heteroaryl group, which may be substituted independently by one and/or more substituents selected from a group comprising hydrogen, C₁-C₁₂ alkyl group, C₁-C₁₂ perfluoroalkyl group, C₁-C₁₂ alkoxy group, C₅-C₂₄ aryloxy group, C₅-C₂₀ heteroaryloxy group, or halogen; or
heteroatom 1
   selected from a group comprising oxygen, sulfur, selenium, substituted by a group selected from such as hydrogen, halogen, oxygen, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′₂), Weinreb-type amide (—CON(R′)(OR′)), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl, or C₅-C₂₄ heteroaryloxy and then the dashed line represents a direct binding of the heteroatom to the R¹⁴ substituent or represents the connection of the R¹⁴ substituent to the heteroatom via a —CH₂—, —CHR′—, or —CR′₂— methylene bridge, wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, or
heteroatom 2
   selected from a group comprising nitrogen, or phosphorus, substituted by a group selected from such as hydrogen, methylidene optionally substituted by an R′ substituent, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, acyl group (—COR′), tert-butyloxycarbonyl group (t-Boc) or 9-fluorenylmethoxycarbonyl group (Fmoc), carbamate (—CONR [symbol] ₂), sulfonic (—SO₂R [symbol] ), formyl (—COH), in which the R [symbol] group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′₂), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy and then the dashed line represents a direct binding of the heteroatom to the R¹⁴ substituent, or represents the connection of the R¹⁴ substituent to the heteroatom via a (CH₂)—, —(CHR′)—, or (CR′₂)— methylene bridge; wherein the R¹⁴ substituent is C₅-C₁₅ aryl eventually substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₃-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, or
heteroatom 3
   selected from a group comprising halogen, and then the dashed line represents a direct binding of the heteroatom to the R¹⁴ substituent, wherein the R¹⁴ substituent is C₅-C₁₅ aryl, or C₅-C₂₅ polyaryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which R″ group is C₁-C₅ alkyl, C₁-C₅ perfluoroalkyl, C₆-C₂₄ aryl, C₇-C₂₄ aralkyl, C₅-C₂₄ perfluoroaryl;
is reacted with a compound of the structure defined by formula 3a or 3b

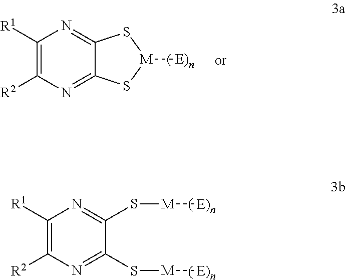

in which
M is monovalent or divalent metal cation;
n is 0, 1 or 2;
E is at least one heteroatom selected from a group comprising oxygen, sulfur, selenium, nitrogen, phosphorus, which are substituted with a group, or if the heteroatom is nitrogen or phosphorus, with groups: C₁-C₂₅ alkyl group, C₁-C₂₅ cycloalkyl group, C₅-C₂₀ alkoxy group, C₅-C₂₀ aryl group, C₇-C₂₀ aralkyl group, C₅-C₂₄ aryloxy group, C₂-C₁₂ alkenyl group, C₆-C₂₀ heteroaryl group, C₅-C₂₄ heteroaryloxy group, or hydrogen, which are optionally substituted by at least one C₁-C₁₂ alkyl or C₁-C₁₂ perfluoroalkyl, or if two identical or different heteroatoms constitute a chelating system then, taken together, they form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy, and halogen;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently alkoxy group (—OR″), sulfide group (—SR″), sulfoxide group (—S(O)R″), sulfonium group (—S⁺R″₂), sulfonyl group (—SO₂R′), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
or R¹ and R², taken together, form a substituted or unsubstituted C₄-C₁₀ cyclic, C₄-C₁₂ polycyclic, C₄-C₁₀ aromatic, C₄-C₁₀ heteroaromatic, C₄-C₁₀ polyaromatic, and C₄-C₁₀ polyheteroaromatic system which can be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus.

The invention also relates to the use of a compound of formula 1-Ru as a precatalyst and/or catalyst in olefin metathesis reactions, particularly in ring-closing metathesis (RCM), cross-metathesis (CM), homometathesis (cross-metathesis between two molecules of the same olefin), ethenolysis, isomerization, in diastereoselective ring rearrangement metathesis (DRRM) reactions, alkene-alkyne (ene-yne) metathesis or ROMP and ADMET-type polymerization reactions.

Preferably, the olefin metathesis reactions are carried out with 1-Ru catalyst and/or precatalyst in the presence of a compound with a structure represented by a formula selected from such as 3-Zn1, 3-Zn2, 3-Zn3, 3-Zn4, 3-Zn5, 3-Zn6, 3-Zn7, 3-Zn8, 3-Zn9, 3-Zn10, 3-Zn11, 3-Zn12, 3-Zn13, 3-K1 in an amount ranging from 0.0001 mol % to 200 mol %.

Preferably, the reaction is carried out in an organic solvent such as toluene, benzene, mesitylene, hexane, dichloromethane, dichloroethane, chlorobenzene, perfluorobenzene, perfluorotoluene, ethyl acetate, methyl acetate, methyl carbonate, ethyl carbonate, methyl tert-butyl ether, cyclopentyl methyl ether, diethyl ether, THF, 2-Me-THF, 4-Me-THP, dioxane, DME, PAO, PEG, paraffin, esters of saturated fatty acids.

Preferably, the reaction is carried out in a solvent-free system.

Preferably, the reaction is carried out at a temperature of 20 to 200° C.

Preferably, the reaction is carried out over a period of 5 minutes to 48 hours.

Preferably, the 1-Ru compound is used in an amount of not more than 10 mol %.

Preferably, the 1-Ru compound is used in an amount of not more than 0.1 mol %.

Preferably, the 1-Ru compound is added to the reaction mixture portion-wise in a solid form and/or continuously, using a pump, as a solution in an organic solvent.

Preferably, a gaseous by-product of the reaction, selected from ethylene, propylene, butylene, is actively removed from the reaction mixture using an inert gas barbotage or by vacuum.

The subject matter of the invention is explained in the embodiments shown in the FIGURES, where:

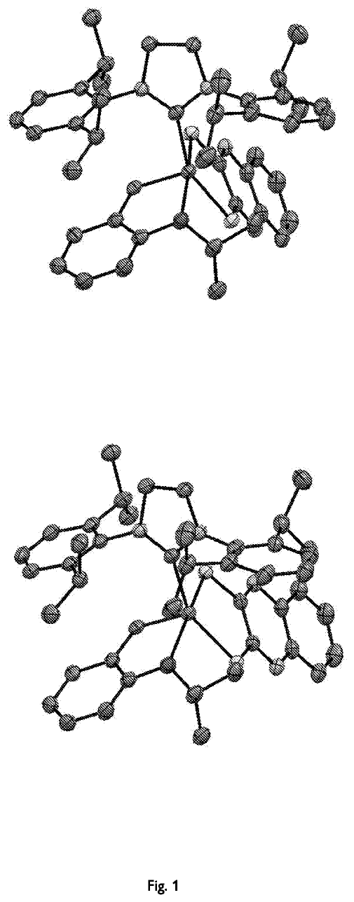

FIG. 1 shows the structure of stereoretentive ruthenium complex 1-Ru1a according to the invention, obtained from X-ray structural analysis, presented in two spatial projections.

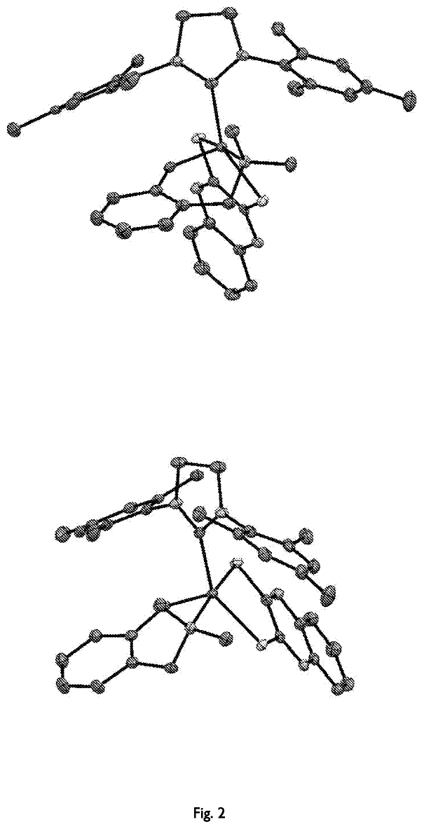

FIG. 2 shows the structure of stereoretentive ruthenium complex 1-Ru1ar according to the invention, obtained from X-ray structural analysis, presented in two spatial projections.

In this description the terms used have the following meanings. Undefined terms herein have meanings which are given and understood by a person skilled in the art in light of the best knowledge possessed, the present disclosure and the context of the patent application specification. Unless stated otherwise, the following conventions of chemical terms are used in this description and have the meanings indicated as in the definitions below:

As used herein, the term “halogen” means an element selected from F, Cl, Br, I.

The term “carbene” means an electrically neutral molecule in which the carbon atom has two non-bonding electrons in the singlet or triplet state and is linked by a single covalent bond to two groups or linked by a double covalent bond to one group. The term “carbene” also includes carbene analogues in which the carbene carbon atom is replaced by another chemical element such as boron, silicon, germanium, tin, lead, nitrogen, phosphorus, sulfur, selenium or tellurium.

The term “alkyl” means a saturated, linear, or branched hydrocarbon substituent with the indicated number of carbon atoms. Examples of an alkyl substituent are -methyl, -ethyl, -n-propyl, -n-butyl, -n-pentyl, -n-hexyl, -n-heptyl, -n-octyl, -n-nonyl, and -n-decyl. Representative branched —(C₁-C₁₀) alkyls include-isopropyl, -sec-butyl, -isobutyl, -tert-butyl, -isopentyl, -neopentyl, -1-methylbutyl, -2-methylbutyl, -3-methylbutyl, -1,1-dimethylpropyl, -1,2-dimethylpropyl, -1-methylpentyl, -2-methylpentyl, -3-methylpentyl, -4-methylpentyl, -1-ethylbutyl, -2-ethylbutyl, -1,1-dimethylbutyl, -1,2-dimetylbutyl, -1,3-dimethylbutyl, -2,2-dimethylbutyl, -2,3-dimethylbutyl, -3,3-dimethylbutyl, -1-methylhexyl, -2-methylhexyl, -3-methylhexyl, -4-methylhexyl, -1,2-dimethylpentyl, -1,3-dimethylpentyl, -5-methylhexyl, -1,2-dimethylhexyl, -1,3-dimethylhexyl, -3,3-dimethylhexyl, -1,2-dimethylheptyl, -1,3-dimethylheptyl, -3,3-dimethylheptyl, and the like.

The term “alkoxy” means an alkyl substituent as defined above attached via an oxygen.

The term “perfluoroalkyl” means an alkyl group as defined above in which all hydrogens have been replaced by identical or different halogens.

The term “cycloalkyl” means a saturated mono- or polycyclic hydrocarbon substituent with the indicated number of carbon atoms. Examples of a cycloalkyl substituent are -cyclopropyl, -cyclobutyl, -cyclopentyl, -cyclohexyl, -cycloheptyl, -cyclooctyl, -cyclononyl, -cyclodecyl, and the like.

The term “alkenyl” means an unsaturated, linear, or branched non-cyclic hydrocarbon substituent with the indicated number of carbon atoms and containing at least one carbon-carbon double bond. Examples of an alkenyl substituent are -vinyl, -allyl, -1-butenyl, -2-butenyl, -isobutylenyl, -1-pentenyl, -2-pentenyl, -3-methyl-1-butenyl, -2-methyl-2-butenyl, -2,3-dimethyl-2-butenyl, -1-hexenyl, -2-hexenyl, -3-hexenyl, -1-heptenyl, -2-heptenyl, -3-heptenyl, -1-octenyl, -2-octenyl, -3-octenyl, -1-nonenyl, -2-nonenyl, -3-nonenyl, -1-decenyl, -2-decenyl, -3-decenyl, and the like.

The term “cycloalkenyl” means an unsaturated cyclic or branched cyclic hydrocarbon substituent with the indicated number of carbon atoms and containing at least one carbon-carbon double bond. Examples of cycloalkenyl substituent are -cyclopropene, -cyclobutene, -cyclopentene, -cyclohexene, -cycloheptene, -cyclooctene, cyclononene, -cyclodecene, -methylcyclopropene, -ethylcyclobutene, -isopropylcyclopentene, -methylcyclohexene, and the like.

The term “aryl” means an aromatic mono- or polycyclic hydrocarbon substituent with the indicated number of carbon atoms. Examples of an aryl substituent are -phenyl, -tolyl, -xylyl, -naphthyl, -2,4,6-trimethylphenyl, -2-fluorophenyl, -4-fluorophenyl, -2,4,6-trifluorophenyl, -2,6-difluorophenyl, -4-nitrophenyl, and the like.

The term “aralkyl” means an alkyl substituent as defined above substituted with at least one aryl as defined above. Examples of an aralkyl substituent are -benzyl, -diphenylmethyl, -triphenylmethyl, and the like.

The term “heteroaryl” means an aromatic mono- or polycyclic hydrocarbon substituent with the indicated number of carbon atoms, in which at least one carbon atom has been replaced by a heteroatom selected from the O, N and S. Examples of a heteroaryl substituent are -furyl, -tienyl, -imidazolyl, -oxazolyl, -thiazolyl, -isoxazolyl, -triazolyl, -oxadiazolyl, -thiadiazolyl, -tetrazolyl, -pyridyl, -pyrimidyl, -triazinyl, -indolyl, -benzo[b]furyl, -benzo[b]thienyl, -indazolyl, -benzoimidazolyl, -azaindolyl, -quinolyl, -isoquinolyl, -carbazolyl, and the like.

The term “heterocycle” means a saturated, unsaturated or partially unsaturated, mono- or polycyclic hydrocarbon substituent, with the indicated number of carbon atoms, in which at least one carbon atom has been replaced by a heteroatom selected from O, N and S. Examples of a heterocyclic substituent are -furyl, -thiophenyl, -pirolyl, -oxazolyl, -imidazolyl, -thiazolyl, -isoxazolyl, -pirazolyl, -isothiazolyl, -triazinyl, -pirolidinonyl, -pirolidinyl, -hydantoinyl, -oxiranyl, -oxetanyl, -tetrahydrofuranyl, -tetrahydrothiophenyl, -quinolinyl, -isoquinolinyl, -chromonyl, -coumarinyl, -indolyl, -indolizinyl, -benzo[b]furanyl, -benzo[b]thiophenyl, -indazolyl, -purinyl, -4H-quinolysinyl, -isoquinolyl, -quinolyl, -phthalazinyl, -naphthyridinyl, -carbazolyl, -β-carbolinyl, and the like.

The term “neutral ligand” means an uncharged substituent capable of coordinating with a metallic center (transition metal atom). Examples of such ligands may be: N-heterocyclic carbenes (NHCs), cyclic alkylaminocarbenes (CAACs), amines, phosphines and their oxides, alkyl and aryl phosphites and phosphates, arsines and their oxides, ethers, alkyl and aryl sulfides, coordinated unsaturated or aromatic hydrocarbons, alkyl and aryl halides, nitriles, isonitriles, sulfides, sulfoxides, sulfones, thioketones, thioamides, thioesters, thionoesters and dithioesters.

The term “anionic ligand” means a substituent capable of coordinating with a metallic center (transition metal atom) and having a charge which is capable of partial or full metallic center charge compensation. Examples of such ligands may be fluoride anions, chloride anions, bromide anions, iodide anions, cyanide anions, cyanate anions and thiocyanate anions, anions of carboxylic acids, anions of alcohols, anions of phenols, anions of thiols and thiophenols, anions of hydrocarbons with delocalized charge (such as cyclopentadiene anion), anions of (organo) sulfuric and (organo)phosphoric acids and esters thereof (such as for example anions of alkyl and aryl sulfonic acids, anions of alkyl and aryl phosphoric acids, anions of alkyl and aryl esters of sulfuric acid, anions of alkyl and aryl esters of phosphoric acids, anions of alkyl and aryl esters of alkyl and aryl phosphoric acids). Alternatively, an anionic ligand may have L¹, L² and L³ groups, linked as the catechol anion, acetylacetone anion, salicylaldehyde anion. Anionic ligands (X¹, X²) and neutral ligands (L¹, L², L³) can be linked together to form multidentate ligands, for example, a bidentate ligand (X¹-X²), a tridentate ligand (X¹-X²-L¹), tetradentate ligand (X¹-X²-L¹-L²), bidentate ligand (X¹-L¹), tridentate ligand (X¹-L¹-L²), tetradentate ligand (X¹-L¹-L²-L³), bidentate ligand (L¹-L²), tridentate ligand (L¹-L²-L³). Examples of such ligands are catechol anion, dithiocatechol anion, acetylacetone anion, and salicylaldehyde anion.

The term “heteroatom” means an atom selected from a group comprising oxygen, sulfur, nitrogen, phosphorus, boron, silicon, arsenic, selenium, tellurium.

The term “PAO” means polyolefins, an abbreviation for Poly-Alpha-Olefins, in the case of the present invention it is an abbreviation used for low molecular weight polyolefins used as high boiling point solvents. It denotes also a class of solvents and/or lubricants that are the product of the polymerization of ethylene derivatives, leading to the formation of branched, saturated hydrocarbons, used here as heat-resistant, non-polar, high boiling point solvents.

### EMBODIMENTS OF THE INVENTION

The following examples are included only to illustrate the invention and to clarify particular aspects of the invention, not to limit it, and should not be considered the entire scope of the invention as defined in the appended claims. In the following examples, unless stated otherwise, standard materials and methods used in the art were applied or manufacturers' recommendations for specific reactants and methods were followed.

When necessary, model compounds for the metathesis reaction were purified by fractional distillation and then stored in an inert gas atmosphere over activated inert aluminum oxide. Tetrahydrofuran was purified by distillation over sodium-potassium alloy in the presence of benzophenone and then stored over 4 Å molecular sieves. When appropriate, the selected reactions were carried out under an argon atmosphere using reaction vessels heated at 130° C.

Starting compounds for the synthesis of zinc complexes were commercially available.

The composition of the reaction mixtures of the metathesis reactions was studied by gas chromatography, using a PerkinElmer Clarus 680 GC equipped with a GL Sciences InertCap® 5 MS/NP capillary column.

Individual components of the reaction mixtures were identified by comparing retention times with commercial standards or isolated from reaction mixtures for which the structure was confirmed by NMR.

### Example I

### Synthesis of New Dithiolate Ligands and Corresponding Metal Salts

The following Scheme 1 illustrates the synthesis of dithiolate ligand precursors and compounds (general formula VI and general formula VII) allowing the preparation of stereoretentive ruthenium catalysts (general formula 1-Ru1a to 1-Ru1ar and 1-Ru2a to 1-Ru2c, Scheme 10), which are the subject matter of the present invention.

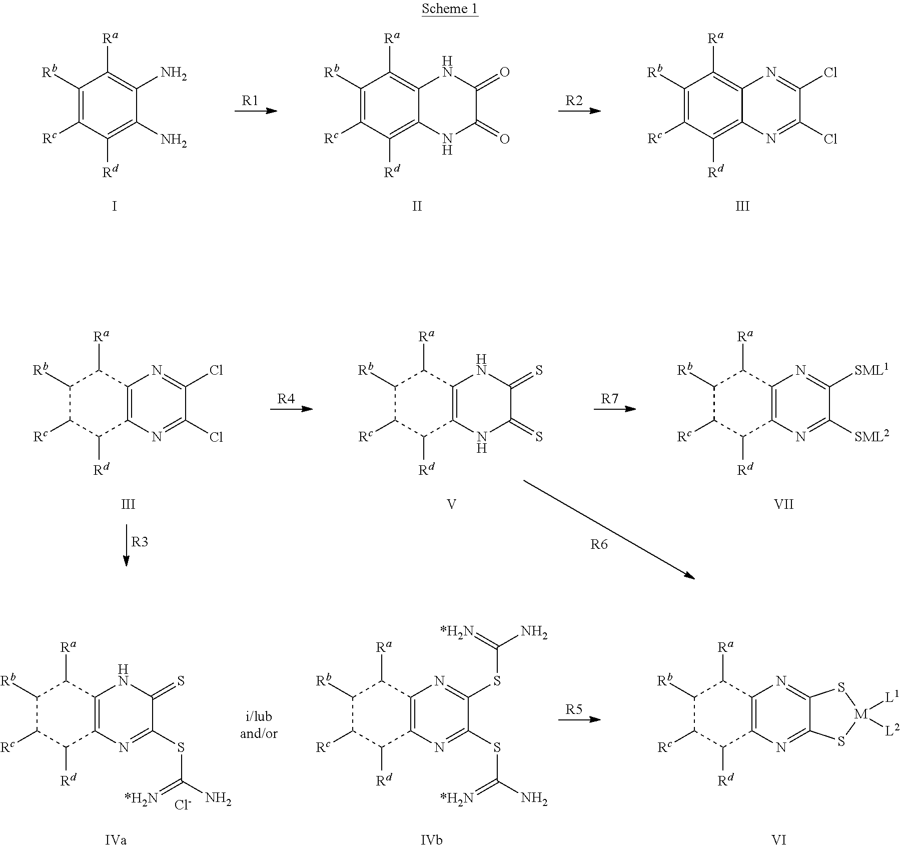

The reactions R1 to R4 shown in Scheme 1 were carried out using commercially available substrates based on procedures described in the literature with modifications developed by the authors. Unless stated otherwise, in the reactions described commercially available solvents were used and no attention was paid to the presence of oxygen and/or moisture.

The subsequent transformations described in Scheme 1 are shown below.

a. Reaction R1

In step R1 (Scheme 1), the synthesis of diamide of general formula II is carried out. For this purpose, diamine of general formula I and a dicarbonyl compound, preferably oxalic acid, dimethyl oxalate or oxalyl chloride, are used. The transformation is carried out in water or an organic solvent, using a catalytic amount of an organic or inorganic acid or using a stoichiometric amount of a base, preferably a non-nucleophilic base. The reaction mixture is heated under a reflux condenser or in a microwave reactor. The product is isolated by filtration from the reaction mixture. [(i) J. Lin, P. Wang, Z. Zhang, G. Xue, D. Zha, J. Wang, X. Xu, Z. Li, Synth. Commun. 2020, 50, 823-830; (ii) O. O. Ajani, C. A. Obafemi, C. O. Ikpo, K. O. Ogunniran, O. C. Nwinyi, Chem. Heterocycl. Compd. 2009, 45, 1370-1378].

### Example of Reaction R1

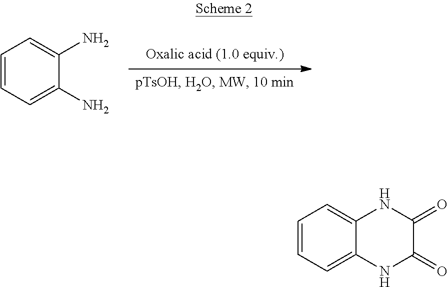 [SMILES: Nc1ccccc1N ; O=c1[nH]c2ccccc2[nH]c1=O]

O-phenylenediamine (2.0 g, 18.4 mmol), oxalic acid dihydrate (1.66 g, 18.4 mmol), 15 ml of water and a catalytic amount of para-toluenesulfonic acid (pTsOH) were introduced into a reaction vessel equipped with a stirring element. The vessel was placed in a microwave reactor (MW), and the content of the vessel was heated for 10 min while maintaining a constant temperature of 100° C. After cooling the mixture to room temperature, the resulting red crystals of the product were filtered off, washed successively with a small amount of ethanol and diethyl ether, and then dried in air to obtain the expected product in 80% yield (2.4 g, 14.8 mmol).

¹H NMR (400 MHZ, DMSO-d₆) δ=11.90 (brs, 2H), 7.07 (ddt, J=18.1, 5.6, 3.5 Hz, 4H).

¹³C NMR (101 MHZ, DMSO-d₆) δ=155.6, 126.0, 123.4, 115.6.

b. Reaction R2

In step R2 (Scheme 1), the resulting diamide of general formula II is converted to a 2,3-dichloroquinoxaline derivative of general formula III with dehydrating chlorinating agent, preferably phosphoryl chloride or thionyl chloride. The reaction is carried out in organic solvent or without solvent; preferably in the presence of dimethylformamide. The reaction mixture is heated under a reflux condenser or in a microwave reactor. The product is isolated by precipitation, followed by filtration of the resulting precipitate, or by extraction with an organic solvent [R. Beldi, K. F. Atta, S. Aboul-Ela, E. S. H. El Ashry, J. Heterocycl. Chem. 2011, 48, 50-56].

### Example of Reaction R2

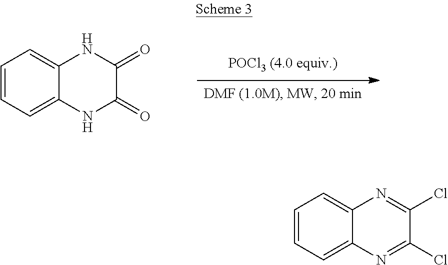 [SMILES: O=c1[nH]c2ccccc2[nH]c1=O ; Clc1nc2ccccc2nc1Cl]

The corresponding reaction product R1 (2.4 g, 14.8 mmol), POCl₃ (5.5 mL, 59.2 mmol) and 15 mL of dry dimethylformamide were introduced into a reaction vessel equipped with a stirring element. The reaction mixture was heated in a microwave reactor for 20 min while maintaining a constant temperature of 50° C. After cooling the post-reaction mixture to the room temperature, the contents of the vessel were carefully poured onto ice. Thus obtained colorless precipitate was filtered off and washed successively with ethanol and diethyl ether. As a result, the expected product was obtained as a colorless solid in 71% yield (2.1 g, 10.6 mmol).

¹H NMR (400 MHZ, CDCl₃) δ=8.03 (dd, J=6.4, 3.4 Hz, 2H), 7.81 (dd, J=6.4, 3.4 Hz, 2H).

¹³C NMR (101 MHZ, CDCl₃) δ=145.4, 140.6, 131.3, 128.2.

c. Functionalization of Substituents Forming Carboxylic or Sulfonic Acid Chlorides

When one of the substituents from R^{a} to R^{d} (Scheme 1.) contains functional groups that react with thionyl chloride or phosphoryl chloride (e.g. carboxylic acids, sulfonic acids), one obtains the compounds of the general formula:

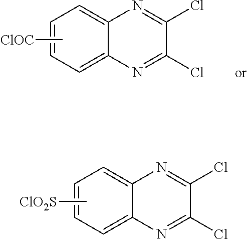

These compounds were used in an additional reaction with a nucleophile in the presence or absence of a base, and can form esters: acyl or sulfonic, or amides: acyl or sulfonic according to Scheme 4.

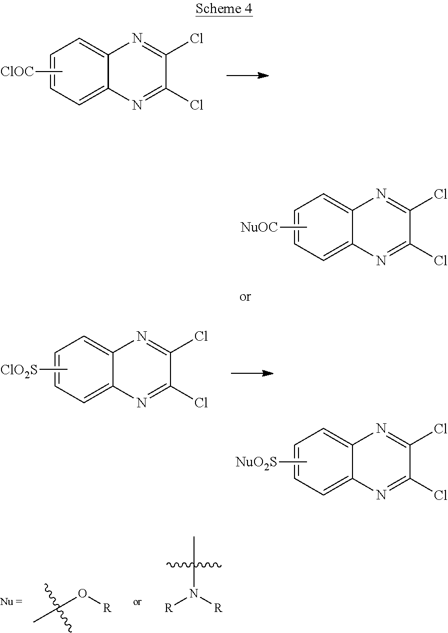

### Example of Reaction

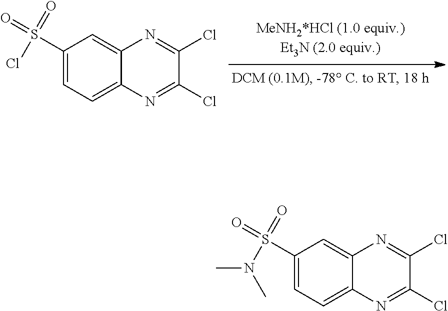 [SMILES: O=S(=O)(Cl)c1ccc2nc(Cl)c(Cl)nc2c1 ; CN(C)S(=O)(=O)c1ccc2nc(Cl)c(Cl)nc2c1]

Dimethylamine hydrochloride (206 mg, 2.52 mmol), 2,3-dichloroquinoxalin-6-sulfonyl chloride (750 mg, 2.52 mmol) and 25 mL of dichloromethane were introduced into the reaction vessel. The vessel was placed in an acetone/dry ice cooling bath, after which triethylamine (0.7 mL, 5.04 mmol) was added dropwise into the reaction mixture. The vessel was then left to warm slowly overnight using the temperature inertia of the cooling bath. The next day, the reaction mixture was transferred to a separatory funnel and washed with water. The aqueous phase was extracted with two portions of dichloromethane. The combined organic phases were dried with anhydrous sodium sulfate, concentrated to about 10% of the initial volume, and then the product was precipitated by adding n-hexane. The resulting precipitate was filtered off under reduced pressure and dried to provide the product as a yellow solid in 65% yield (0.5 g, 1.63 mmol).

¹H NMR (400 MHz, Chloroform-d) δ 8.49 (dd, J=2.0, 0.6 Hz, 1H), 8.22-8.17 (m, 1H), 8.14-8.10 (m, 1H), 2.81 (s, 6H).

d. Reaction R3

In step R3 (Scheme 1), the derivative of general formula III obtained in the previous steps is reacted with an alcoholic thiourea solution. The reaction is carried out at an elevated temperature, preferably 40 to 80° C. Depending on the water content in the solvent, and the substrate used in the reaction, a mixture of products of general formula IVa and IVb of different proportions can be obtained, which can be used in further reactions without much effect on their yields. In the example shown, the dominant compound was the one with the general formula IVa. [(iii) R. Beldi, K. F. Atta, S. Aboul-Ela, E. S. H. El Ashry, J. Heterocycl. Chem. 2011, 48, 50-56; (iv) Ya. Z. Voloshin, A. S. Belov, A. Yu. Lebedev, O. A. Varzatskii, M. Yu. Antipin, Z. A. Starikova, T. E. Kron, Russ. Chem. Bull. 2004, 53, 1218-1222]. The reaction product is isolated and purified by filtration.

### Example of Reaction R3

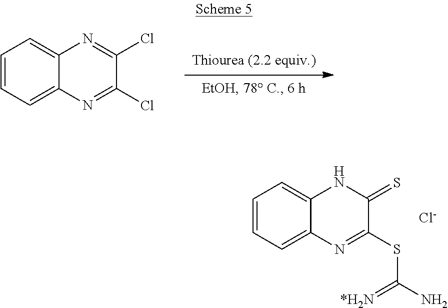

2,3-dichloroquinoxaline (10.3 g, 52 mmol) and thiourea (8.7 g, 115 mmol) were introduced into a reaction vessel equipped with a stirring element. The contents of the vessel were suspended in 120 mL of ethanol and then heated under a reflux condenser for 6 h. After completion of the reaction, the resulting suspension was cooled to room temperature, then filtered off and washed with a small amount of ethanol and diethyl ether. After drying, the product was obtained as a yellow solid in 61% yield (11.0 g, 31.72 mmol).

¹H NMR (400 MHZ, DMSO-d₆) δ 15.14 (brs, 1H), 9.97 (brs, 2H), 9.83 (brs, 2H), 7.88 (dt, J=8.0, 1.0 Hz, 1H). 7.70-7.63 (m, 2H), 7.51 (ddd, J=8.4, 5.6, 2.9 Hz, 1H).

¹³C NMR (101 MHZ, DMSO-d₆) δ 171.0, 164.9, 160.3, 135.1, 131.6, 131.5, 128.2, 127.0, 117.0.

e. Reaction R4

In step R4 (Scheme 1), a derivative of general formula III is treated with sodium bisulfide, in water or an organic solvent, preferably ethanol, at an elevated temperature or in a microwave reactor [(v) S. Henfling, R. Kempt, J. Klose, A. Kuc, B. Kersting, H. Krautscheid, Inorg. Chem. 2020, 59, 16441-16453]. The product after the reaction is isolated by filtration.

Alternatively, the derivative of general formula III is treated with thiourea, in water or an organic solvent, preferably ethanol, at elevated temperature or in a microwave reactor, and then hydrolysis of the resulting mixture under aqueous conditions is carried out using first a solution of an alkali, preferably sodium hydroxide, and then a solution of an organic or inorganic acid, preferably acetic acid.

### Example of Reaction R4

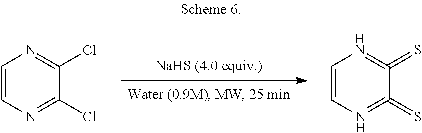

1,2-dichloropyrazine (2.0 g, 13.2 mmol), hydrated sodium bisulfide (2.95 g, 52.6 mmol) and 15 mL of water were introduced into a reaction vessel equipped with a stirring element. The vessel was placed in a microwave reactor, and the contents were heated by maintaining temperature of 95° C. for 25 min. After cooling the reaction mixture to the room temperature, the precipitate formed was filtered off, washed with a small amount of water, ethanol and diethyl ether and then allowed to dry to give the expected product in the form of purple crystals in 84% yield (1.6 g, 11.1 mmol).

¹H NMR (400 MHZ, DMSO-d₆) δ=13.72 (s, 2H), 6.87 (s, 2H).

¹³C NMR (101 MHZ, DMSO-d₆) δ=180.5, 118.0.

### Alternative Example of Reaction R4

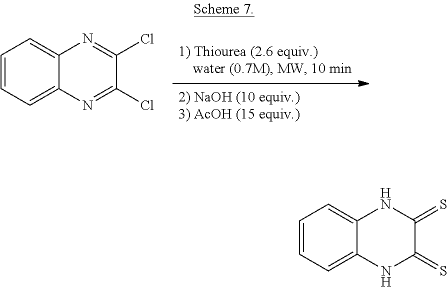 [SMILES: Clc1nc2ccccc2nc1Cl ; S=c1[nH]c2ccccc2[nH]c1=S]

1,2-dichloroquinoxaline (2.1 g, 10.6 mmol), thiourea (2.1 g, 27.4 mmol) and 15 mL of water were introduced into a reaction vessel equipped with a stirring element. The vessel was placed in a microwave reactor, and the content of the vessel was heated by maintaining a temperature of 100° C. for 10 min. After cooling the reaction mixture to the room temperature, NaOH solution (4.22 g in 30 ml of water) was added. The content of the flask was then stirred for another 10 min, after which 9.1 mL of glacial acetic acid was added. The precipitate was filtered off, washed with water, ethanol and diethyl ether, and then allowed to dry. As a result, the expected product was obtained as a brown solid in 73% yield (1.5 g, 7.72 mmol).

¹H NMR (400 MHZ, DMSO-d₆) δ=14.25 (s, 2H), 7.45-7.35 (m, 2H), 7.32-7.21 (m, 2H).

¹³C NMR (101 MHZ, DMSO-d₆) δ=179.7, 128.3, 126.0, 116.0.

f. Reactions R5 and R6

Compounds of general formula IVa, IVb and V can be directly converted to compound of general formula VI using similar reaction conditions. Each of these compounds (IVa, IVb and V) is treated with a metal complex, preferably zinc acetate or zinc chloride, in the presence of ethylenediamine, in water or an organic solvent. The reaction product is separated by filtration.

### Example of Reaction R5

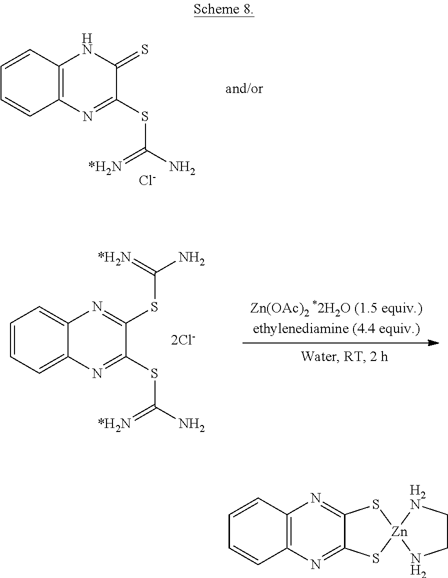

Isothiourethane salt (5.6 g, 15.9 mmol), zinc acetate dihydrate (7.0 g, 31.9 mmol), ethylenediamine (6.5 mL, 95.7 mmol) and 100 ml of water were introduced into a reaction vessel equipped with a stirring element. The reaction was carried out for 2 hours at room temperature, and then the yellow precipitate formed was filtered off, washed with water, ethanol and diethyl ether, and allowed to dry. The expected product was obtained in 66% yield (4.5 g, 14.2 mmol).

By reaction R⁵ using zinc (II) acetate, or iron (II) chloride, or copper (II) chloride, respectively, the following compounds with the general formula

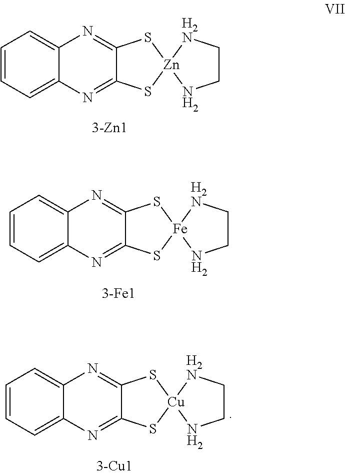

were generated.

### Example of Reaction R6

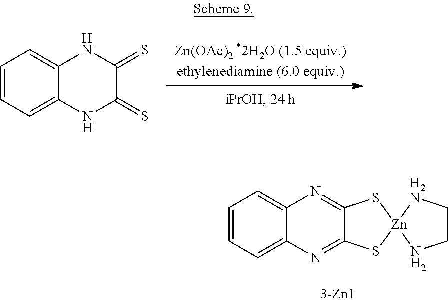

Zinc acetate dihydrate (1.19 g, 5.4 mmol), ethylenediamine (1.46 mL, 21.6 mmol), 1.2 dithioquinoxaline (0.7 g, 3.6 mmol) and 10 mL of isopropanol were introduced into a reaction vessel equipped with a stirring element. The reaction was carried out for 24 hours at room temperature, and then the yellow precipitate formed was filtered off, washed with water, ethanol and diethyl ether and allowed to dry to obtain the expected product 3-Zn1 in 75% yield (0.7 g. 2.72 mmol).

By Reaction R6, the following list of compounds of general formula VI was obtained.

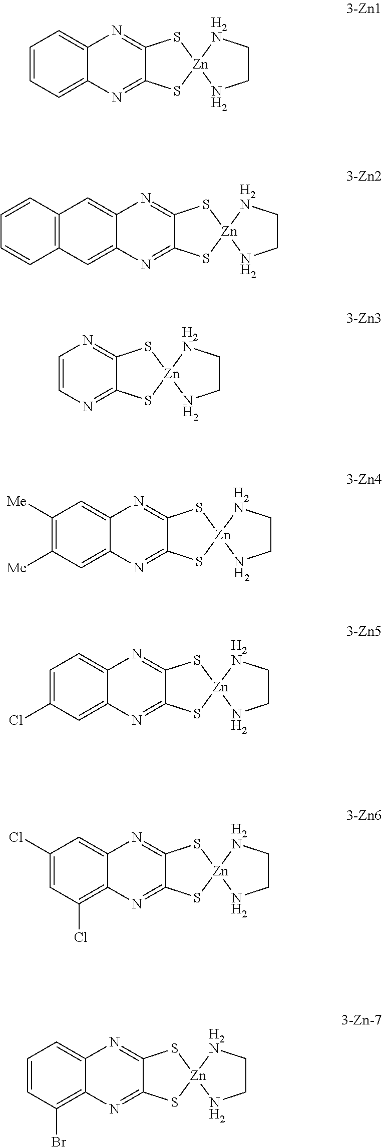

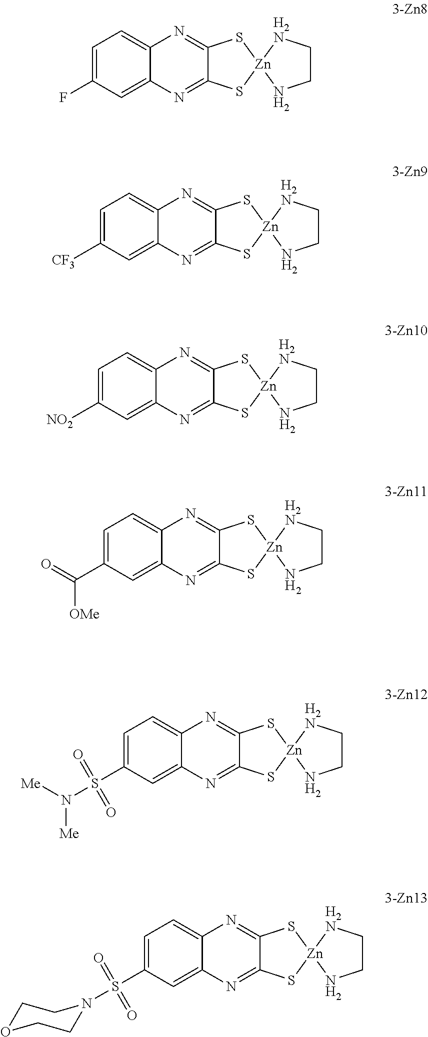

Zinc complexes 3-Zn1 to 3-Zn13 were characterized using ATR IR. The most characteristic absorption bands are shown below:

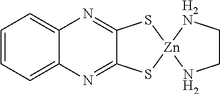

Code name: 3-Zn1
Molecular formula: C₁₀H₁₂N₄S₂Zn
Molar mass: 315.98 g/mol
IR (ATR IR): ν=3331.91, 3250.43, 3063.37, 2949.59, 2882.09, 1698.01, 1590.99, 1374.51, 1268.93, 1158.53, 1128.15, 1099.23, 1019.19, 999.43, 742.94 cm⁻¹

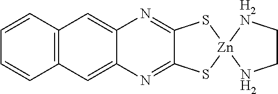

Code name: 3-Zn2
Molecular formula: C₁₄H₁₄N₄S₂Zn
Molar mass: 366.00 g/mol
IR (ATR IR): ν=3048.91, 1659.93, 1650.29, 1632.45, 1591.47, 1394.76, 1320.04, 1293.52, 1177.81, 1150.81, 1098.74, 1023.05, 863.95, 735.23 cm⁻¹

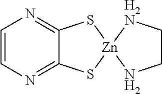

Code name: 3-Zn3
Molecular formula: C₆H₁₀N₄S₂Zn
Molar mass: 265.96 g/mol
IR (ATR IR): ν=3302.98, 3260.56, 3210.41, 3057.10, 2954.89, 2938.50, 2880.17, 1608.34, 1410.19, 1318.11, 1122.85, 1063.55, 1048.60, 1029.80 cm⁻¹

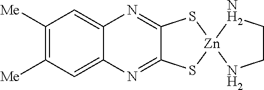

Code name: 3-Zn4
Molecular formula: C₁₂H₁₆N₄S₂Zn
Molar mass: 344.01 g/mol
IR (ATR IR): ν=3344.93, 3327.09, 3295.75, 3248.98, 2975.14, 2942.84, 2915.36, 2885.47, 1243.86, 1198.54, 1127.67, 1108.39, 998.46 cm⁻¹

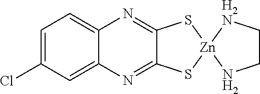

Code name: 3-Zn5
Molecular formula: C₁₀H₁₁ClN₄S₂Zn
Molar mass: 349.94 g/mol
IR (ATR IR): ν=3297.68, 3225.36, 3130.87, 2936.09, 2883.54, 1588.09, 1574.59, 1369.21, 1270.38, 1134.42, 1105.98, 1024.98, 1008.59 cm⁻¹

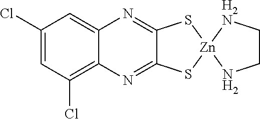

Code name: 3-Zn6
Molecular formula: C₁₀H₁₀Cl₂N₄S₂Zn
Molar mass: 383.90 g/mol
IR (ATR IR): ν=3326.12, 3139.54, 2947.18, 2884.99, 1698.50, 1585.68, 1432.37, 1378.85, 1261.22, 1116.58, 1022.57 cm⁻¹

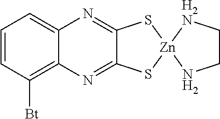

Code name: 3-Zn7
Molecular formula: C₁₀H₁₁BrN₄S₂Zn
Molar mass: 393.89 g/mol
IR (ATR IR): ν=3057.58, 2963.57, 2883.06, 2734.08, 1657.52, 1544.22, 1401.51, 1360.53, 1256.88, 1154.19, 1110.80, 1015.34 cm⁻¹

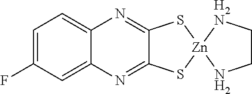

Code name: 3-Zn8
Molecular formula: C₁₀H₁₁FN₄S₂Zn
Molar mass: 333.97 g/mol
IR (ATR IR): ν=3317.44, 3203.67, 3113.03, 3034.44, 2946.22, 2886.43, 1613.64, 1567.36, 1489.26, 1169.13, 1103.08, 1033.18, 1016.78 cm⁻¹

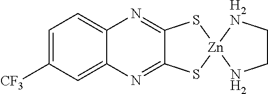

Code name: 3-Zn9
Molecular formula: C₁₁H₁₁F₃N₄S₂Zn
Molar mass: 383.97 g/mol
IR (ATR IR): ν=3226.32, 2953.93, 2885.95, 2647.30, 1378.37, 1340.28, 1306.54, 1277.61, 1108.87, 1169.62, 1060.17, 1023.05 cm⁻¹

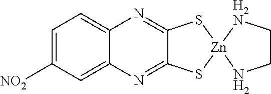

Code name: 3-Zn10
Molecular formula: C₁₀H₁₁N₅O₂S₂Zn
Molar mass: 360.96 g/mol
IR (ATR IR): ν=3337.69, 3286.11, 3261.52, 3145.33, 2920.18, 2874.86, 1602.07, 1556.75, 1506.13, 1399.10, 1382.71, 1335.95, 1319.07, 1269.90, 1144.06, 1110.31, 1068.37, 1004.25, 988.82 cm⁻¹

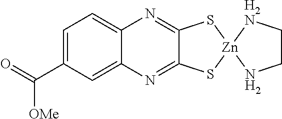

Code name: 3-Zn11
Molecular formula: C₁₂H₁₄N₄O₂S₂Zn
Molar mass: 373.98 g/mol
IR (ATR IR): ν=3261.04, 2946.70, 2884.50, 1698.98, 1607.86, 1378.85, 1294.48, 1266.04, 1229.40, 1137.31, 1107.90, 1013.89, 1433.82 cm⁻¹

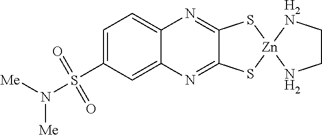

Code name: 3-Zn12
Molecular formula: C₁₂H₁₇N₅O₂S₃Zn
Molar mass: 422.98 g/mol
IR (ATR IR): ν=3329.98, 3254.29, 3166.54, 2939.95, 2882.58, 1590.99, 1458.40, 1374.03, 1315.70, 1243.86, 1138.76, 1106.94, 1065.96, 1003.28, 948.81, 728.00 cm⁻¹

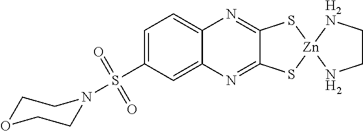

Code name: 3-Zn13
Molecular formula: C₁₄H₁₉N₅O₃S₃Zn
Molar mass: 464.99 g/mol
IR (ATR IR): ν=3544.52, 3319.37, 3249.47, 3139.06, 2945.73, 2888.84, 2865.70, 1704.28, 1698.50, 1581.34, 1456.47, 1378.85, 1260.74, 1141.65, 1110.31, 1017.27, 943.02, 738.12 cm⁻¹

### f. Example of Reaction R7

In step R7 (Scheme 1), a derivative of general formula V is treated with one or more salts, or an organometallic compound, or a metal hydride, preferably lithium, sodium, potassium, magnesium, calcium or copper, respectively, in an organic solvent, preferably THF, at room temperature. The product VII does not have to be isolated, but can be used directly in the synthesis of suitable catalysts (Example IV). By reaction R7, the following compounds with the general formula VII were generated.

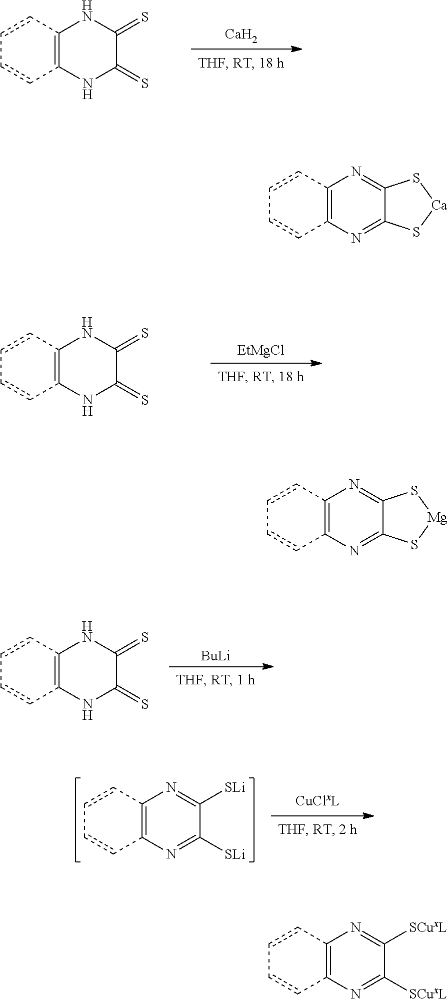

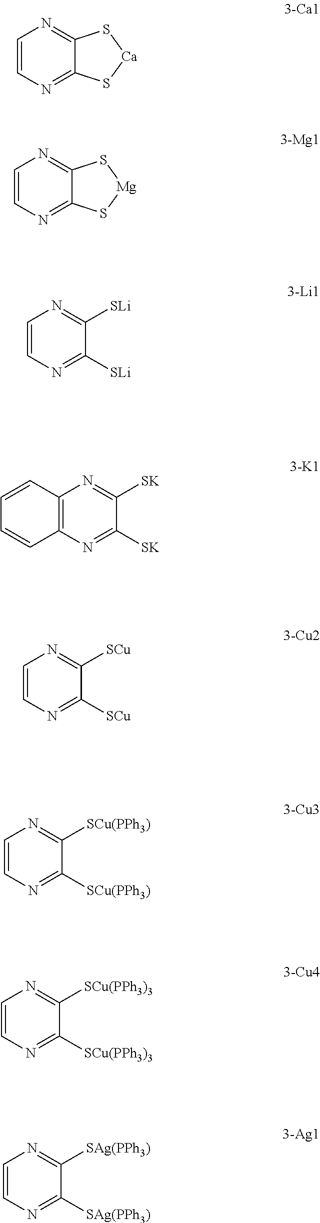

### Example II

### General Method for the Synthesis of Stereoretentive Ruthenium Complexes 1-Ru1a to 1-Ru1ar and 1-Ru2a to 1-Ru2c

The synthesis of stereoretentive ruthenium complexes, which are the subject matter of the present invention, consists in mixing together a metal complex of general structure VI or a reaction R7 product of general formula VII, which is formed in situ by reacting a compound of general formula V with a source of the previously mentioned metal cations and optionally neutral ligands, and an alkylidene ruthenium complex of general structure 4, 4a-Ru or 4b-Ru, according to Scheme 10. The reaction is carried out at room or elevated temperature, in organic solvents, preferably in tetrahydrofuran, while maintaining anhydrous and anaerobic conditions. The product is isolated by filtration of the reaction mixture, followed by evaporation of the resulting filtrate to obtain the expected products 1-Ru1a to 1-Ru1ar or 1-Ru2a to 1-Ru2c according to Scheme 10.

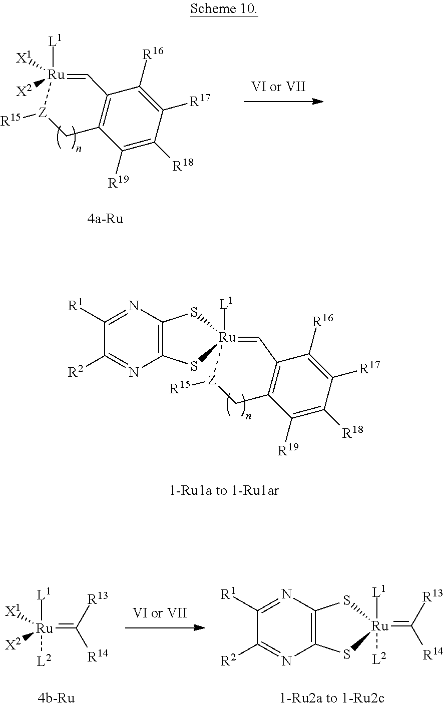

### Example III

### Preparation of Stereoretentive Ruthenium Complexes Using 3-Zn1 Ligand

The transformations described below were performed, when necessary, using a glovebox and/or vacuum-argon line under an inert gas atmosphere, with deoxygenated and anhydrous reactants and solvents.

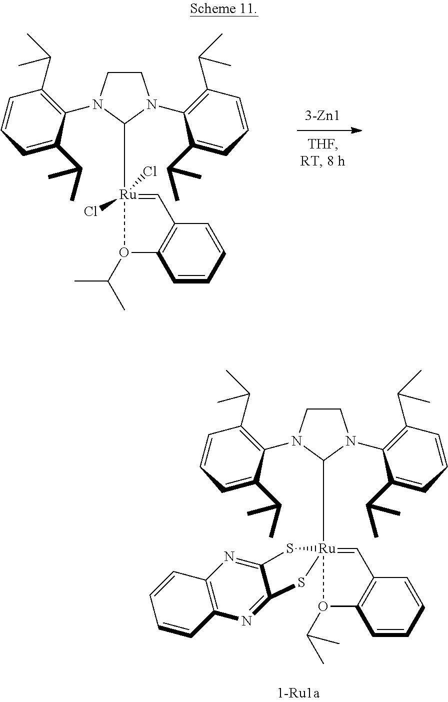

Hoveyda-Grubbs II generation-type complex (50.0 mg, 0.07 mmol), a quinoxalino-2,3-dithiolate zinc 3-Zn1 complex (33.5 mg, 0.14 mmol), and 5 mL of tetrahydrofuran were introduced into a 10 mL vial equipped with a stirring element. The content of the vial was stirred at room temperature for 8 hours and the solvent was evaporated. The residue was suspended in dichloromethane and filtered, preferably through a syringe filter or a Celite pad. After evaporation of the solvent the product 1-Ru1a was obtained as a solid in 95% yield (0.067 mmol, 55.8 mg).

### Example IV

Preparation of Stereoretentive Ruthenium Complexes Using 3-K1 Ligand (Obtained from Reaction R7, Scheme 1)

The transformations described below were performed when necessary using a glovebox and/or vacuum-argon line under an inert gas atmosphere, with deoxygenated and anhydrous reactants and solvents.

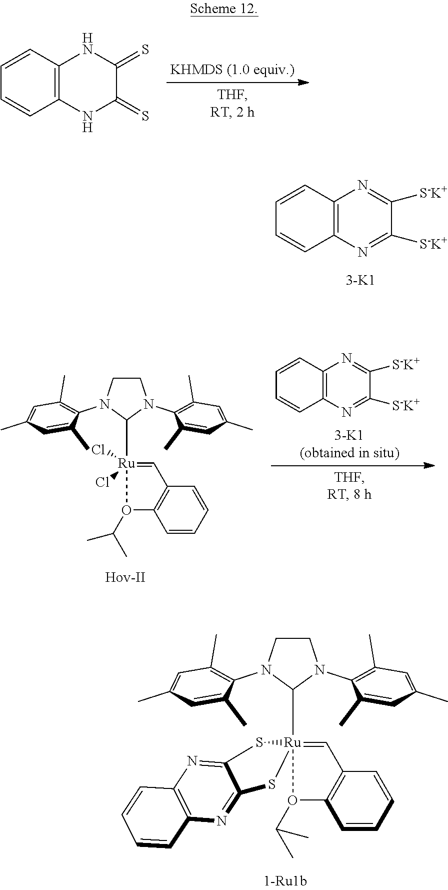

Quinoxalino-2,3-dition (18.6 mg, 0.096 mmol), KHMDS (38.2 mg, 0.196 mmol) and 5 mL of THF were introduced into a 10 mL vial equipped with a stirring element. The content of the vial was stirred for 2 hours, then the Hoveyda-Grubbs II generation complex (Hov-II, 30.0 mg, 0.048 mmol) was added, and the mixture was stirred for another 22 hours, after which the solvent was evaporated. The residue was suspended in dichloromethane and filtered, preferably through a syringe filter or a Celite pad. The filtrate was concentrated to about 2 mL and then 15 mL of hexane was slowly added. The crystals formed were collected and washed with a small amount of hexane. After removal of residual solvent, the solid 1-Ru1b product was obtained in 70% yield (0.033 mmol, 25.0 mg).

Using the method presented in examples III and IV, a series of complexes 1-Ru1a to 1-Ru1ar or 1-Ru2a to 1-Ru2c were obtained, the structures of which are shown below.

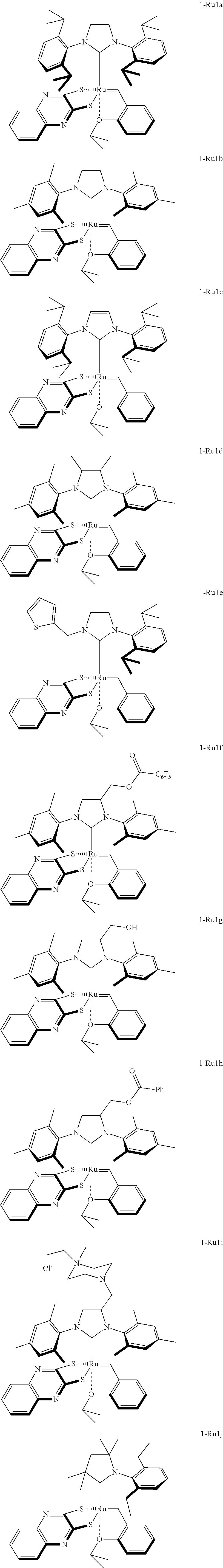

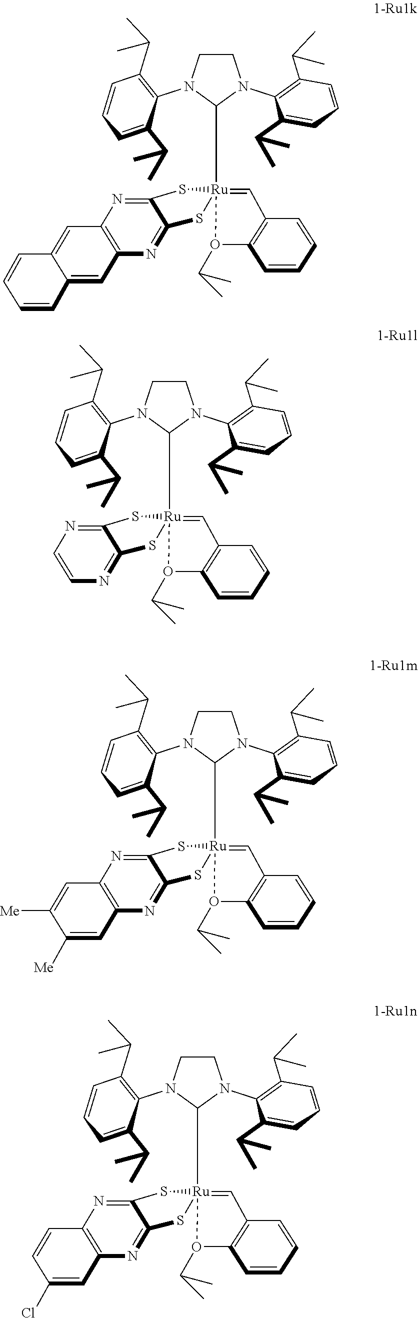

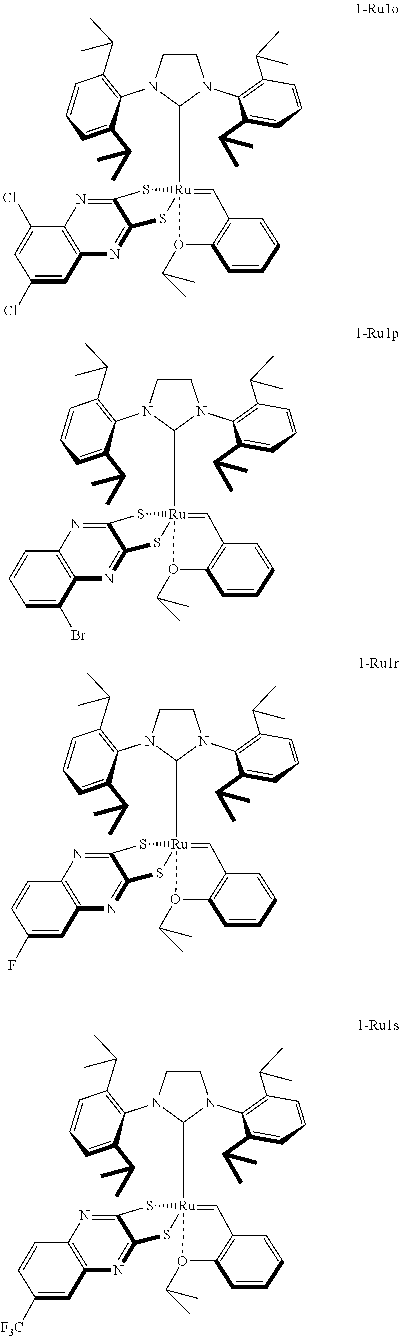

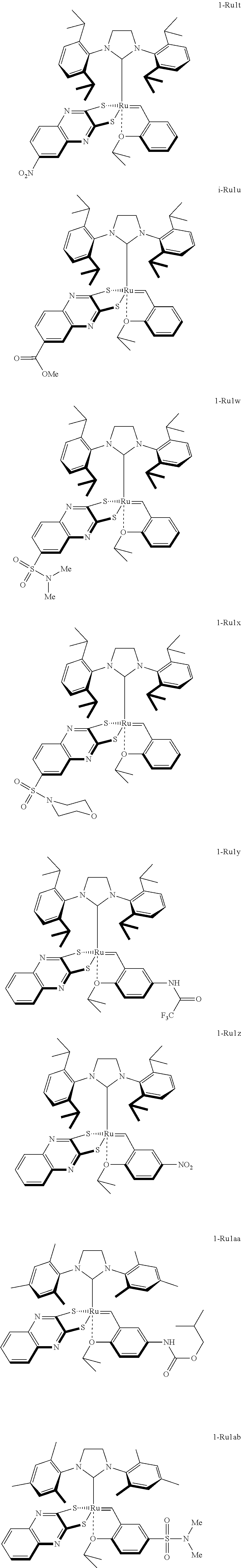

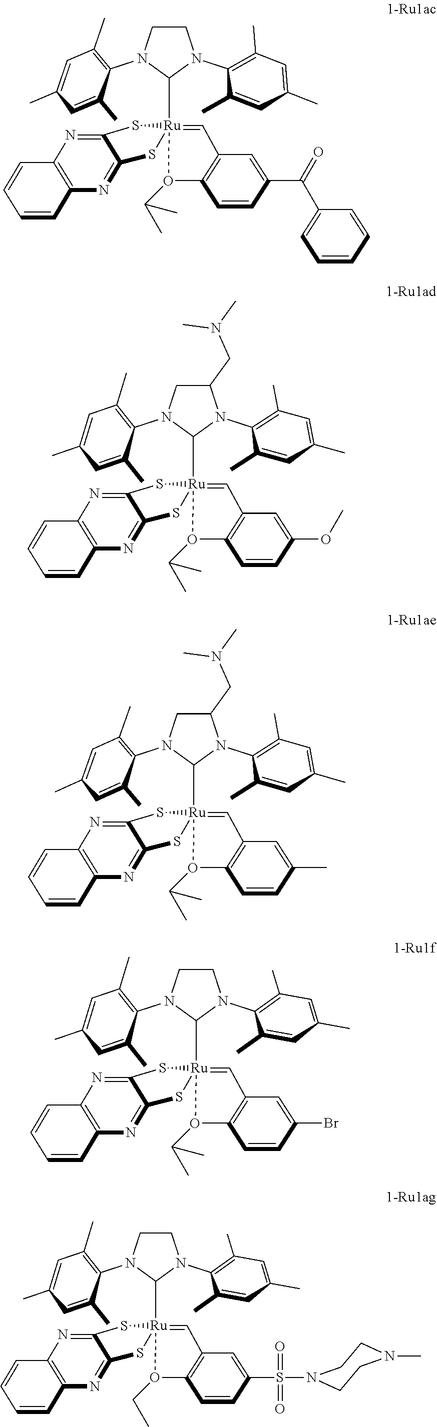

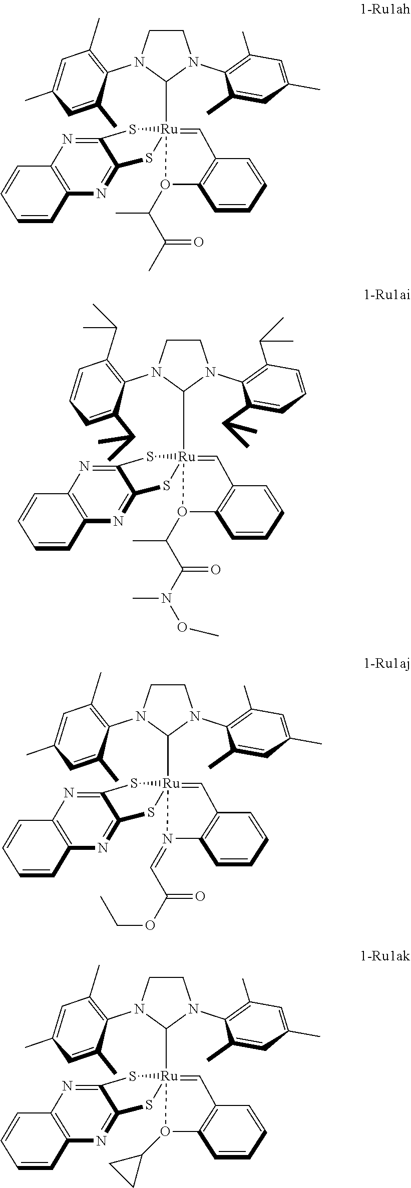

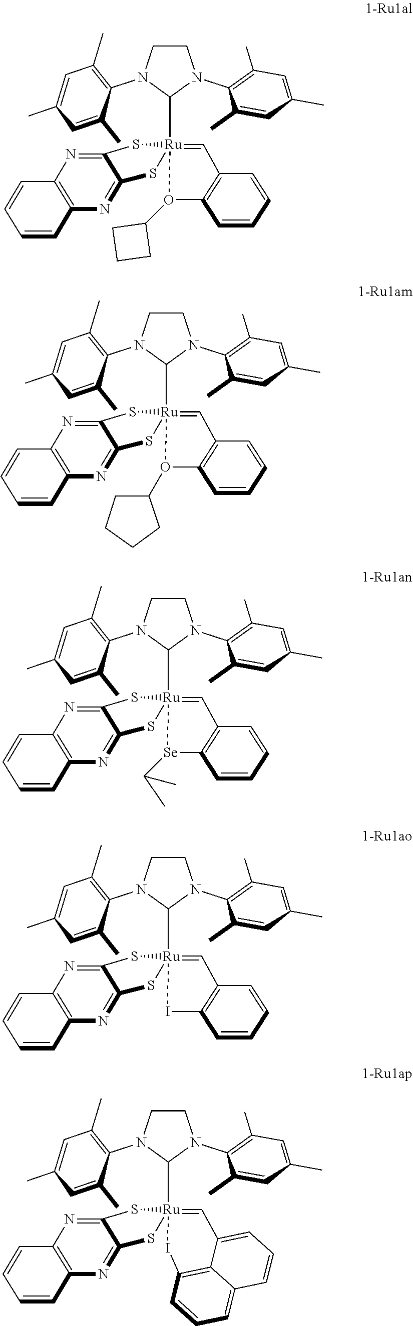

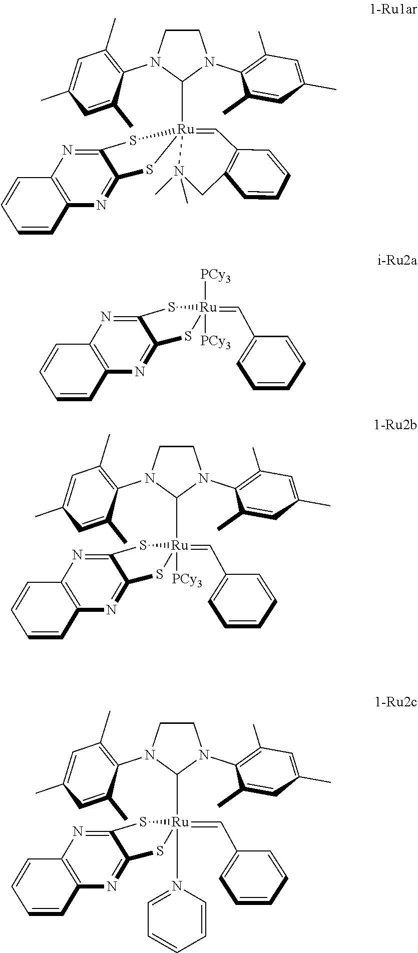

All of the above complexes were characterized using nuclear magnetic resonance spectroscopy. Table 1 summarizes the benzylidene proton shifts of each complex in the ¹H NMR spectrum in a given solvent.

TABLE 1
Summary of the obtained ruthenium complex structures according to the general
procedure of example III and IV and the shift of their benzylidene proton in the ¹H NMR
spectrum.

| | | | | | ¹H NMR δ |
|---|---|---|---|---|---|
| | Compound | | | Molar mass | Ru = CH |
| Item | No. | Structure | Molecular formula | [g/mol] | (solvent) |
| 1. | 1-Ru1a | 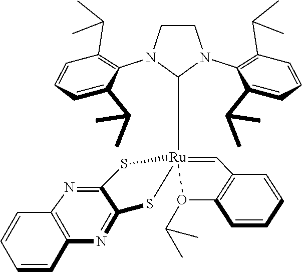 | C₄₅H₅₄N₄ORuS₂ | 832.14 | 15.02 ppm (CD₂Cl₂) |
| 2. | 1-Ru1b | 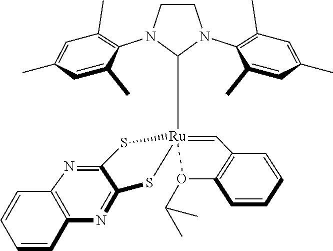 | C₃₉H₄₂N₄ORuS₂ | 748.19 | 14.78 ppm (CD₂Cl₂) |
| 3. | 1-Ru1c | 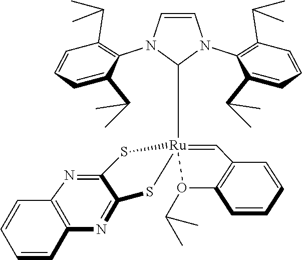 | C₄₅H₅₂N₄ORuS₂ | 830.27 | 15.15 ppm (CD₂Cl₂) |
| 4. | 1-Ru1d | 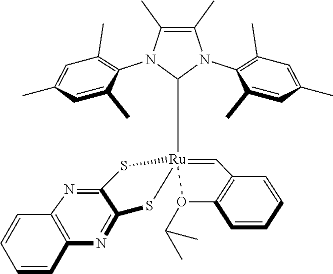 | C₄₁H₄₄N₄ORuS₂ | 754.21 | 15.33 ppm (THF) |
| 5. | 1-Ru1e | 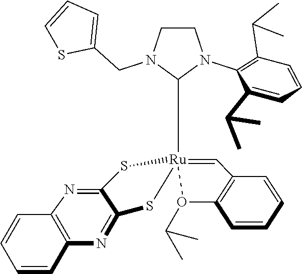 | C₃₈H₄₂N₄ORuS₃ | 768.16 | 14.80 ppm (CD₂Cl₂) |
| 6. | 1-Ru1f | 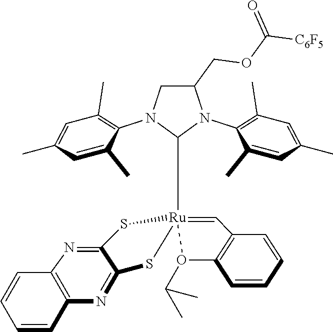 | C₄₇H₄₃F₅N₄O₃RuS₂ | 972.07 | 14.74 ppm (THF) |
| 7. | 1-Ru1g | 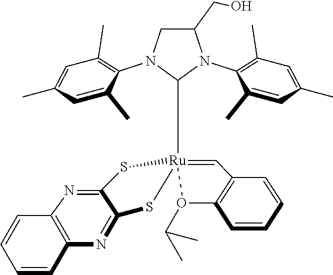 | C₄₀H₄₄N₄O₂RuS₂ | 778.20 | 15.03 ppm; 14.78 ppm (THF) |
| 8. | 1-Ru1h | 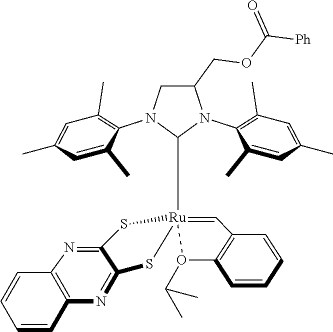 | C₄₇H₄₈N₄O₃RuS₂ | 882.23 | 14.82 ppm (THF) |
| 9. | 1-Ru1i | 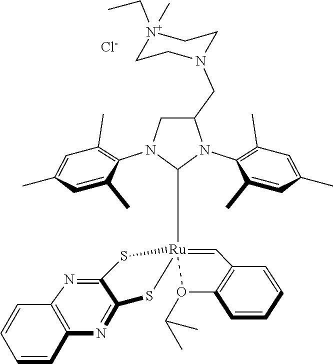 | C₄₇H₅₉ClN₆ORuS₂ | 924.67 | 14.73 ppm (THF) |
| 10. | 1-Ru1j | 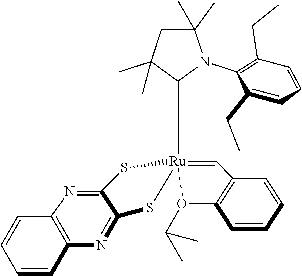 | C₃₆H₄₃N₃ORuS₂ | 699.20 | 14.45 ppm (THF) |
| 11. | 1-Ru1k | 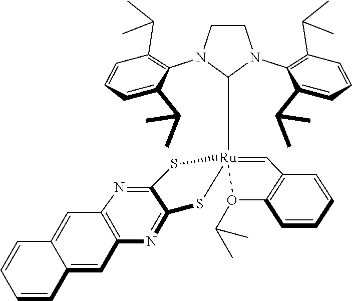 | C₄₉H₅₆N₄ORuS₂ | 882.30 | 14.97 ppm (CD₂Cl₂) |
| 12. | 1-Ru1l | 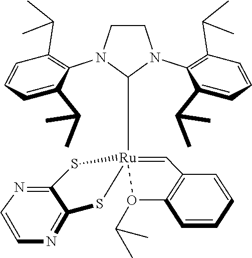 | C₄₁H₅₂N₄ORuS₂ | 782.27 | 14.79 ppm (CD₂Cl₂) |
| 13. | 1-Ru1m | 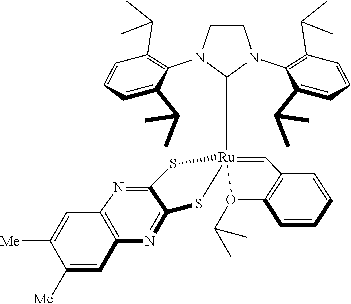 | C₄₇H₅₈N₄ORuS₂ | 860.32 | 14.94 ppm (CD₂Cl₂) |
| 14. | 1-Ru1n | 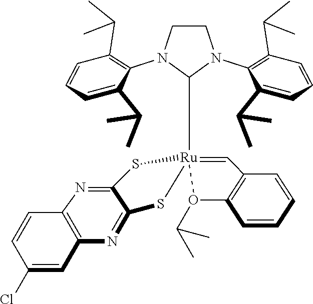 | C₄₅H₅₃N₄ClORuS₂ | 866.25 | 14.97 ppm; 14.94 ppm (CD₂Cl₂) |
| 15. | 1-Ru1o | 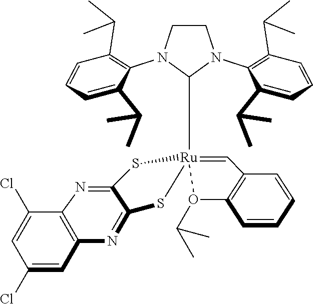 | C₄₅H₅₂N₄Cl₂ORuS₂ | 900.24 | 14.98 ppm; 14.94 ppm (CD₂Cl₂) |
| 16. | 1-Ru1p | 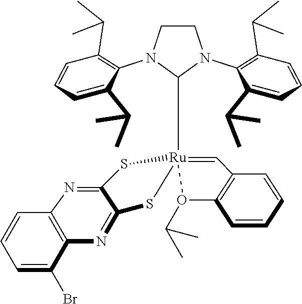 | C₄₅H₅₃N₄BrORuS₂ | 910.20 | 14.97 ppm (CD₂Cl₂) |
| 17. | 1-Ru1r | 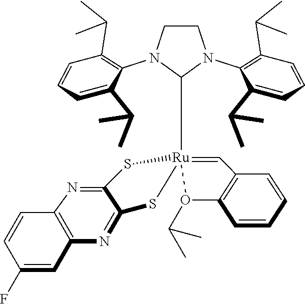 | C₄₅H₅₃FN₄ORuS₂ | 850.28 | 15.00 ppm 14.92 ppm (CD₂Cl₂) |
| 18. | 1-Ru1s | 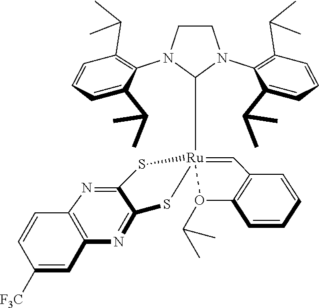 | C₄₆H₅₃F₃N₄ORuS₂ | 900.27 | 14.98 ppm 14.94 ppm (CD₂Cl₂) |
| 19. | 1-Ru1t | 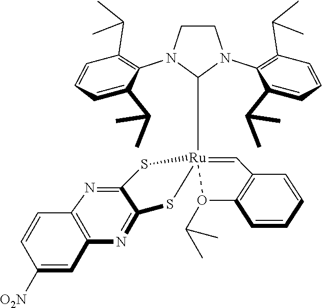 | C₄₅H₅₃N₅O₃RuS₂ | 877.27 | 15.00 ppm 14.89 ppm (CD₂Cl₂) |
| 20. | 1-Ru1u | 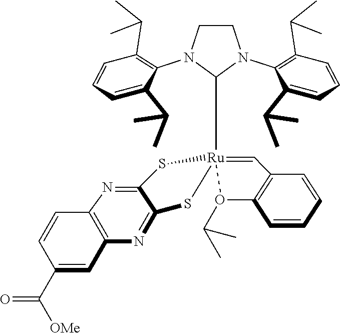 | C₄₇H₅₆N₄O₃RuS₂ | 890.29 | 15.00 ppm; 14.91 ppm (CD₂Cl₂) |
| 21. | 1-Ru1w | 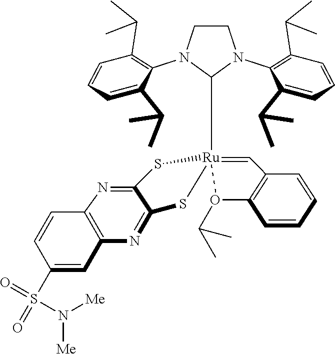 | C₄₇H₅₉N₅O₃RuS₃ | 939.29 | 14.98 ppm 14.94 ppm (CD₂Cl₂) |
| 22. | 1-Ru1x | 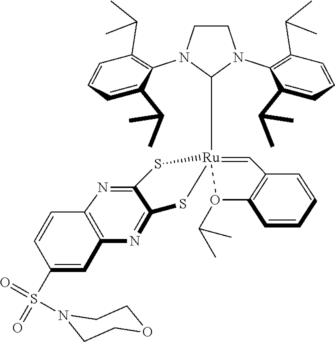 | C₄₉H₆₁N₅O₄RuS₃ | 981.30 | 14.98 ppm 14.92 ppm (CD₂Cl₂) |
| 23. | 1-Ru1y | 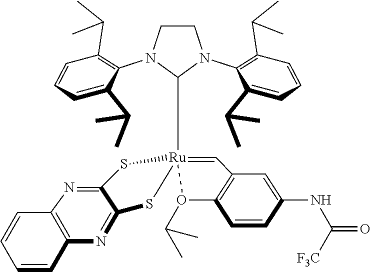 | C₄₇H₅₄F₃N₅O₂RuS₂ | 943.28 | 15.11 ppm (THF) |
| 24. | 1-Ru1z | 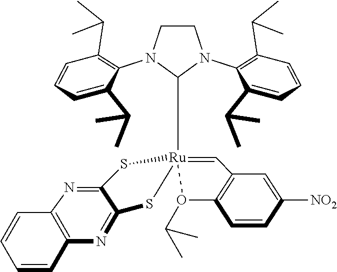 | C₄₅H₅₃N₅O₃RuS₂ | 877.27 | 15.14 ppm (THF) |
| 25. | 1-Ru1aa | 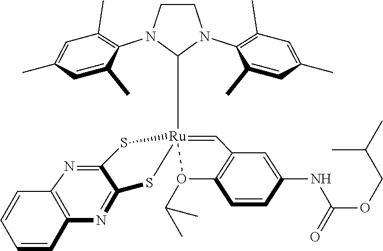 | C₄₄H₅₁N₅O₃RuS₂ | 863.26 | 14.95 ppm (THF) |
| 26. | 1-Ru1ab | 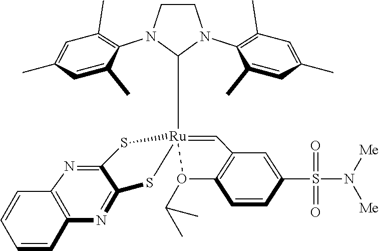 | C₄₁H₄₇N₅O₃RuS₃ | 855.20 | 14.88 ppm (THF) |
| 27. | 1-Ru1ac | 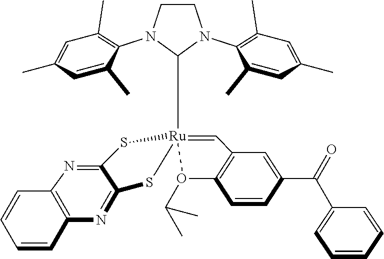 | C₄₆H₄₆N₄O₂RuS₂ | 852.22 | 14.94 ppm (THF) |
| 28. | 1-Ru1ad | 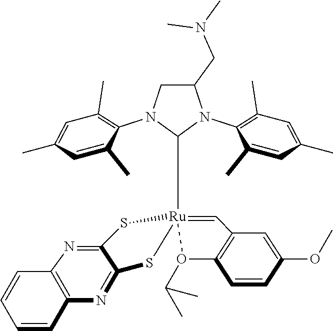 | C₄₃H₅₁N₅O₂RuS₂ | 835.26 | 14.74 ppm (THF) |
| 29. | 1-Ru1ae | 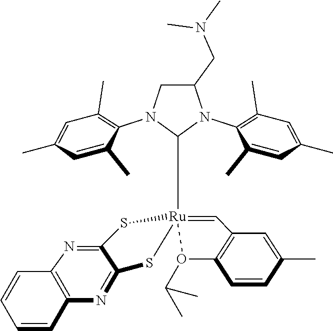 | C₄₃H₅₁N₅ORuS₂ | 819.27 | 14.76 ppm (THF) |
| 30. | 1-Ru1af | 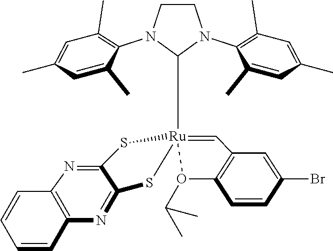 | C₃₉H₄₁BrN₄ORuS₂ | 826.10 | 14.86 ppm (THF) |
| 31. | 1-Ru1ag | 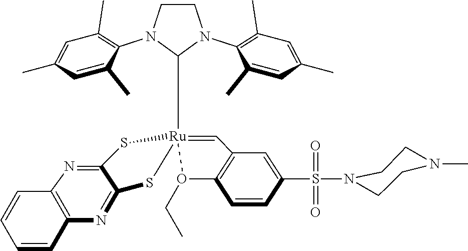 | C₄₃H₅₀N₆O₃RuS₃ | 896.22 | 14.78 ppm (THF) |
| 32. | 1-Ru1ah | 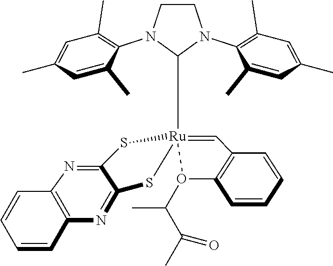 | C₄₀H₄₂N₄O₂RuS₂ | 776.19 | 15.00 ppm (THF) |
| 33. | 1-Ru1ai | 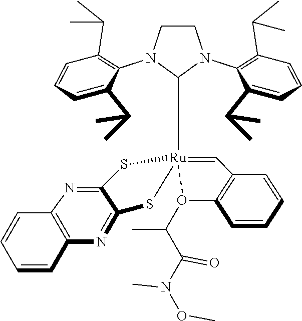 | C₄₇H₅₇N₅O₃RuS₂ | 905.30 | 14.98 ppm (THF) |
| 34. | 1-Ru1aj | 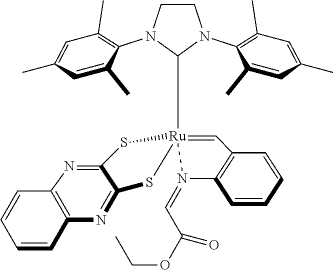 | C₄₀H₄₁N₅O₂RuS₂ | 789.18 | 15.17 ppm 15.00 ppm (Dioxane) |
| 35. | 1-Ru1ak | 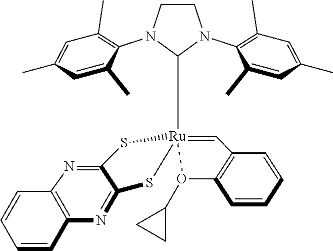 | C₃₉H₄₀N₄ORuS₂ | 746.18 | 15.04 ppm (THF) |
| 36. | 1-Ru1al | 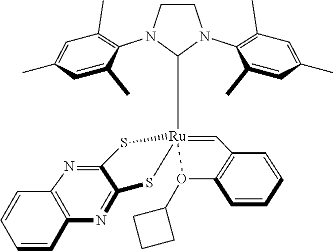 | C₄₀H₄₂N₄ORuS₂ | 760.19 | 15.17 ppm (THF) |
| 37. | 1-Ru1am | 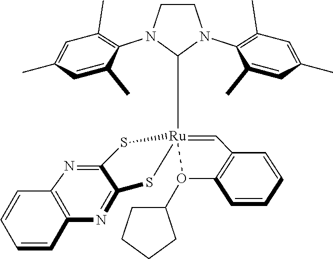 | C₄₁H₄₄N₄ORuS₂ | 774.21 | 15.11 ppm (THF) |
| 38. | 1-Ru1an | 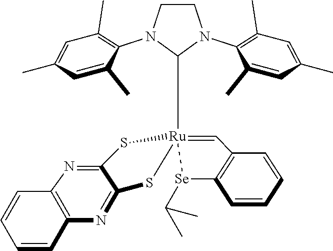 | C₃₉H₄₂N₄RuS₂Se | 812.11 | 15.36 ppm (THF) |
| 39. | 1-Ru1ao | 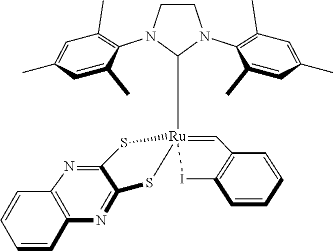 | C₃₆H₃₅IN₄RuS₂ | 816.05 | 15.79 ppm (THF) |
| 40. | 1-Ru1ap | 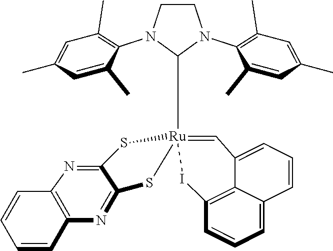 | C₄₀H₃₇IN₄RuS₂ | 866.06 | 16.34 ppm (THF) |
| 41. | 1-Ru1ar | 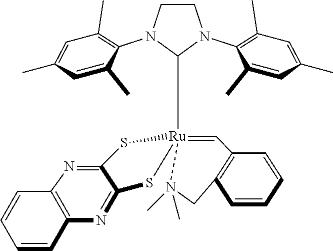 | C₃₉H₄₃N₅RuS₂ | 747.21 | 16.14 ppm (CD₂Cl₂) |
| 42. | 1-Ru2a | 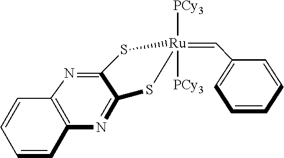 | C₅₁H₇₆N₂P₂RuS₂ | 944.40 | 18.43 ppm (THF) |
| 43. | 1-Ru2b | 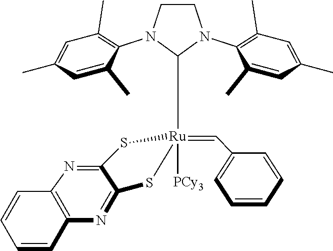 | C₅₄H₆₉N₄PRuS₂ | 970.38 | 19.02 ppm (THF) |
| 44. | 1-Ru2c | 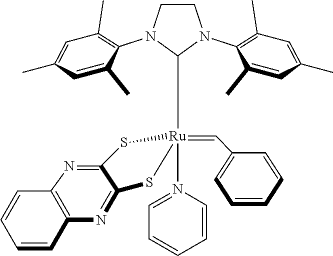 | C₄₁H₄₁N₅RuS₂ | 769.19 | 19.06 ppm (THF) |

### Example V

### Application of New Stereoretentive Ruthenium Complexes

In the example applications of the new stereoretentive metathesis catalysts also the reference ruthenium catalysts 1-Ru0a, 1-Ru0b, 1-Ru0c and the reference molybdenum catalysts Mo1, Mo2, Mo3, shown below, were used for comparison. Reference values described in the literature are shown for some of the results. The % Z and % E values indicate the percentage of a given isomer relative to both present in the product. Unless stated otherwise, all manipulations were carried out under an inert gas atmosphere with anhydrous and deoxygenated solvents and reagents. Gas chromatograph analyses were performed using the internal standard method.

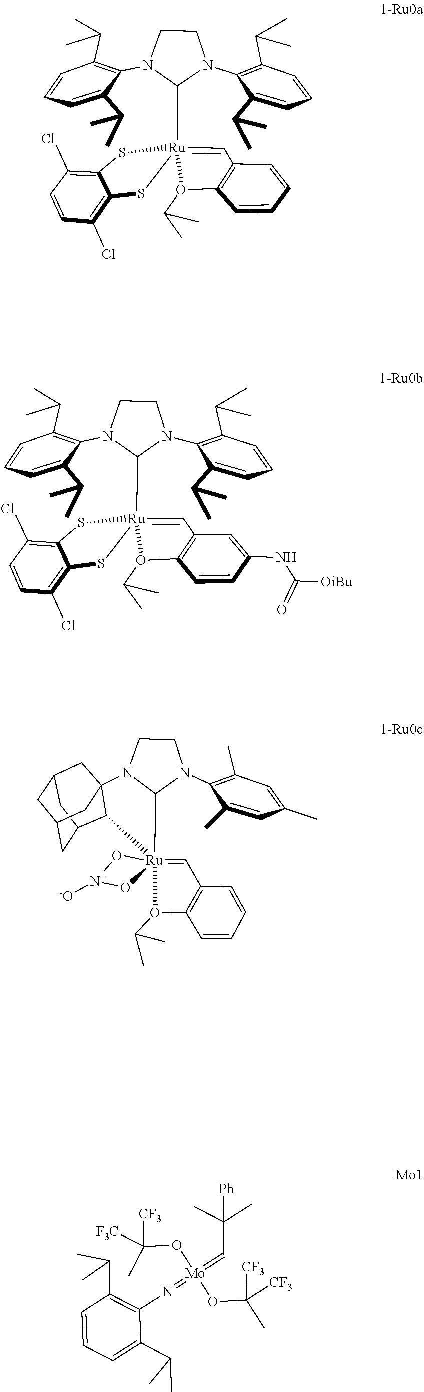

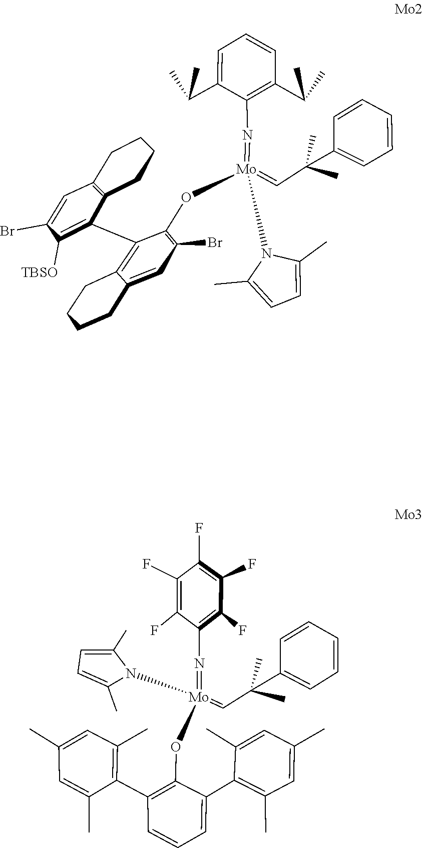

### Example VI

### Activity Study of the New Stereoretentive Ruthenium Complexes in the Cross-Metathesis Reaction of Methyl Oleate (OM)

A solution of methyl oleate (1.0 equiv.) in THF, a solution of tetradecane (0.1 equiv.) in THF and a solution of 1-Ru0a, 1-Ru1a, 1-Ru1c, 1-Ru1m, 1-Ruin, 1-Ru1x catalyst (0.001 equiv.) in THF were introduced into a vial equipped with a stirring element so that the concentration of methyl oleate in the mixture was 0.1 M. The reactions were carried out at room temperature (RT) for 18 hours. The conversion and composition of the mixture were determined by gas chromatography. The results of the model reaction are shown in Table 2, where “OM” is methyl oleate, “9-ODE” is octadec-9-ene, “9-OKD” in this example is dimethyl octadec-9-enodiate.

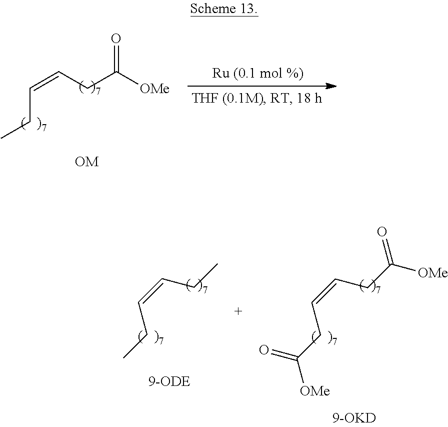

TABLE 2
Comparison of model reaction results for selected ruthenium complexes

| | | Z/E ratio after reaction | | |
|---|---|---|---|---|
| Catalyst | Conversion [%] | 9-ODE | OM | 9-OKD |
| 1-Ru0a | 50 | >99/1 | >99/1 | >99/1 |
| 1-Ru1a | 50 | >99/1 | >99/1 | >99/1 |
| 1-Ru1c | 50 | 98/2 | >99/1 | >99/1 |
| 1-Ru1m | 50 | >99/1 | >99/1 | >99/1 |
| 1-Ru1n | 30 | >99/1 | >99/1 | >99/1 |
| 1-Ru1x | 50 | >99/1 | >99/1 | >99/1 |

### Example VII

### Activity Study of the New Stereoretentive Ruthenium Complexes in the Cross-Metathesis Reaction of Methyl Oleate (OM) at Elevated Temperature

A solution of methyl oleate (1.0 equiv.) in THF, a solution of tetradecane (0.1 equiv.) in THF and a solution of 1-Ru1a, 1-Ru1c, 1-Ru1n, 1-Ru1x catalyst (0.0001 equiv.) in THF were introduced into a vial equipped with a stirring element so that the concentration of methyl oleate in the mixture was 0.1 M. The reactions were carried out at 60° C. for 18 hours. The conversion and composition of the mixture were determined by gas chromatography. The reaction results are shown in Table 3, where “OM” is methyl oleate, “9-ODE” is octadec-9-ene, and “9-OKD” is dimethyl octadec-9-enodiate.

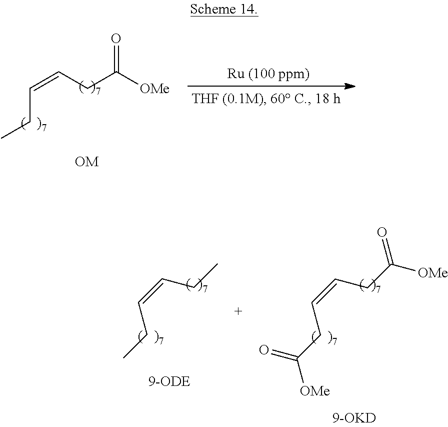

TABLE 3
Comparison of model reaction results for selected ruthenium complexes

| | | Z/E ratio after reaction | | |
|---|---|---|---|---|
| Catalyst | Conversion [%] | 9-ODE | OM | 9-OKD |
| 1-Ru1a | 18 | 96/4 | >99/1 | >99/1 |
| 1-Ru1c | 21 | 90/10 | >99/1 | >99/1 |
| 1-Ru1n | 13 | 98/2 | >99/1 | >99/1 |
| 1-Ru1x | 36 | 76/24 | 74/26 | 76/24 |

### Example VIII

### Study of the Effect of Addition of Zinc Derivative and Other Metals on the Activity and Selectivity of New Stereoretentive Ruthenium Complexes in the Cross-Metathesis Reaction of Methyl Oleate (OM)

A solution of methyl oleate (1.0 equiv.) in THF, a solution of tetradecane (0.1 equiv.) in THF, a solution of catalyst 1-Ru1c (0.0002 equiv.) in THF and 3-Zn1 (0.0-1.0 equiv.) was introduced into a vial equipped with a stirring element so that the concentration of methyl oleate in the reaction mixture was 0.1 M. The reactions were carried out at 60° C. for 18 hours. The conversion and composition of the mixture were determined by gas chromatography. The results of the reactions are shown in Table 4, where “OM” is methyl oleate, “9-ODE” is octadec-9-ene, “9-OKD” is dimethyl octadec-9-enodiate

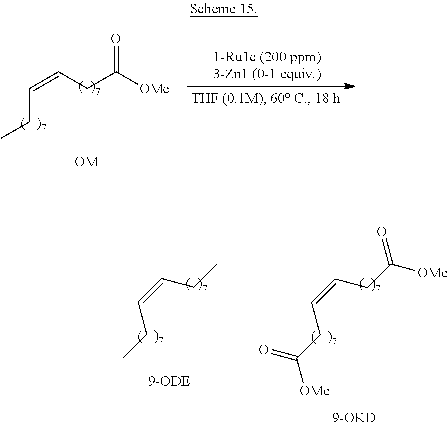

TABLE 4
Effect of zinc complex addition on the course of the model reaction

| Number of 3-Zn1 | Conversion | Z/E ratio after reaction | | |
|---|---|---|---|---|
| equivalents per 1-Ru1c | [%] | 9-ODE | OM | 9-OKD |
| 1 | 19 | 98/2 | 95/5 | 97/3 |
| 0.5 | 21 | 98/2 | 95/5 | 96/4 |
| 0.25 | 22 | 96/4 | 94/6 | 94/6 |
| 0 | 24 | 88/12 | 88/12 | 82/18 |

### Example IX

Activity Study of the New Stereoretentive Ruthenium Complexes in the Cross-Metathesis Reaction of Allylbenzene with (Z)-1,4-Diacetoxybut-2-Ene

A solution of allylbenzene (1.0 equiv.) in THF, a solution of (Z)-1,4-diacetoxybut-2-ene (2.0 equiv.) in THF, a solution of tetradecane (0.1 equiv.) in THF, a solution of catalyst 1-Ru0a, 1-Ru1a, 1-Ru1c, 1-Ru1m or 1-Ru1x (0.05 equiv.) in THF were introduced into a vial equipped with a stirring element so that the concentration of allylbenzene in the mixture was 0.237 M. The reactions were carried out at room temperature for 4 hours. The conversion and composition of the mixture were determined by gas chromatography. The results of the reactions are shown in Table 5.

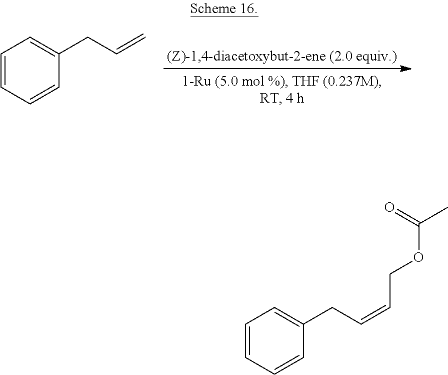

TABLE 5
Comparison of model reaction results for selected ruthenium complexes

| Catalyst | Conversion [%] | Z/E ratio in the product |
|---|---|---|
| 1-Ru0a | 52 | 98/2 |
| 1-Ru1a | 49 | 98/2 |
| 1-Ru1c | 46 | 97/3 |
| 1-Ru1m | 27 | >99/1 |
| 1-Ru1x | 32 | >99/1 |
| 1-Ru0b^{a} | 55 | 97/3 |

^{a}Literature result [A. Dumas, D. S. Müller, I. Curbet, L. Toupet, M. Rouen, O. Baslé, M. Mauduit, Organometallics 2018, 37, 829-834]

### Example X

Activity Study of the New Stereoretentive Ruthenium Complexes in the Cross-Metathesis Reaction of Allylbenzene with (Z)-but-2-en-1,4-diol

A solution of allylbenzene (1.0 equiv.) in THF, a solution of (Z)-but-2-ene-1,4-diol (2.0 equiv.) in THF, a solution of tetradecane (0, 1 equiv.) in THF, a solution of catalyst 1-Ru0a, 1-Ru1a, 1-Ru1c, 1-Ru1m or 1-Ru1x (0.05 equiv.) in THF were introduced into a vial equipped with a stirring element so that the concentration of allylbenzene in the mixture was 0.237 M. The reactions were carried out at room temperature for 4 hours. The conversion and composition of the mixture were determined by gas chromatography (GC). The results of the model reaction are summarized in Table 6.

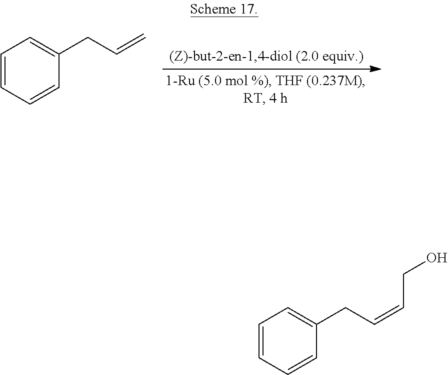

TABLE 6
Comparison of model reaction results for selected ruthenium complexes

| Catalyst | Conversion [%] | Z/E ratio in the product |
|---|---|---|
| 1-Ru0a | 56 | 98/2 |
| 1-Ru1a | 42 | 98/2 |
| 1-Ru1c | 47 | 79/21 |
| 1-Ru1m | 29 | 98/2 |
| 1-Ru1x | 34 | >99/1 |
| 1-Ru0b^{a} | 78 | 98/2 |

^{a}Literature result [A. Dumas, D. S. Müller, I. Curbet, L. Toupet, M. Rouen, O. Baslé, M. Mauduit, Organometallics 2018, 37, 829-834]

^{[a]} Literature result [A. Dumas, D. S. Müller, I. Curbet, L. Toupet, M. Rouen, O. Baslé, M. Mauduit, Organometallics 2018, 37, 829-834]

### Example XI

### Activity Study of the New Stereoretentive Ruthenium Complexes in the Cross-Metathesis Reaction of Methyl Elaidinate (EM)

A solution of methyl elaidinate (1.0 equiv.) in THF, a solution of tetradecane (0.1 equiv.) in THF and a solution of catalyst 1-Ru0a, 1-Ru1a, 1-Ru1c, 1-Ru1m or 1-Ru1x (0.075 equiv.) in THF were introduced into a vial equipped with a stirring element so that the concentration of methyl elaidinate in the mixture was 0.42 M. The reactions were carried out at room temperature for 20 hours. The conversion and composition of the mixture were determined by gas chromatography. The results of the model reaction are shown in Table 7, where “EM” is methyl elaidinate, “9-ODE” is octadec-9-ene, and “9-OKD” is dimethyl octadec-9-enodiate.

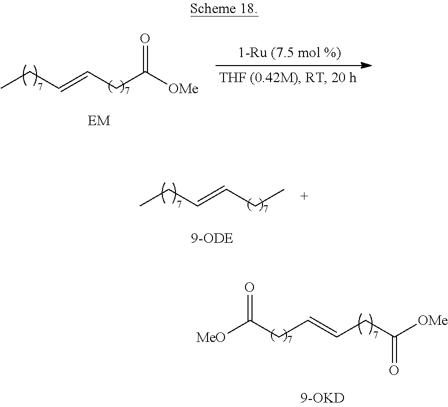

TABLE 7
Comparison of model reaction results for selected ruthenium complexes

| | | E/Z ratio after reaction | | |
|---|---|---|---|---|
| Catalyst | Conversion [%] | 9-ODE | OM | 9-OKD |
| 1-Ru0a | 50 | 84/16 | 89/11 | 86/14 |
| 1-Ru1a | 50 | 95/5 | 94/6 | 95/5 |
| 1-Ru1c | 50 | 95/5 | 94/6 | 91/9 |
| 1-Ru1m | 50 | 82/18 | 82/18 | 79/21 |
| 1-Ru1x | 50 | 94/6 | 93/7 | 88/12 |

### Example XII

Activity Study of the New Stereoretentive Ruthenium Complexes in the Cross-Metathesis Reaction of dec-9-en-1-ol acetate and (Z)-hex-3-ene. Synthesis of (Z)-dodec-9-en-1-ol acetate, the Insect Sex Pheromone of the Moth Eupoecilia ambiguella

A solution of dec-9-en-1-ol (1.0 equiv.) in THF, a solution of (Z)-hex-3-ene (2.0 equiv.) in THF, a solution of tetradecane (0, 1 equiv.) in THF, and a solution of catalyst 1-Ru0a, 1-Ru1a, 1-Ru1c, 1-Ru1m, 1-Ru1t or 1-Ru1x (0.05 equiv.) in THF were introduced into a vial equipped with a stirring element so that the concentration of dec-9-en-1-ol in the mixture was 0.237 M. The reactions were carried out at room temperature for 20 hours. The conversion and composition of the mixture were determined by gas chromatography. The results of the model reaction are shown in Table 8.

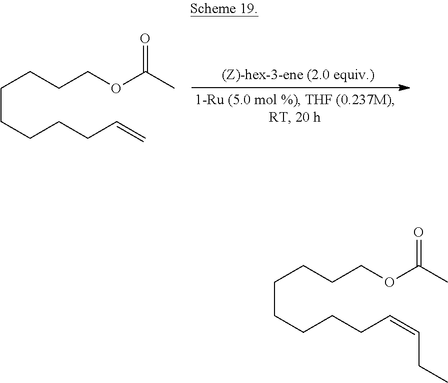 [SMILES: C=CCCCCCCCCOC(C)=O ; CC/C=C\CCCCCCCCOC(C)=O]

TABLE 8
Comparison of model reaction results for selected ruthenium complexes

| Catalyst | Conversion [%] | Z/E ratio in the product |
|---|---|---|
| 1-Ru0a | 97 | 87/13 |
| 1-Ru1a | 91 | 81/19 |
| 1-Ru1c | 95 | 41/59 |
| 1-Ru1m | 84 | 82/18 |
| 1-Ru1t | 63 | 96/4 |
| 1-Ru1x | 89 | 90/10 |

### Example XIII

Activity Study of the New Stereoretentive Ruthenium Complexes in the Ring-Closing Metathesis Reaction of (Z)-6-nonenyl oleate

(Z)-6-nonenyl oleate (1.0 equiv.), 2.5 mL PAO6, and an appropriate amount of catalyst 1-Ru1a or 1-Ru0a were introduced into a reaction vessel equipped with a stirring element. The vessel was equipped with a Hickman distillation adapter, then connected to a diffusion pump (nominal pressure was 1×10⁻⁶ mbar) and placed in a heating bath. The reaction was carried out for 8 hours at 110° C. After the reaction was completed, the distillate was purified on a column chromatography (SiO₂, using n-hexane followed by ethyl acetate as eluents). The fractions collected with ethyl acetate were combined and then concentrated on a rotary evaporator. As a result, a pure product was obtained, in which the Z-isomer content was determined by gas chromatography. The results of the model reaction are shown in Table 9.

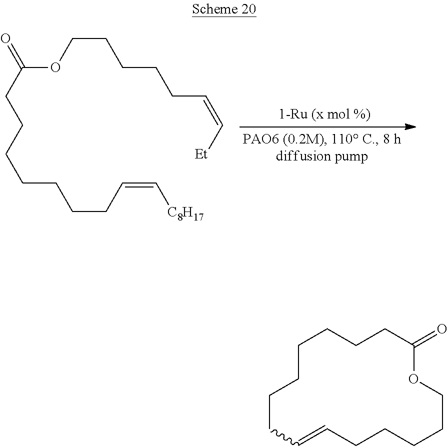

TABLE 9
Effect of the amount of ruthenium complex
on the course of the model reaction

| Catalyst amount | Catalyst | Yield [%] | Z/E ratio in the product |
|---|---|---|---|
| 10 mol % | 1-Ru0a | 52% | 58/42 |
| 10 mol % | 1-Ru1a | 84% | 93/7 |
| 1.0 mol % | 1-Ru1a | 76% | 96/4 |
| 0.5 mol % | 1-Ru1a | 78% | 98/2 |

### Example XIV

### Activity Study of the New Stereoretentive Ruthenium Complexes in the Reaction to Obtain Civetone by Ring-Closure Metathesis (RCM) Reaction

Substrate (1.0 equiv.), 2.5 mL PAO6, and the appropriate 1-Ru1a or 1-Ru0a catalyst amount were introduced into the reaction vessel. The vessel was equipped with a Hickman distillation adapter, then connected to a diffusion pump (nominal pressure was 1×10⁻⁶ mbar) and placed in a heating bath. The reaction was carried out for 8 hours at 110° C. After the reaction was completed, the distillate was purified on a column chromatography (SiO₂, using n-hexane followed by ethyl acetate as eluents). The fractions collected with ethyl acetate were combined and then concentrated on a rotary evaporator. As a result, a pure product was obtained, in which the content of the Z-isomer was determined by gas chromatography. The results of the model reaction are shown in Table 10.

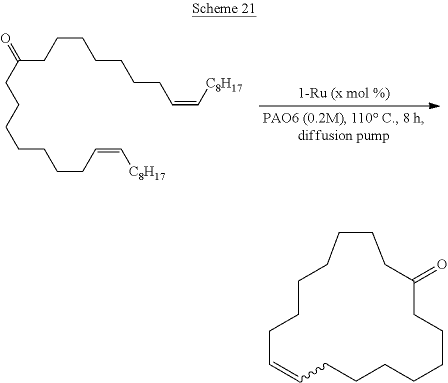

TABLE 10
Comparison of model reaction results for selected ruthenium complexes

| | | | | Z/E ratio in the |
|---|---|---|---|---|
| Catalyst amount | Temperature | Catalyst | Yield [%] | product |
| 1.0 mol % | 110° C. | 1-Ru1a | 54% | 96/4 |
| 0.5 mol % | 110° C. | 1-Ru1a | 54% | 98/2 |
| 0.5 mol % | 110° C. | 1-Ru0a | 13% | 83/17 |
| 0.5 mol % | 130° C. | 1-Ru1a | 45% | 96/4 |
| 0.5 mol % | 150° C. | 1-Ru1a | 27% | 96/4 |

The results shown in Example XIII and Example XIV indicate that the representative for the state of the art stereoretentive thiocatechol complex 1-Ru0a does not yield satisfactory results in the synthesis of macrocyclic lactones and ketones at elevated temperature, while the complexes that are the subject matter of the invention show much higher stereoselectivity and/or yield under the same conditions.

### Example XV

Study of the Z-Selective Molybdenum Complex Activities in the Ring-Closure Metathesis Reaction of (Z)-6-nonenyl oleate

Substrate (1.0 equiv.), 2.5 mL PAO6, and catalyst Mo1, Mo2 or Mo3 in tablet form were introduced into the reaction vessel. The vessel was equipped with a Hickman distillation adapter, then connected to a diffusion pump (nominal pressure was 1×10⁻⁶ mbar) and placed in a heating bath. The reactions were carried out for 8 hours at 110° C. After the reaction was completed, the distillate was purified on a column chromatography (SiO₂, using n-hexane followed by ethyl acetate as eluents). The fractions collected with ethyl acetate were combined and then concentrated on a rotary evaporator. As a result, a pure product was obtained, in which the content of the Z-isomer was determined by gas chromatography. The results of the model reaction are shown in Table 11.

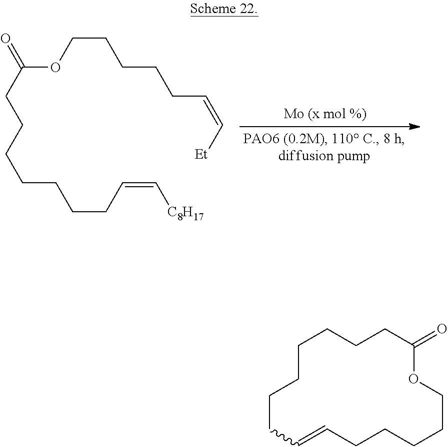

TABLE 11
Comparison of model reaction results for selected ruthenium complexes

| Catalyst | Catalyst amount | Yield [%] | Z/E ratio in the product |
|---|---|---|---|
| Mo1 | 2.6 mol % | 92% | 18/82 |
| Mo2 | 1.9 mol % | 93% | 30/70 |
| Mo3 | 2.4 mol % | 87% | 26/74 |

As expected, the non-stereoselective Mo1 complex yielded the E/Z ratio typical of standard molybdenum complexes. In contrast, the Z-selective Mo2 complex unexpectedly did not show the expected Z-selectivity. Similarly, in the case of another representative for the state of the art Z-selective Mo3 complex, the obtaining of an excess Z-isomer also did not occur. The above results indicate that the cited method for the synthesis of macrocyclic lactones at elevated temperature is incompatible with representative Z-selective alkylidene molybdenum complexes, while the complexes that are the subject matter of the invention show high stereoselectivity under the same conditions.

### Example XVI

Activity Study of the Z-Selective Ruthenium Complex in the Ring-Closure Metathesis Reaction of (Z)-6-nonenyl oleate

Substrate (1.0 equiv.), 2.5 mL PAO6, and catalyst were introduced into the reaction vessel. The vessel was equipped with a Hickman distillation adapter, then connected to a diffusion pump (nominal pressure was 1×10⁻⁶ mbar) and placed in a heating bath. The reaction was carried out for 8 hours at 110° C. After the reaction was completed, the distillate was purified on a column chromatography (SiO₂, hexane then ethyl acetate). The fractions collected with ethyl acetate were combined and then concentrated on a rotary evaporator. As a result, a pure product was obtained, in which the Z-isomer content was determined by gas chromatography. The results of the model reaction are shown in Table 12.

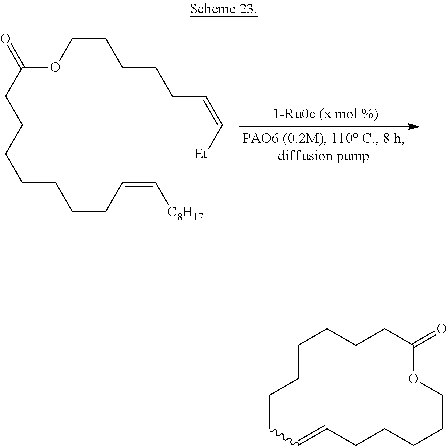

TABLE 12
Comparison of results of model reaction carried out at different
temperatures for different 1-Ru0c catalyst loadings

| 1-Ru0c catalyst | | | Z/E ratio in the |
|---|---|---|---|
| amount [mol %] | Temperature | Yield [%] | product |
| 0.5 | 110 | 0 | — |
| 0.5 | 40→110 | 0 | — |
| 10 | 110 | 0 | — |

The results shown in Example XVI indicate that the representative for the state of the art Z-selective 1-Ru0c complex does not give satisfactory results in the synthesis of macrocyclic lactones at elevated temperature.

### Example XV

### Activity Study of the New Stereoretentive Ruthenium Complexes in the Reaction to Obtain Macrocyclic Compounds by Ring-Closure Metathesis (RCM) Reaction

Substrate (1.0 equiv.), 2.5 mL PAO6, and the corresponding 1-Ru1a catalyst amount were introduced into the reaction vessel. The vessel was equipped with a Hickman distillation adapter, then connected to a diffusion pump (nominal pressure was 1×10⁻⁶ mbar) and placed in a heating bath. The reaction was carried out for 8 hours at 110° C. After the reaction was completed, the distillate was purified on a column chromatography (SiO₂, using n-hexane followed by ethyl acetate as eluents). The fractions collected with ethyl acetate were combined and then concentrated on a rotary evaporator. As a result, a pure product was obtained, in which the Z-isomer content was determined by gas chromatography. The results of the model reaction are shown in Scheme 24.

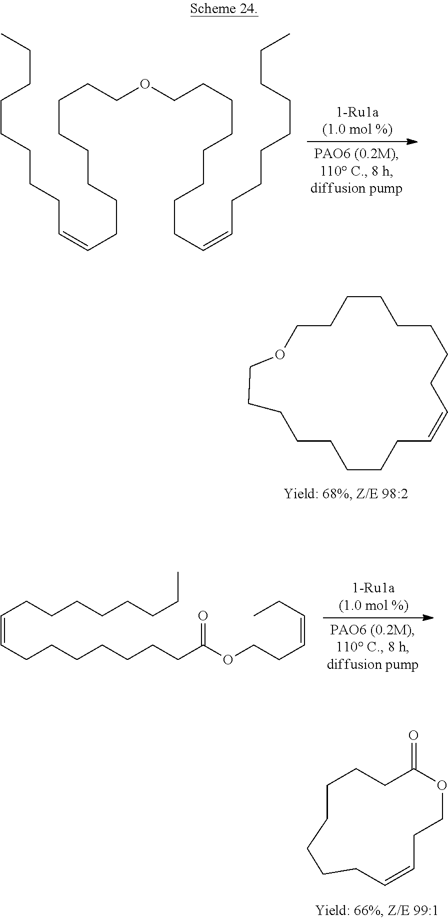 [SMILES: CCCCCCCC/C=C\CCCCCCCCOCCCCCCCC/C=C\CCCCCCCC ; C1=C\CCCCCCCCOCCCCCCCC/1 ; CC/C=C\CCOC(=O)CCCCCCC/C=C\CCCCCCCC ; O=C1CCCCCCC/C=C\CCO1]

### Example XVI

Activity Study of the New Stereoretentive Ruthenium Complexes in the Cross-Metathesis Reaction of Terminal Olefins or Internal Olefins of Z-Configuration with Internal Symmetric Olefins of Z-Configuration

A solution of terminal olefin or internal olefin of Z-configuration (1.0 equiv.) in THF and a solution of symmetric internal olefin of Z-configuration (2.0 equiv.) in THF was introduced into a vial equipped with a stirring element so that the concentration of terminal olefin in the mixture was 0.2 M. A solution of 1-Ru0a, 1-Ru1a (0.02 equiv.) catalyst in THF was added to the mixture, or a solution of 1-Ru0a, 1-Ru1a (0.04 equiv.) catalyst in THF was added in two portions (the second portion was added one hour after the start of the reaction). The reactions were carried out at room temperature for 2 hours. The composition of the mixture was determined by NMR spectroscopy. The results of the model reaction are shown in Scheme 25.

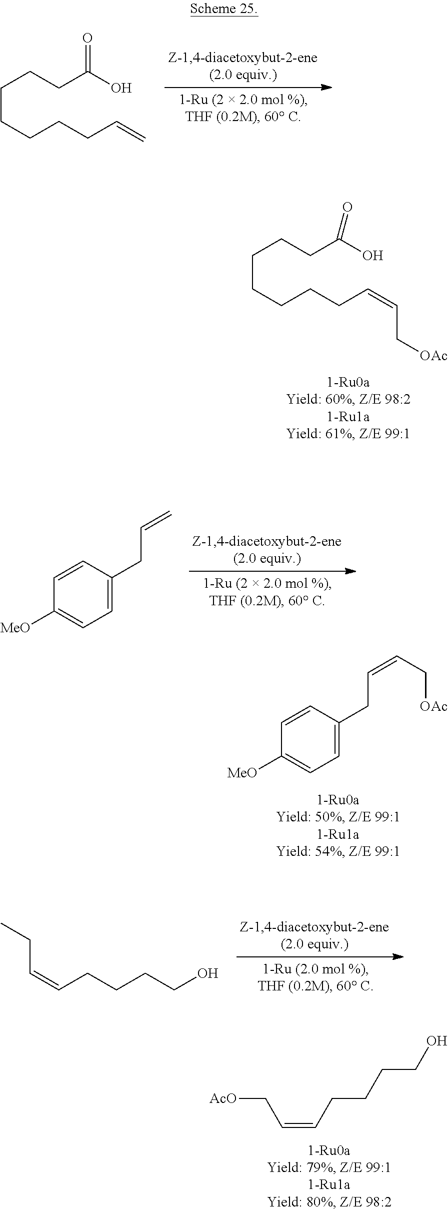

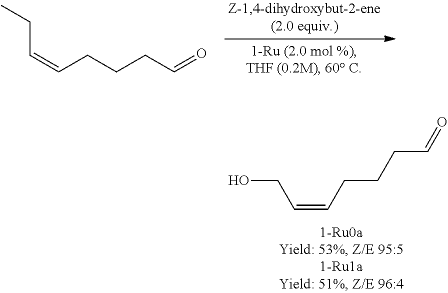

### LITERATURE

[1] J. Lin, P. Wang, Z. Zhang, G. Xue, D. Zha, J. Wang, X. Xu, Z. Li, Synth. Commun. 2020, 50, 823-830.
[2] O. O. Ajani, C. A. Obafemi, C. O. Ikpo, K. O. Ogunniran, O. C. Nwinyi, Chem. Heterocycl. Compd. 2009, 45, 1370-1378.
[3] R. Beldi, K. F. Atta, S. Aboul-Ela, E. S. H. El Ashry, J. Heterocycl. Chem. 2011, 48, 50-56.
[4] Ya. Z. Voloshin, A. S. Belov, A. Yu. Lebedev, O. A. Varzatskii, M. Yu. Antipin, Z. A. Starikova, T. E. Kron, Russ. Chem. Bull. 2004, 53, 1218-1222.
[5] S. Henfling, R. Kempt, J. Klose, A. Kuc, B. Kersting, H. Krautscheid, Inorg. Chem. 2020, 59, 16441-16453.
[6] A. Dumas, D. S. Müller, I. Curbet, L. Toupet, M. Rouen, O. Baslé, M. Mauduit, Organometallics 2018, 37, 829-834.

1. Ruthenium complex of formula 1-Ru 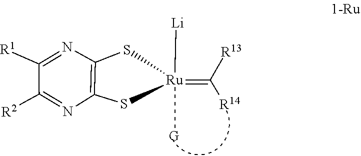
in which:
L¹ is a neutral ligand selected from N-heterocyclic carbenes (NHCs), cyclic alkylaminocarbene (CAAC) or phosphines;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl or C₅-C₂₄ heteroaryloxy, which are optionally substituted by at least one C₁-C₁₂ alkyl, C₁-C₁₂ perfluoroalkyl, or R¹ and R² are independently alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups to form a quaternary ammonium group, a tertiary sulfonium group, or a quaternary phosphonium group;
or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus;
R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ aralkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein the R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium or phosphorus, optionally substituted with one and/or more substituents independently selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle;
wherein the R¹³ and R¹⁴ substituents are independently preferably hydrogen and/or C₅-C₂₅ aryl independently substituted with hydrogen, halogen, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group independently is hydrogen, C₁-C₅ alkyl, C₁-C₅ perfluoroalkyl, C₆-C₂₄ aryl, C₇-C₂₄ aralkyl, C₅-C₂₄ perfluoroaryl, the two R″ groups, taken together, may form either C₃-C₁₂ cycloalkyl ring or C₃-C₂₅ heterocycloalkyl ring containing nitrogen, oxygen or sulfur, optionally additionally substituted with C₁-C₁₂ alkyl group, alternatively R″ is a ketone group (—COR^{c}) in which R^{c} is C₁-C₁₂ perfluoroalkyl or alkoxy group (—OR^{d}) in which R^{d} is C₁-C₁₂ alkyl or C₃-C₁₂ heterocycloalkyl containing nitrogen, oxygen or sulfur optionally additionally substituted with C₁-C₁₂ alkyl group;
G is selected from such as
L² ligand 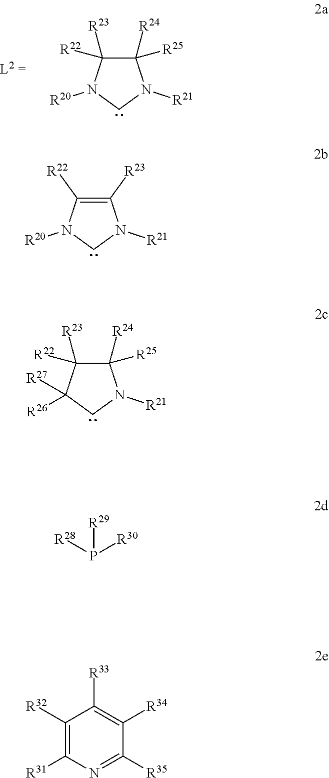
in which the R²⁰ and R²¹ substituents are independently C₁-C₁₂ alkyl group, C₃-C₁₂ cycloalkyl group, C₅-C₂₀ aryl group, or C₅-C₂₀ heteroaryl group, C₅-C₂₅ aralkyl group, which may be substituted independently by one and/or more substituents selected from a group comprising hydrogen, halogen, C₁-C₁₂ alkyl, C₁-C₁₂ perfluoroalkyl, C₅-C₂₀ aryl, C₅-C₂₀ perfluoroaryl, C₅-C₂₀ heteroaryl, C₁-C₁₂ alkoxy, C₅-C₂₄ aryloxy, C₅-C₂₀ heteroaryloxy, alkoxy (—OR″), sulfide (—SR″), amine (—NR″₂) group, in which the R″ group independently is hydrogen, C₁-C₅ alkyl, C₆-C₂₄ aryl, C₇-C₂₄ aralkyl, alternatively R²⁰ and R²¹, taken together, form C₅-C₂₅ ring;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR^{c}₂), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or amine group (—NR^{e}₂) in which each R^{e} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form cyclic C₄-C₁₀ system or polycyclic C₄-C₁₂ system;
each R²⁸, R²⁹, and R³⁰ substituent is independently C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹, R³⁰, taken together, form a substituted or unsubstituted cyclic C₄-C₁₀, polycyclic C₄-C₁₂, aromatic C₄-C₁₀, heteroaromatic C₄-C₁₀ system which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen;
each R³¹, R³², R³, R³⁴ and R³⁵ substituent is independently C₁-C₁₂ alkyl group, C₃-C₁₂ cycloalkyl group, C₃-C₂₀ aryl group or C₅-C₂₀ heteroaryl group, which may be substituted independently by one and/or more substituents selected from a group comprising hydrogen, C₁-C₁₂ alkyl group, C₁-C₁₂ perfluoroalkyl group, C₁-C₁₂ alkoxy group, C₅-C₂₄ aryloxy group, C₅-C₂₀ heteroaryloxy group, or halogen;
or
heteroatom 1
selected from a group comprising oxygen, sulfur, selenium, substituted by a group selected from such as hydrogen, halogen, oxygen, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′₂), Weinreb-type amide (—CON(R′)(OR′)), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which R′ group is independently C₁-C₂₅ alkyl, C₁-C₂₅ perfluoroalkyl, C₃-C₂₅ cycloalkyl, C₃-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl, C₅-C₂₄ heteroaryloxy and then the dashed line represents a direct binding of the heteroatom to the R¹⁴ substituent or represents the connection of the R¹⁴ substituent to the heteroatom via a —CH₂—, —CHR′—, or CR′₂— methylene bridge, wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl; or
heteroatom 2
selected from a group comprising either nitrogen or phosphorus, substituted by a group selected from such as hydrogen, methylidene optionally substituted by an R′ substituent, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, acyl group (—COR′), ester group (—COOR′), tert-butyloxycarbonyl group (t-Boc) or 9-fluorenylmethoxycarbonyl group (Fmoc), carbamate group (—CONR [symbol] ₂), sulfonic group (—SO₂R′), formyl group (—COH), in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy optionally substituted by acyl group (—COR′), cyano (—CN), carboxyl (—COOH), ester (—COOR′), ester (—CH₂COOR′), ester (—CHR′COOR′), ester (—C(R′)₂COOR′), amide (—CONR′₂), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl, or C₅-C₂₄ heteroaryloxy and then the dashed line represents a direct binding of the heteroatom to the R¹⁴ substituent or represents the connection of the R¹⁴ substituent to the heteroatom via a (CH₂)—, —(CHR′)—, or (CR′₂)— methylene bridge; wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, or
heteroatom 3
selected from a group comprising a halogen, and then the dashed line represents a direct binding of the heteroatom to the R¹⁴ substituent, wherein the R¹⁴ substituent is C₅-C₁₅ aryl, or C₅-C₂₅ polyaryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which R″ group is C₁-C₅ alkyl, C₁-C₅ perfluoroalkyl, C₆-C₂₄ aryl, C₇-C₂₄ aralkyl, C₅-C₂₄ perfluoroaryl.

2. The ruthenium complex according to claim 1,
in which the neutral L¹ ligand has a structure represented by a general formula selected from 2a, 2b, 2c or 2d 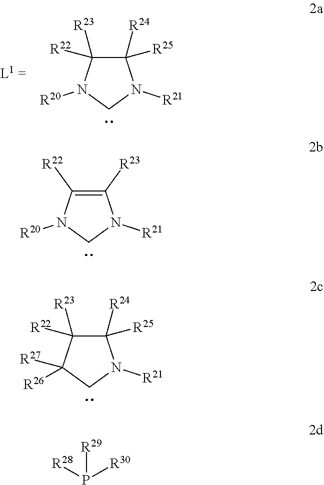
in which:
each R²⁰ and R²¹ substituent is independently C₁-C₁₂ alkyl group, C₃-C₁₂ cycloalkyl group, C₅-C₂₀ aryl group, or C₅-C₂₀ heteroaryl group, which may be substituted independently by one and/or more substituents selected from a group comprising hydrogen, C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy group, C₅-C₂₄ aryloxy group, C₅-C₂₀ heteroaryloxy group, or halogen, alkoxy group (—OR″), sulfide group (—SR″), halogen, amino group (—NR″₂), in which the R″ group independently is hydrogen, C₁-C₅ alkyl, C₆-C₂₄ aryl, C₇-C₂₄ aralkyl, alternatively R²⁰ and R²¹, taken together, form ring C₅-C₂₅ group;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which may be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or amine group (—NR^{e}₂) in which each R^{d} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form cyclic C₄-C₁₀ system or polycyclic C₄-C₁₂ system;
R²⁸, R²⁹ and R³⁰ independently are C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl or C₅-C₂₄ heteroaryloxy, which are optionally substituted by at least one C₁-C₁₂ alkyl or C₁-C₁₂ perfluoroalkyl, or R¹ and R², taken together, form a substituted or unsubstituted cyclic C₄-C₁₀, polycyclic C₄-C₁₂, aromatic C₄-C₁₀, heteroaromatic C₄-C₁₀ system which can be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen.

3. The ruthenium complex according to claim 1 or 2 represented by the formula 1a-Ru 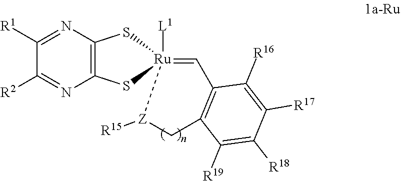
in which:
L¹ is a neutral ligand selected from N-heterocyclic carbenes (NHCs), cyclic alkylaminocarbene (CAAC), or phosphines;
‘n’ is 1 or 0
Z is selected from a group comprising halogen, O, S, Se, or NR″ group, in which R″ is methylidene, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, acyl group (—COR′), ester group (—COOR′), tert-butyloxycarbonyl group (t-Boc) or 9-fluorenylmethoxycarbonyl group (Fmoc), carbamate group (—CONR [symbol] ₂), sulfonic group (—SO₂R′), formyl group (—COH), in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy or halogen, wherein when Z is halogen, R¹⁵ does not exist;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₁₂ alkyl, C₁-C₁₂ perfluoroalkyl, C₁-C₁₂ alkoxy, C₅-C₂₄ aryloxy, C₅-C₂₀ heteroaryloxy, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl;
R¹⁵ is independently hydrogen, C₁-C₂₅ alkyl, C₁-C₂₅ cycloalkyl, C₅-C₂₀ alkoxy, C₅-C₂₀ aryl, C₅-C₂₄ aryloxy, —COOR″ group, —CH₂COOR″ group, —CONR″₂ group, —CH₂CONR″₂ group, —COR″ group, —CH₂COR′″ group, —CON(OR″)(R″) group, —CH₂CON(OR″)(R″) group, or a halogen, wherein R″ is C₁-C₁₂ alkyl, C₃-C₁₂ cycloalkyl, C₂-C₁₂ alkenyl, C₆-C₂₀ aryl, which are optionally substituted by at least one C₁-C₁₂ alkyl, C₁-C₁₂ perfluoroalkyl, C₁-C₁₂ alkoxy, C₆-C₂₄ aryloxy, or halogen;
R¹⁶, R¹⁷, R¹⁸, and R¹⁹ are independently hydrogen, halogen, C₁-C₂₅ alkyl group, C₂-C₂₅ alkenyl group, C₅-C₂₅ aryl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl,
wherein R¹⁶, R¹⁷, R¹⁸, and R¹⁹ substituents, taken together, may form a substituted or unsubstituted cyclic C₄-C₁₀ or polycyclic C₄-C₁₂ system.

4. The ruthenium complex according to claim 1, 2 or 3 with the formula 1b-Ru 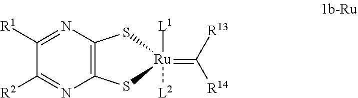
in which:
L¹ is a neutral ligand selected from N-heterocyclic carbenes (NHCs), cyclic alkylaminocarbene (CAAC) or PR₃ phosphines;
L² is a neutral ligand selected from N-heterocyclic carbenes (NHCs), cyclic alkylaminocarbene (CAAC), PR₃ phosphine derivatives or pyridine derivatives;
R¹ and R², are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl or C₅-C₂₄ heteroaryloxy, which are optionally substituted by at least one C₁-C₁₂ alkyl or C₁-C₁₂ perfluoroalkyl, or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R′), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus; R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ arylalkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium, or phosphorus which may be substituted independently with one and/or more substituents selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle.

5. The ruthenium complex according to any of the claims 1 to 4 with the formula 1b-Ru 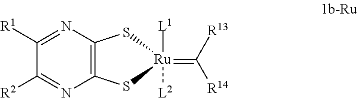
in which the L¹ ligand is 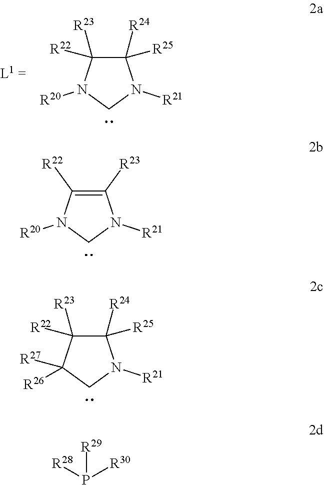
in which:
each R²⁰ and R²¹ substituent is independently C₁-C₁₂ alkyl group, C₃-C₁₂ cycloalkyl group, C₅-C₂₀ aryl group, or C₅-C₂₀ heteroaryl group, which may be substituted independently by one and/or more substituents selected from a group comprising hydrogen, C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy group, C₅-C₂₄ aryloxy group, C₅-C₂₀ heteroaryloxy group, or halogen, alkoxy group (—OR″), sulfide group (—SR″), halogen, amino group (—NR″₂), in which the R″ group independently is hydrogen, C₁-C₅ alkyl, C₆-C₂₄ aryl, C₇-C₂₄ aralkyl, alternatively R²⁰ and R²¹, taken together, form ring C₅-C₂₅ group;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which may be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or amine group (—NR^{e}₂) in which each R^{d} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form cyclic C₄-C₁₀ system or polycyclic C₄-C₁₂ system;
R²⁸, R²⁹, and R³⁰ are independently C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹ and R³⁰, taken together, form a substituted or unsubstituted cyclic C₄-C₁₀, polycyclic C₄-C₁₂, aromatic C₄-C₁₀, heteroaromatic C₄-C₁₀ system which can be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen;
in which L² ligand is: 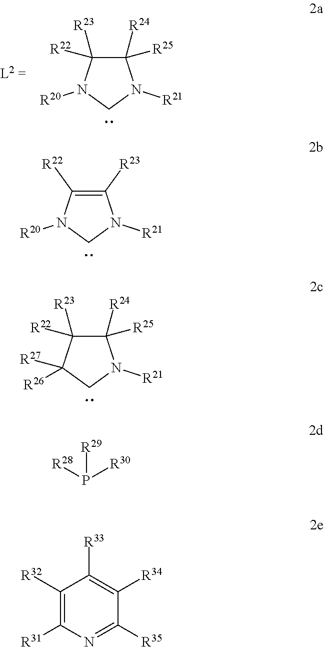
in which
each R²⁰ and R²¹ substituent is independently C₁-C₁₂ alkyl group, C₃-C₁₂ cycloalkyl group, C₅-C₂₀ aryl group, or C₅-C₂₀ heteroaryl group, which may be substituted independently by one and/or more substituents selected from a group comprising hydrogen, C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy group, C₅-C₂₄ aryloxy group, C₅-C₂₀ heteroaryloxy group, or halogen, alkoxy group (—OR″), sulfide group (—SR″), halogen, amino group (—NR″₂), in which the R″ group independently is hydrogen, C₁-C₅ alkyl, C₆-C₂₄ aryl, C₇-C₂₄ aralkyl, alternatively R²⁰ and R²¹, taken together, form ring C₅-C₂₅ group;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which may be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or amine group (—NR^{e}₂) in which each R^{d} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form C₄-C₁₀ cyclic system or C₄-C₁₂ polycyclic system;
each R²⁸, R²⁹, and R³⁰ substituent is independently hydrogen, halogen, C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹ and R³⁰, taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy, and halogen;
each R³¹, R³², R³³, R³⁴ and R³⁵ substituent is independently hydrogen, halogen, C₁-C₁₂ alkyl group, C₃-C₁₂ cycloalkyl group, C₅-C₂₀ aryl group or C₅-C₂₀ heteroaryl group, which can be substituted independently by one and/or more substituents selected from a group comprising hydrogen, C₁-C₁₂ alkyl group, C₁-C₁₂ perfluoroalkyl group, C₁-C₁₂ alkoxy group, C₅-C₂₄ aryloxy group, C₅-C₂₀ heteroaryloxy group, or halogen;
R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ arylalkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium or phosphorus which may be substituted independently with one and/or more substituents selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle.

6. The ruthenium complex according to any of the claims 1 to 5, characterized in that its structure is represented by a formula selected from such as

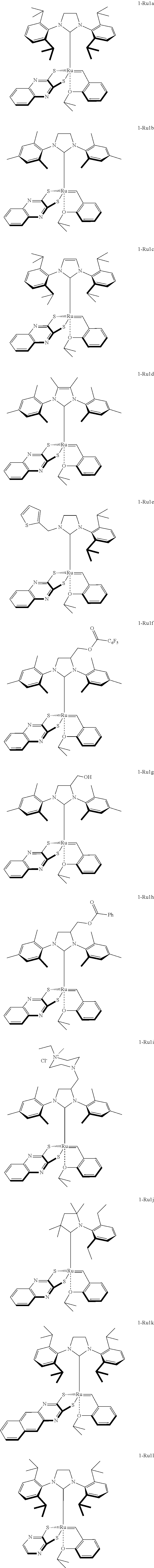

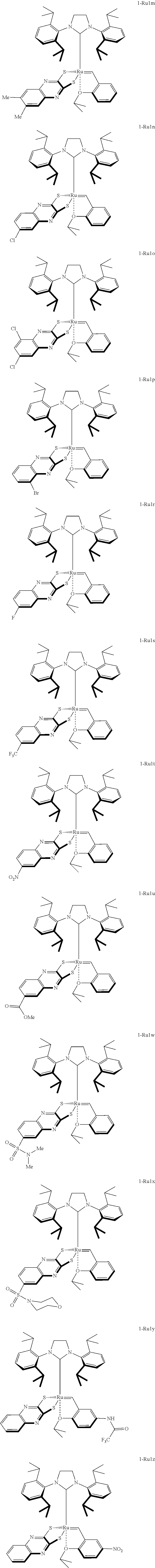

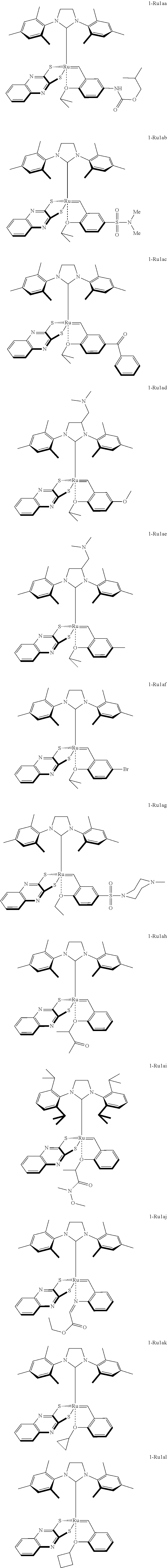

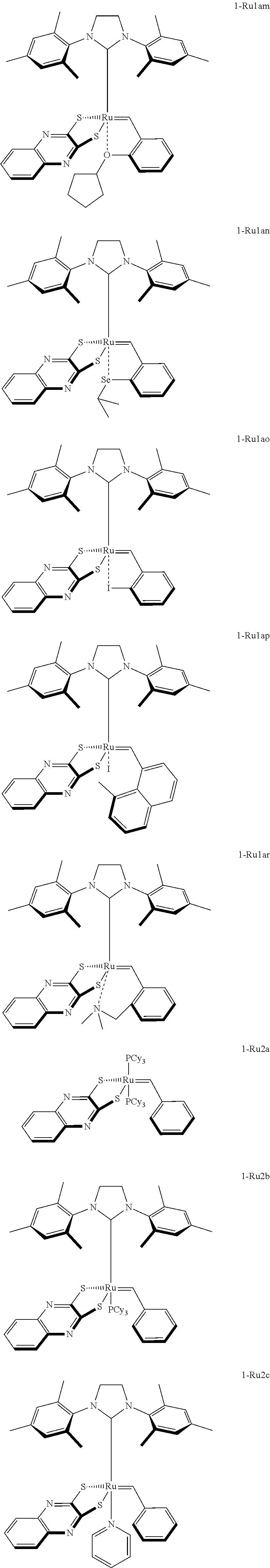

7. A compound with the structure defined by formula 3a or 3b 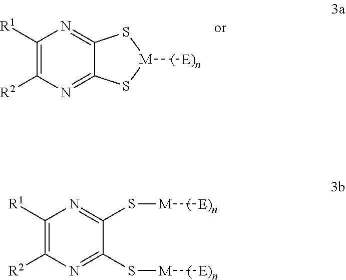
in which
M is monovalent or divalent metal cation;
n is 0, 1, 2 or 3;
E is at least one heteroatom selected from a group comprising oxygen, sulfur, selenium, nitrogen, phosphorus, which are substituted with a group, or if the heteroatom is nitrogen or phosphorus, with groups: C₁-C₂₅ alkyl group, C₁-C₂₅ cycloalkyl group, C₅-C₂₀ alkoxy group, C₅-C₂₀ aryl group, C₇-C₂₀ aralkyl group, C₅-C₂₄ aryloxy group, C₂-C₁₂ alkenyl group, C₆-C₂₀ heteroaryl group, C₅-C₂₄ heteroaryloxy group, or hydrogen, which are optionally substituted by at least one C₁-C₁₂ alkyl or C₁-C₁₂ perfluoroalkyl, or if two identical or different heteroatoms constitute a chelating system then, taken together, they form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy, and halogen;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently alkoxy group (—OR″), sulfide group (—SR″), sulfoxide group (—S(O)R″), sulfonium group (—S⁺R″₂), sulfonyl group (—SO₂R′), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
or R¹ and R², taken together, form a substituted or unsubstituted cyclic C₄-C₁₀, polycyclic C₄-C₁₂, aromatic C₄-C₁₀, heteroaromatic C₄-C₁₀, polyaromatic C₄-C₁₀, and polyheteroaromatic C₄-C₁₀ system, which can be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus.

8. Compound 3c or 3d or 3e according to claim 7 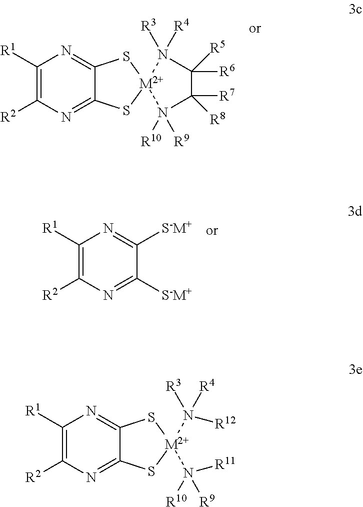
in which
M²⁺ is Zn, Cu, Mg, Ca cation,
M⁺ is Li, Na, K, Cs, Cu or Cu^{x}(E)ₙ cation
n is 1 or 2;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently alkoxy group (—OR″), sulfide group (—SR″), sulfoxide group (—S(O)R″), sulfonium group (—S⁺R″₂), sulfonyl group (—SO₂R′), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group;
or R¹ and R², taken together, form a substituted or unsubstituted cyclic C₄-C₁₀, polycyclic C₄-C₁₂, aromatic C₄-C₁₀, heteroaromatic C₄-C₁₀, polyaromatic C₄-C₁₀, and polyheteroaromatic C₄-C₁₀ system, which can be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus;
R³, R⁴, R⁵, R⁶, R⁷, R⁸, R⁹, R¹⁰, R¹¹ and R¹² independently are hydrogen, C₁-C₂₅ alkyl, C₁-C₂₅ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or two selected R³, R⁴, R⁵, R⁶, R⁷, R⁸, R⁹, R¹⁰, R¹¹ and R¹² substituents, taken together, form a substituted or unsubstituted cyclic C₄-C₁₀, polycyclic C₄-C₁₂, heterocyclic C₄-C₁₂, aromatic C₄-C₁₀, heteroaromatic C₄-C₁₀ system, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₃-C₂₀ heteroaryloxy, and halogen.

9. Compound 3f according to claim 7 or 8 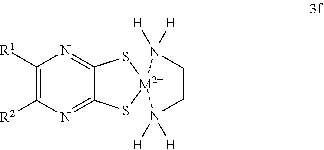
in which
M²⁺ is Zn cation,
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group;
or R¹ and R², taken together, form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, halogen, C₁-C₁₂ perfluoroalkyl group, C₁-C₁₂ alkoxy group, C₅-C₂₄ aryloxy group, C₅-C₂₀ heteroaryloxy group, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus.

10. Compound according to claim 7, 8 or 9, characterized in that its structure is represented by a formula selected from such as 3-Zn1, 3-Zn2, 3-Zn3, 3-Zn4, 3-Zn5, 3-Zn6, 3-Zn7, 3-Zn8, 3-Zn9, 3-Zn10, 3-Zn11, 3-Zn12, 3-Zn13 and 3-K1:

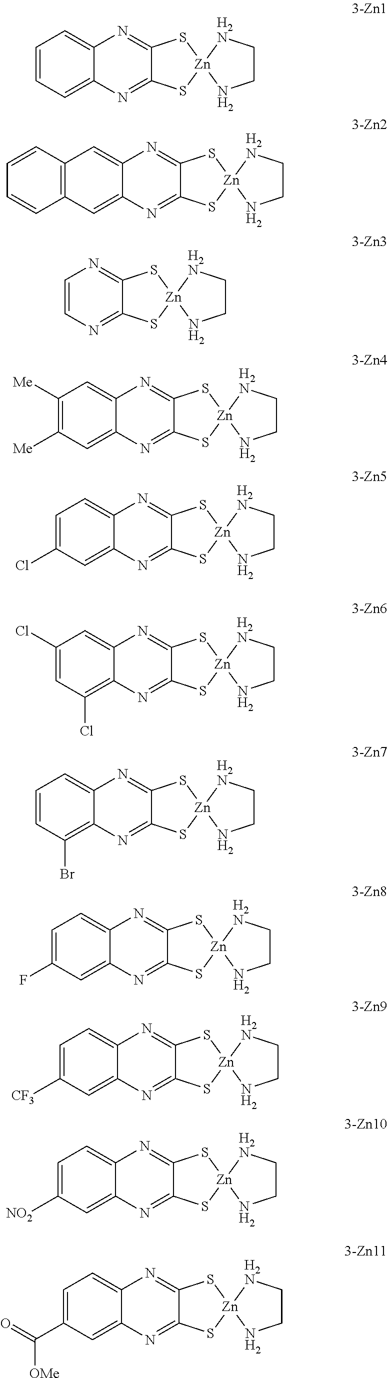

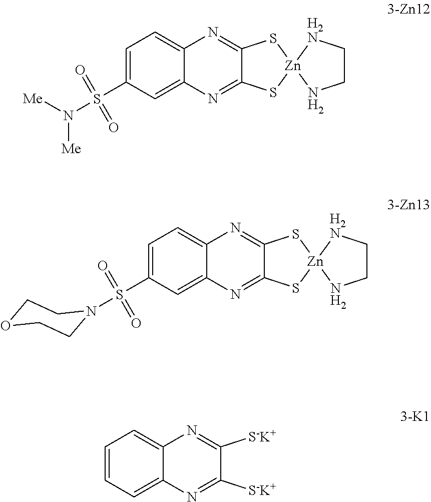

11. A method of producing the ruthenium complex of formula 1-Ru, as defined in any of the claims 1 to 6: 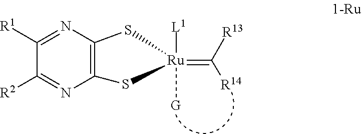
in which:
L¹ is a neutral ligand selected from N-heterocyclic carbenes (NHCs), cyclic alkylaminocarbene (CAAC), or phosphines;
R¹ and R², are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently alkoxy group (—OR″), sulfide group (—SR″), sulfoxide group (—S(O)R″), sulfonium group (—S⁺R″₂), sulfonyl group (—SO₂R′), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group;
or R¹ and R², taken together, form a substituted or unsubstituted cyclic C₄-C₁₀, polycyclic C₄-C₁₂, aromatic C₄-C₁₀, heteroaromatic C₄-C₁₀ system, which can be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus,
R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ arylalkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium or phosphorus which may be substituted independently with one and/or more substituents selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle;
wherein the R¹³ and R¹⁴ substituents are independently preferably hydrogen and/or an C₅-C₂₅ aryl independently substituted with hydrogen, halogen, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₂), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group independently is hydrogen, C₁-C₅ alkyl, C₁-C₅ perfluoroalkyl, C₆-C₂₄ aryl, C₇-C₂₄ aralkyl, C₅-C₂₄ perfluoroaryl, the two R″ groups, taken together, may form either C₃-C₁₂ cycloalkyl ring or C₃-C₂₅ heterocycloalkyl ring containing nitrogen, oxygen or sulfur, optionally additionally substituted with C₁-C₁₂ alkyl group, alternatively R″ is a ketone group (—COR^{c}) in which R^{c} is C₁-C₁₂ perfluoroalkyl or alkoxy group (—OR^{d}) in which R^{d} is C₁-C₁₂ alkyl or C₃-C₁₂ heterocycloalkyl containing nitrogen, oxygen or sulfur optionally additionally substituted with C₁-C₁₂ alkyl group;
G is selected from such as
L² ligand 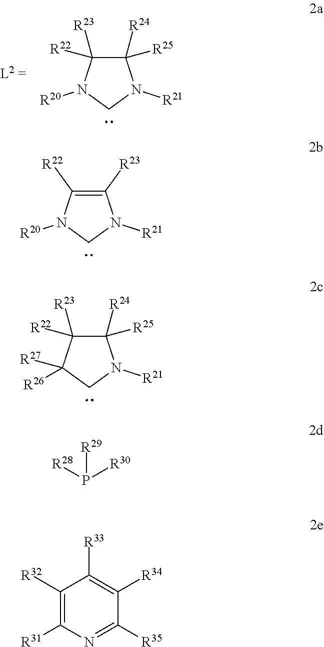
in which the R²⁰ and R²¹ substituents are independently C₁-C₁₂ alkyl group, C₃-C₁₂ cycloalkyl group, C₅-C₂₀ aryl group or C₅-C₂₀ heteroaryl group, C₅-C₂₅ aralkyl group, which may be substituted independently by one and/or more substituents selected from a group comprising hydrogen,
C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy group, C₅-C₂₄ aryloxy group, C₅-C₂₀ heteroaryloxy group, or halogen, alkoxy group (—OR″), sulfide group (—SR″), halogen, amine group (—NR″₂), in which the R″ group independently is hydrogen, C₁-C₅ alkyl, C₆-C₂₄ aryl, C₇-C₂₄ aralkyl, alternatively R²⁰ and R²¹, taken together, form C₅-C₂₅ ring;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or an amino group (—NR^{e}₂) in which each R^{d} is independently hydrogen or C₁-C₁₂ alkyl, the two R^{e} groups may, taken together, form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²², R²¹, R²², R²³, R²⁴, R²⁵, R²⁶, and R²⁷ substituents may optionally be interconnected to form cyclic C₄-C₁₀ system or polycyclic C₄-C₁₂ system;
each R²⁸, R²⁹, and R³⁰ substituent is independently C₁-C₂₅ alkyl, C₁-C₂₅ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹, R³⁰, taken together, form a substituted or unsubstituted cyclic C₄-C₁₀, polycyclic C₄-C₁₂, aromatic C₄-C₁₀, heteroaromatic C₄-C₁₀ system which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy and halogen;
each R³¹, R³², R³³, R³⁴ and R³⁵ substituent is independently C₁-C₁₂ alkyl group, C₃-C₁₂ cycloalkyl group, C₅-C₂₀ aryl group or C₅-C₂₀ heteroaryl group, which may be substituted independently by one and/or more substituents selected from a group comprising hydrogen, C₁-C₁₂ alkyl group, C₁-C₁₂ perfluoroalkyl group, C₁-C₁₂ alkoxy group, C₅-C₂₄ aryloxy group, C₅-C₂₀ heteroaryloxy group, or halogen; or
heteroatom 1
selected from a group comprising oxygen, sulfur, selenium, substituted by a group selected from such as hydrogen, halogen, oxygen, C₁-C₂₅ alkyl, C₁-C₂₅ perfluoroalkyl, C₃-C₂₅ cycloalkyl, C₅-C₂ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, optionally substituted by acyl group (—COR′), cyano (—CN), carboxyl (—COOH), ester (—COOR′), ester (—CH₂COOR′), ester (—CHR′COOR′), ester (—C(R′)₂COOR′), amide (—CONR′₂), Weinreb-type amide (—CON(R′)(OR′)), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which R′ group is C₁-C₂₅ alkyl, C₁-C₂₅ perfluoroalkyl, C₃-C₂₅ cycloalkyl, C₃-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy and then the dashed line represents a direct binding of the heteroatom to the R¹⁴ substituent or represents the connection of the R¹⁴ substituent to the heteroatom via (CH₂)—, —(CHR′)—, or (CR′₂)— methylene bridge, wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl; or
heteroatom 2
selected from a group comprising nitrogen, or phosphorus, substituted by a group selected from such as hydrogen, methylidene optionally substituted by an R′ substituent, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, acyl group (—COR′), tert-butyloxycarbonyl group (t-Boc) or 9-fluorenylmethoxycarbonyl group (Fmoc), carbamate group (—CONR [symbol] ₂), sulfonic group (—SO₂R′), formyl group (—COH), in which R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′₂), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy and then the dashed line represents a direct binding of the heteroatom to the R¹⁴ substituent or represents the connection of the R¹⁴ substituent to the heteroatom via (CH₂)—, —(CHR′)—, or (CR′₂)— methylene bridge; wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, or
heteroatom 3
selected from a group comprising halogen, and then the dashed line represents a direct binding of the heteroatom to the R¹⁴ substituent, wherein the R¹⁴ substituent is C₅-C₁₅ aryl, or C₅-C₂₅ polyaryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which R″ group is C₁-C₅ alkyl, C₁-C₅ perfluoroalkyl, C₆-C₂₄ aryl, C₇-C₂₄ aralkyl, C₅-C₂₄ perfluoroaryl;
characterized in that the alkylidene ruthenium complex of formula 4-Ru: 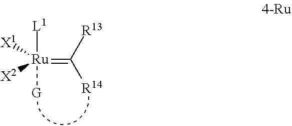
in which:
X¹ and X² independently are anionic ligands selected from a group comprising halogen anion, —CN, —SCN, —OR^{a}, —SR^{a}, —O(C═O)R^{a}, —O(SO₂)R^{a}, and —OSi(R^{a}); group, in which R^{a} is C₁-C₁₂ alkyl, C₃-C₁₂ cycloalkyl, C₂-C₁₂ alkenyl or C₅-C₂₀ aryl, which is optionally substituted by at least one C₁-C₁₂ alkyl, C₁-C₁₂ perfluoroalkyl, C₁-C₁₂ alkoxy, C₅-C₂₄ aryloxy, C₅-C₂₀ heteroaryloxy or halogen;
L¹ is a neutral ligand selected from N-heterocyclic carbenes (NHCs), cyclic alkylaminocarbene (CAAC) or phosphines;
R¹³ and R¹⁴ are independently hydrogen, halogen, optionally substituted C₁-C₂₅ alkyl, optionally substituted C₃-C₂₅ cycloalkyl, optionally substituted C₁-C₁₂ perfluoroalkyl, optionally substituted C₂-C₂₅ alkene, optionally substituted C₂-C₂₅ alkenyl, optionally substituted C₃-C₂₅ cycloalkenyl, optionally substituted C₂-C₂₅ alkynyl, optionally substituted C₃-C₂₅ cycloalkynyl, optionally substituted C₁-C₂₅ alkoxy, optionally substituted C₅-C₂₅ aryl, optionally substituted C₅-C₂₅ aryloxy, optionally substituted C₆-C₂₅ arylalkyl, optionally substituted C₅-C₂₅ heteroaryl, optionally substituted C₅-C₂₅ heteroaryloxy, optionally substituted C₅-C₂₅ perfluoroaryl, 3-12-membered heterocycle containing sulfur, oxygen, nitrogen, selenium or phosphorus, optionally substituted;
wherein R¹³ and R¹⁴ substituents, taken together, may form a ring selected from a group comprising C₃-C₂₅ cycloalkyl, C₃-C₂₅ cycloalkenyl, C₃-C₂₅ cycloalkynyl, C₅-C₂₅ aryl, C₅-C₂₅ heteroaryl, C₅-C₂₅ perfluoroaryl, 3-12-membered heterocycle containing sulfur, oxygen, nitrogen, selenium or phosphorus which may be substituted independently with one and/or more substituents selected from a group comprising hydrogen, halogen, C₁-C₂₅ alkyl, C₃-C₂₅ cycloalkyl, C₁-C₁₂ perfluoroalkyl, C₂-C₂₅ alkene, C₂-C₂₅ alkenyl, C₃-C₂₅ cycloalkenyl, C₂-C₂₅ alkynyl, C₃-C₂₅ cycloalkynyl, C₁-C₂₅ alkoxy, C₅-C₂₅ aryl, C₅-C₂₅ aryloxy, C₆-C₂₅ arylalkyl, C₅-C₂₅ heteroaryl, C₅-C₂₅ heteroaryloxy, C₅-C₂₅ perfluoroaryl, 3-12-membered heterocycle;
wherein the R¹³ and R¹⁴ substituents independently preferably are hydrogen and/or C₅-C₂₅ aryl independently substituted with hydrogen, C₁-C₂₅ alkyl group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl;
G is selected from such as
L² ligand 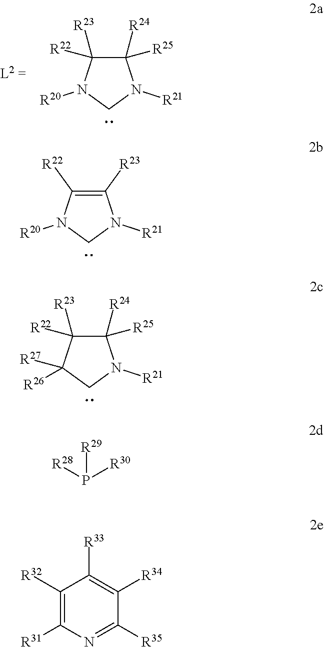
in which the R²⁰ and R²¹ substituents are independently C₁-C₁₂ alkyl group, C₃-C₁₂ cycloalkyl group, C₅-C₂₀ aryl group or C₅-C₂₀ heteroaryl group, C₅-C₂₅ aralkyl group which can be substituted independently by one and/or more substituents selected from a group comprising hydrogen,
C₁-C₁₂ alkyl group, C₁-C₁₂ perfluoroalkyl group, C₅-C₂₀ aryl group, C₅-C₂₀ perfluoroaryl group, C₅-C₂₀ heteroaryl group, C₁-C₁₂ alkoxy group, C₅-C₂₄ aryloxy group, C₅-C₂₀ heteroaryloxy group, or halogen, alkoxy group (—OR″), sulfide group (—SR″), halogen, amine group (—NR″₂), in which the R″ group independently is hydrogen, C₁-C₅ alkyl, C₆-C₂₄ aryl, C₇-C₂₄ aralkyl, alternatively R²⁰ and R²¹, taken together, form C₅-C₂₅ ring;
each R²⁰, R²¹, R²², R²³, R²⁴, R²⁵, R²⁶, and R²⁷ substituent independently is hydrogen, halogen, hydroxyl group, C₁-C₁₂ alkoxy group, hydroxymethyl group (—CH₂OH), C₁-C₁₂ alkyl group optionally substituted with an amine group (—NR^{a} [symbol] ), in which each R^{a} is independently either hydrogen or C₁-C₁₂ alkyl, the two R^{a} groups, taken together, may form either C₃-C₁₂ cycloalkyl ring or C₃-C₂₅ heterocycloalkyl, C₃-C₁₂ cycloalkyl group; C₅-C₂₀ aryl group, C₅-C₂₀ heteroaryl group, ester group (—OCOR^{b}), (—COR^{d}) group, methylester group (—CH₂OCOR^{b}), in which R^{b} is either C₅-C₂₀ aryl group or C₅-C₂₀ perfluoroaryl group; amine group (—NR [symbol] ), methylamine group (—CH₂NR^{c} [symbol] ), in which each R^{c} is independently either hydrogen or C₁-C₁₂ alkyl, the two R^{c} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
which can be substituted independently by at least one substituent selected from a group comprising hydroxyl (OH), C₁-C₁₂ alkyl, C₁-C₁₂ perfluoroalkyl, C₁-C₁₂ alkoxy, halogen, C₃-C₁₂ heterocycloalkyl optionally substituted with C₁-C₁₂ alkyl group, ester group (—COOR^{d}) or (—COR^{d}) group, in which R^{d} is C₅-C₂₀ aryl group or C₅-C₂₀ perfluoroaryl group, or an amino group (—NR^{e}₂) in which each R^{d} is independently hydrogen or C₁-C₁₂ alkyl, the two R^{e} groups, taken together, may form C₃-C₁₂ cycloalkyl ring or C₃-C₂₅ heterocycloalkyl containing nitrogen, oxygen or sulfur, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group, and R²⁰, R²¹, R²², R²³, R²⁴, R²⁵, R²⁶, and R²⁷ substituents may optionally be interconnected to form cyclic C₄-C₁₀ system or polycyclic C₄-C₁₂ system;
each R²⁸, R²⁹, and R³⁰ substituent independently is C₁-C₂₅ alkyl, C₃-C₁₂ cycloalkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R²⁸, R²⁹, R³⁰, taken together, form a substituted or unsubstituted cyclic C₄-C₁₀, polycyclic C₄-C₁₂, aromatic C₄-C₁₀, heteroaromatic C₄-C₁₀ system which can be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy, and halogen;
each R³¹, R³², R³³, R³⁴ and R³⁵ substituent is independently C₁-C₁₂ alkyl group, C₃-C₁₂ cycloalkyl group, C₅-C₂₀ aryl group or C₅-C₂₀ heteroaryl group, which may be substituted independently by one and/or more substituents selected from a group comprising hydrogen, C₁-C₁₂ alkyl group, C₁-C₁₂ perfluoroalkyl group, C₁-C₁₂ alkoxy group, C₅-C₂₄ aryloxy group, C₅-C₂₀ heteroaryloxy group, or halogen; or
heteroatom 1
selected from a group comprising oxygen, sulfur, selenium, substituted by a group selected from such as hydrogen, halogen, oxygen, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₅-C₂₀ heteroaryl or C₅-C₂₄ heteroaryloxy, 3-12-membered heterocycle, optionally substituted by acyl (—COR′), cyano (—CN), carboxyl (—COOH), ester (—COOR′), ester (—CH₂COOR′), ester (—CHR′COOR′), ester (—C(R′)₂COOR′), amide (—CONR′2), Weinreb-type amide (—CON(R′)(OR′)), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl, or C₅-C₂₄ heteroaryloxy and then the dashed line represents a direct binding of the heteroatom to the R¹⁴ substituent or represents the connection of the R¹⁴ substituent to the heteroatom via —CH₂—, —CHR′—, or —CR′₂— methylene bridge, wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, or
heteroatom 2
selected from a group comprising nitrogen, or phosphorus, substituted by a group selected from such as hydrogen, methylidene optionally substituted by an R′ substituent, C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy, 3-12-membered heterocycle, acyl group (—COR′), tert-butyloxycarbonyl group (t-Boc) or 9-fluorenylmethoxycarbonyl group (Fmoc), carbamate group (—CONR [symbol] ₂), sulfonyl group (—SO₂R′), formyl group (—COH), in which R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy optionally substituted by acyl group (—COR′), cyano (—CN), carboxyl (—COOH), ester (—COOR′), ester (—CH₂COOR′), ester (—CHR′COOR′), ester (—C(R′)₂COOR′), amide (—CONR′₂), sulfonic (—SO₂R′), formyl (—COH), sulfonamide (—SO₂NR′₂), ketone (—COR′), thioamide (—CSNR′₂), thioketone (—CSR′), thionoester (—CSOR′), thioester (—COSR′), dithioester (—CS₂R′) group, in which the R′ group is C₁-C₂₅ alkyl, C₁-C₂₅ perfluoroalkyl, C₃-C₂₅ cycloalkyl, C₅-C₂₀ alkoxy, C₅-C₂₀ aryl, C₅-C₂₀ perfluoroaryl, C₇-C₂₀ aralkyl, C₅-C₂₄ aryloxy, C₂-C₁₂ alkenyl, C₆-C₂₀ heteroaryl or C₅-C₂₄ heteroaryloxy and then the dashed line represents a direct binding of the heteroatom to the R¹⁴ substituent or represents the connection of the R¹⁴ substituent to the heteroatom via (CH₂)—, —(CHR′)—, or (CR′₂)— methylene bridge; wherein the R¹⁴ substituent is C₅-C₁₅ aryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, or
heteroatom 3
selected from a group comprising a halogen, and then the dashed line represents a direct binding of the heteroatom to the R¹⁴ substituent, wherein the R¹⁴ substituent is C₅-C₁₅ aryl, or C₅-C₂₅ polyaryl optionally substituted by 1-4 substituents independently selected from a group comprising hydrogen, halogen, C₁-C₂₅ alkyl, C₃-C₂₅ cycloalkyl, C₂-C₂₅ alkenyl, C₃-C₂₅ cycloalkenyl, C₂-C₂₅ alkynyl, C₃-C₂₅ cycloalkynyl, C₁-C₂₅ perfluoroalkyl, C₅-C₂₀ alkoxy, C₅-C₂₀ aryl, C₅-C₂₀ perfluoroaryl, C₇-C₂₀ aralkyl, C₅-C₂₄ aryloxy, C₆-C₂₀ heteroaryl or C₅-C₂₄ heteroaryloxy, 3-12-membered heterocycle, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl;
is reacted with a compound of the structure defined by formula 3a or 3b 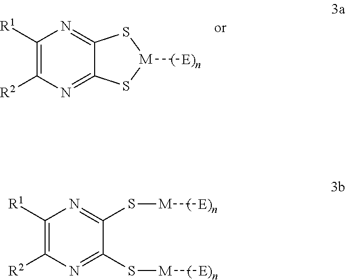
in which
M is monovalent or divalent metal cation;
n is 0, 1 or 2;
E is at least one heteroatom selected from a group comprising oxygen, sulfur, selenium, nitrogen, phosphorus, which are substituted with a group, or if the heteroatom is nitrogen or phosphorus, with groups: C₁-C₂₅ alkyl group, C₁-C₂₅ cycloalkyl group, C₅-C₂₀ alkoxy group, C₅-C₂₀ aryl group, C₇-C₂₀ aralkyl group, C₅-C₂₄ aryloxy group, C₂-C₁₂ alkenyl group, C₆-C₂₀ heteroaryl group, C₅-C₂₄ heteroaryloxy group, or hydrogen, which are optionally substituted by at least one C₁-C₁₂ alkyl or C₁-C₁₂ perfluoroalkyl, or if two identical or different heteroatoms constitute a chelating system then, taken together, they form a substituted or unsubstituted cyclic C₄-C₁₀, polycyclic C₄-C₁₂, aromatic C₄-C₁₀, heteroaromatic C₄-C₁₀ system, which may be substituted by one and/or more substituents selected from hydrogen, C₁-C₁₂ alkyl, C₁-C₁₂ perfluoroalkyl, C₁-C₁₂ alkoxy, C₅-C₂₄ aryloxy, C₅-C₂₀ heteroaryloxy, and halogen;
R¹ and R² are independently hydrogen, halogen, C₁-C₂₅ alkyl, C₅-C₂₀ alkoxy, C₅-C₂₀ aryl, C₇-C₂₀ aralkyl, C₅-C₂₄ aryloxy, C₂-C₁₂ alkenyl, C₆-C₂₀ heteroaryl, or C₅-C₂₄ heteroaryloxy, which are optionally substituted by at least one C₁-C₁₂ alkyl or C₁-C₁₂ perfluoroalkyl, or R¹ and R² are independently alkoxy group (—OR″), sulfide group (—SR″), sulfoxide group (—S(O)R″), sulfonium group (—S⁺R″₂), sulfonyl group (—SO₂R′), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively two R″ groups, taken together, form C₅-C₂₅ ring, which alternatively may contain at least one heteroatom selected from oxygen, sulfur, selenium, nitrogen, phosphorus, optionally additionally substituted with C₁-C₁₂ alkyl group, wherein the heteroatom present in the heterocyclic ring may be substituted by one or two C₁-C₁₂ alkyl groups which form a primary, secondary or tertiary amine, or a quaternary ammonium group, a tertiary sulfonium group or a quaternary phosphonium group,
or R¹ and R², taken together, form a substituted or unsubstituted cyclic C₄-C₁₀, polycyclic C₄-C₁₂, aromatic C₄-C₁₀, heteroaromatic C₄-C₁₀, polyaromatic C₄-C₁₀, and polyheteroaromatic C₄-C₁₀ system, which can be substituted by one and/or more substituents selected from hydrogen, halogen, C₁-C₂₅ alkyl group, C₁-C₁₂ perfluoroalkyl group, C₁-C₁₂ alkoxy group, C₅-C₂₄ aryloxy group, C₅-C₂₀ heteroaryloxy group, C₂-C₂₅ alkenyl group, alkoxy group (—OR″), sulfide group (—SR″), sulfoxide group (—S(O)R″), sulfonium group (—S⁺R″₂), sulfonyl group (—SO₂R″), sulfonamide group (—SO₂NR″₂), amine group (—NR″₂), ammonium group (—N⁺R″₃), nitro group (—NO₂), cyano group (—CN), phosphonate group (—P(O)(OR″)₂), phosphinate group (—P(O)R″(OR″)), phosphonite group (—P(OR″)₂), phosphine group (—PR″₂), phosphine oxide group (—P(O)R″₂), phosphonium group (—P⁺R″₃), carboxyl group (—COOH), ester group (—COOR″), amide group (—CONR″₂), amide group (—NR″C(O)R″), formyl group (—CHO), ketone group (—COR″), thioamide group (—CSNR″₂), thioketone group (—CSR″), thionoester group (—CSOR″), thioester group (—COSR″), dithioester group (—CS₂R″), in which the R″ group is C₁-C₅ alkyl, C₁-C₅ perfluoroalkyl, C₆-C₂₄ aryl, C₇-C₂₄ aralkyl, C₅-C₂₄ perfluoroaryl, alternatively, the two R″ groups, taken together, form C₅-C₂₅ ring, which alternatively may contain at least one heteroatom selected from oxygen, sulfur, selenium, nitrogen, phosphorus.

12. Use of a compound of formula 1-Ru according to any of the claims 1 to 6 as a precatalyst and/or catalyst in olefin metathesis reactions, particularly in ring-closing metathesis (RCM), cross-metathesis (CM), homometathesis (cross-metathesis between two molecules of the same olefin), ethenolysis, isomerization, in diastereoselective ring rearrangement metathesis (DRRM) reaction, alkene-alkyne (ene-yne) metathesis or ROMP or ADMET polymerization reaction.

13. The use according to claim 12, wherein the olefin metathesis reactions are carried out with the catalyst and/or precatalyst 1-Ru defined in any of the claims 1 to 6 in the presence of a compound having a structure represented by a formula selected from such as 3-Zn1, 3-Zn2, 3-Zn3, 3-Zn4, 3-Zn5, 3-Zn6, 3-Zn7, 3-Zn8, 3-Zn9, 3-Zn10, 3-Zn11, 3-Zn12, 3-Zn13, 3-K1 in an amount ranging from 0.0001 mol % to 200 mol %.

14. The use according to claim 12 or 13, wherein the reaction is carried out in an organic solvent such as toluene, benzene, mesylene, hexane, dichloromethane, dichloroethane, chlorobenzene, perfluorobenzene, perfluorotoluene, ethyl acetate, methyl acetate, methyl carbonate, ethyl carbonate, methyl tert-butyl ether, cyclopentyl methyl ether, diethyl ether, THF, 2-ME-THF, 4-ME-THP, dioxane, DME, PAO, PEG, paraffin, esters of saturated fatty acids.

15. The use according to any of the claims 12 to 14, wherein the reaction is carried out in a solvent-free system.

16. The use according to any of the preceding claims, wherein the reaction is carried out at a temperature of 20 to 200° C.

17. The use according to any of the preceding claims, wherein the reaction is carried out over a period of 5 minutes to 48 hours.

18. The use according to any of the preceding claims, wherein the 1-Ru compound is used in an amount of not more than 10 mol %.

19. The use according to any of the preceding claims, wherein the 1-Ru compound is used in an amount of not more than 0.1 mol %.

20. The use according to any of the preceding claims, wherein the 1-Ru compound is added to the reaction mixture portionwise in a solid form and/or continuously, using a pump, as a solution in an organic solvent.

21. The use according to any of the preceding claims, wherein the gaseous by-product of the reaction, selected from ethylene, propylene, butylene, is actively removed from the reaction mixture using an inert gas barbotage or by vacuum.
